(19) United States
(12) Patent Application Publication
(10) Pub. No.: US 2026/0271928 A1
(43) Pub. Date: Sep. 17, 2026

(54) CONTROL OF PESTS RESISTANT TO INSECTICIDES

(71) Applicant: Syngenta Crop Protection Ag, Basel (CH)

(72) Inventors: Andrew Crossthwaite, Bracknell Berkshire (GB); Yves Andenmatten, Basel (CH); Anke Buchholz, Stein (CH); Ying-Ju Chen, Bracknell Berkshire (GB); Fergus Gerard Paul Earley, Bracknell Berkshire (GB); James Arthur Goodchild, Bracknell Berkshire (GB); Elizabeth Ann Hirst, Bracknell Berkshire (GB); Michel Muehlebach, Stein (CH); Dariane Sagaseta de Oliveira Souza, Stein (CH)

(73) Assignee: Syngenta Crop Protection AG, Basel (CH)

(21) Appl. No.: 19/163,583

(22) PCT Filed: Mar. 14, 2024
(86) PCT No.: PCT/EP2024/056790

§ 371 Date: Sep. 9, 2025

(30) Foreign Application Priority Data
Mar. 14, 2023 (EP) EP23161917.2

(51) Int. Cl. A01N 43/40; A01N 43/50; A01N 43/54; A01N 43/56; A01N 43/58; A01N 43/60; A01N 43/653; A01N 43/82; A01N 43/90; A01P 7/04

(52) U.S. Cl. CPC A01N 43/40; A01N 43/50; A01N 43/54; A01N 43/56; A01N 43/58; A01N 43/60; A01N 43/653; A01N 43/82; A01N 43/90; A01P 7/04

(57) ABSTRACT

Use of a compound of formula I to control certain multi-resistant insects wherein the compound is defined in the claims.

The invention relates to a method of controlling a pest, preferably an arthropod pest, such as an insect, that is resistant to one or more, preferably more than one, insecticides using a compound of a defined formula, which compound acts on the vesicular acetylcholine transporter of the pest. The invention also encompasses the use of a compound of a defined formula, or compositions comprising the defined compound, for controlling a pest resistant to one or more, preferably more than one, insecticides, in particular in crops of useful plants.

The efficacy of all major insecticide classes continues to be eroded by the development of resistance mediated, in part, by selection of alleles encoding insecticide insensitive target proteins.

Resistance may be defined as “a heritable change in the sensitivity of a pest population that is reflected in the repeated failure of a product to achieve the expected level of control when used according to the label recommendation for that pest species” (IRAC 2009; IRAC stands for the “Insecticide Resistance Action Committee”—https://irac-online.org/).

Cross-resistance occurs when resistance to one insecticide confers resistance to another insecticide via the same biochemical mechanism. This can happen within insecticide chemical groups or between insecticide chemical groups. Cross-resistance may occur even if the resistant pest has never been exposed to one of the chemical classes of insecticide.

Two of the major mechanisms for diamide resistance include:
(i) Target site resistance, whereby resistance is associated with replacement of one or more amino acids in the insecticide target protein (i.e. the ryanodine receptor); and
(ii) Metabolic resistance, such as enhanced oxidative detoxification of diamides due to overexpression of cytochrome P450 monooxygenases (P450) or conjugation of diamides due to overexpression of UDP-dependent glycosyl transferases (UGT);

Target site resistance has been described in numerous Lepidopteran species incl. Plutella xylostella (Troczka et al. 2012; Steinbach et al. 2015; Guo et al. 2014), Tuta absoluta (Roditakis et al. 2017; Zimmer et al. 2019), Spodoptera frugiperda (Bolzan et al. 2019) Spodoptera exigua (Zuo et al. 2020, 2017) Chilo suppressalis (Yao et al. 2017; Yang et al. 2017). Similar to what has been described for target site resistance against other insecticides e.g. organochlorines affecting the GABA receptor (ffrench-Constant et al. 1998) parallel evolution can also be observed for diamide resistance with two mutations i.e. I4970M and G4946E (P. xylostella numbering) frequently described across species (Richardson et al. 2020). However, that does not exclude that mutations in different positions in the target-site may cause high levels of diamide resistance.

The cytochrome P450 monooxygenases are an important metabolic system involved in the detoxification of xenobiotics in phase I i.e. modification (Dermauw, Van Leeuwen, and Feyereisen 2020; Bard 2000). As such, P450 monooxygenases play an important role in insecticide resistance. P450 monooxygenases have such a phenomenal array of metabolizable substrates because of the presence of numerous P450s (~26-261) arthropodal species, as well as the broad substrate specificity of some P450s (Dermauw, Van Leeuwen, and Feyereisen 2020). Studies of monooxygenase-mediated resistance have indicated that resistance can be due to increased gene expression of one P450 involved (quantitative changes) in detoxification of the insecticide and might also be due to a mutation in the gene itself altering the amino acid composition (qualitative changes) (Feyereisen, Dermauw, and Van Leeuwen 2015). As such, metabolic cross-resistance mechanisms affect not only insecticides from the given class (e.g. neonicotinoids) but also seemingly unrelated insecticides. For example, cross-resistance relationships between the neonicotinoids and pymetrozine in Bemisia tabaci have been reported (Gorman et al. 2010; Nauen et al. 2013).

Apart from cytochrome P450s other enzyme and transport protein families may lead to insecticide resistance e.g. oxidases, hydrolases, transferases and ABC-transporters (Dermauw and Van Leeuwen 2014; Feyereisen, Dermauw, and Van Leeuwen 2015; Bass et al. 2014). P450s as well as other oxidases, transferases and ABC-transporters have been implicated in diamide resistance (Li et al. 2017; Mallott et al. 2019; Li et al. 2018; Shan et al. 2021).

Increasing demand for food, fuel and fibre crops from limited agricultural land area will drive more intensive agricultural practices that are more vulnerable to losses from pests and disease. The need for effective control of insect pests in agriculture is therefore becoming more important. Reliable insect control requires the development of insecticides having a novel mode of action that overcome resistance against existing classes in pest populations, and this is not only an issue for all major agrochemical classes, but also has become a critical issue for human and animal health.

As an example, the diamides represent a fast-growing class of insecticides introduced to the market since the commercialization of neonicotinoids (Sparks and Nauen 2015; Richardson et al. 2020; Troczka et al. 2017) and are extremely valuable insect control agents not least because they had exhibited little or no cross-resistance to older insecticide classes, which suffer markedly from resistance problems. However, reports of insect resistance to the diamides class of insecticides are on the increase.

The increase in resistance of such insects to diamide insecticides thus poses a significant threat to the cultivation of a number of commercially important crops, fruits and vegetables, and there is thus a need to find alternative insecticides capable of better controlling diamide resistant insects (e.g. to find insecticides that do not exhibit any cross-resistance with the diamide class).

Diamide insecticides target the ryanodine receptor in insects and lead to a depletion of the intracellular calcium reservoirs (Ebbinghaus-Kintscher et al. 2006; Sattelle, Cordova, and Cheek 2008; Cordova et al. 2006). Commercial diamides can be attributed to two classes, the phthalic diamides with its sole representative being flubendiamide and the anthranilic diamides comprising chlorantraniliprole, cyantraniliprole, cyclaniliprole, and tetraniliprole. Other examples of phthalic diamides and anthranilic diamides are cyhalodiamide, fluchlordiniliprole and tetrachlorantraniliprole. All diamides share the same mode of action and so are grouped in the IRAC MoA Group 28.

Therefore, it is highly desirable to find classes of compounds offering a better control of the resistant insects.

The discovery of new insecticide classes acting at novel protein binding sites is therefore important for the continued protection of the food supply from insect predators, and of human and animal health from insect borne disease.

Inventors have found that a certain class of compounds act by inhibition of, or affect the function of, the vesicular acetylcholine transporter (VAChT) of pests. The said class of compounds have one or more partially saturated or aromatic carbocyclic and/or heterocyclic ring system (which rings can be fused or bridged), to which ring system is attached an alkylsulfone or alkyl sulfoxamines group (defined herein as VAChT COMPOUNDS).

Acetylcholine signalling pathway has already been successfully exploited by several insecticide classes of major commercial importance acting either as acetylcholinesterase inhibitors (such as organophosphates and carbamates, which are now in declining use because of resistance and safety issues); or as nicotinic acetylcholine receptor activators (such as neonicotinoids and spinosyns), for which resistance is an emerging problem for both agriculture and animal health.

Therefore, the discovery of an insecticide class of compounds that acts at the vesicular acetylcholine transporter, a novel target for pest control, offers a further resource for the management of pests. In particular, the development of resistance in a pest can be reduced through the use of a VAChT COMPOUND in an appropriate manner.

Accordingly, in a first aspect the present invention provides use of a VAChT COMPOUND, preferably a compound of formula I, as a way to control pest population, wherein the compound is insecticidally active by inhibition of, or affect the function of, the vesicular acetylcholine transporter (VAChT) of the insect, wherein the compound of formula I is represented by the formula A-B. wherein A is selected from A1 to A54, and B is selected from B1 to B27

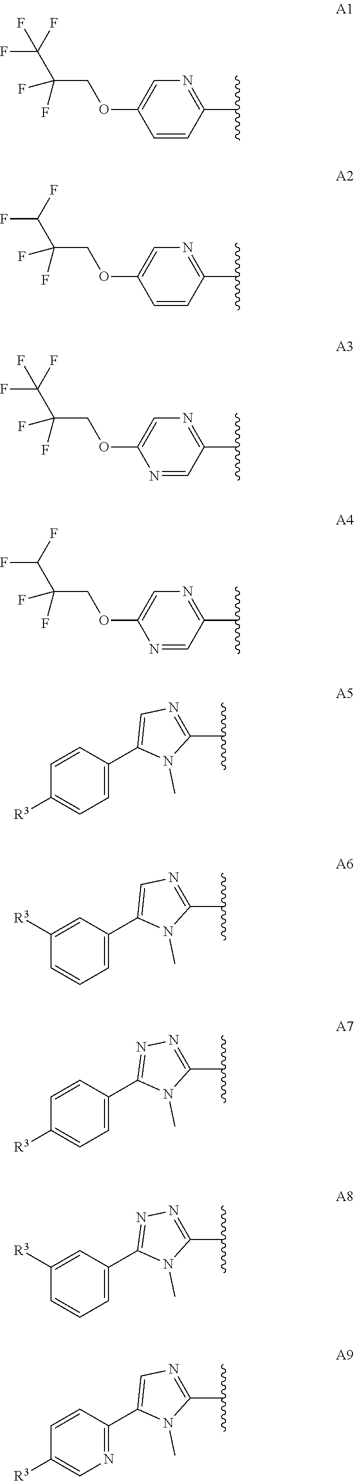

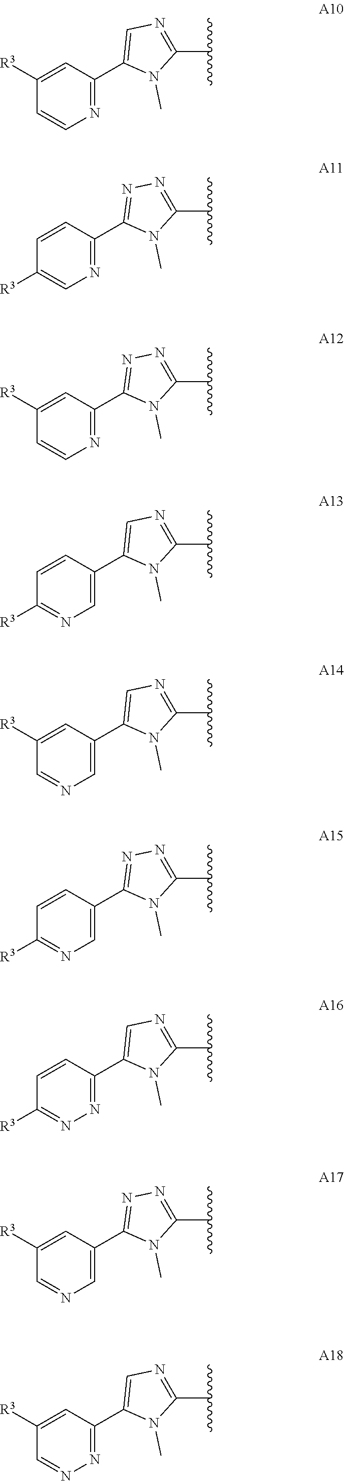

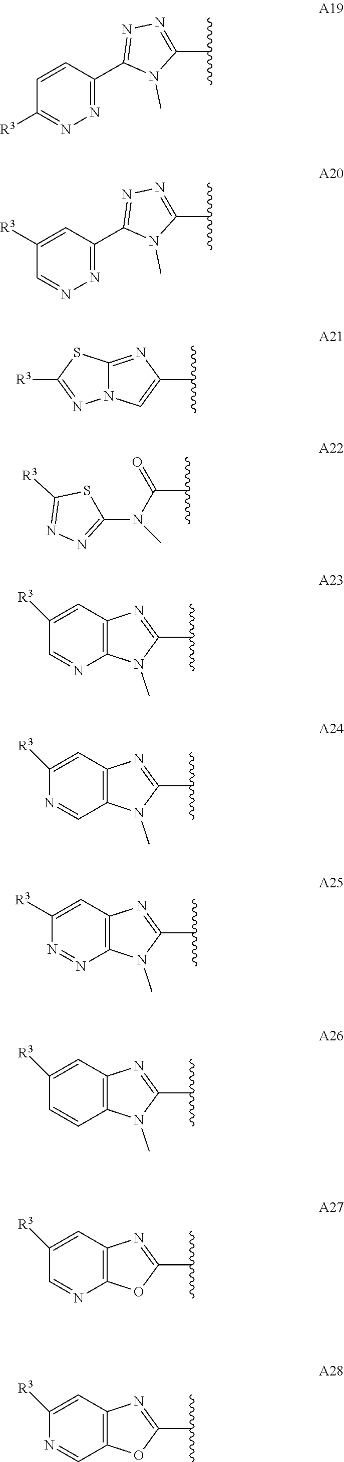

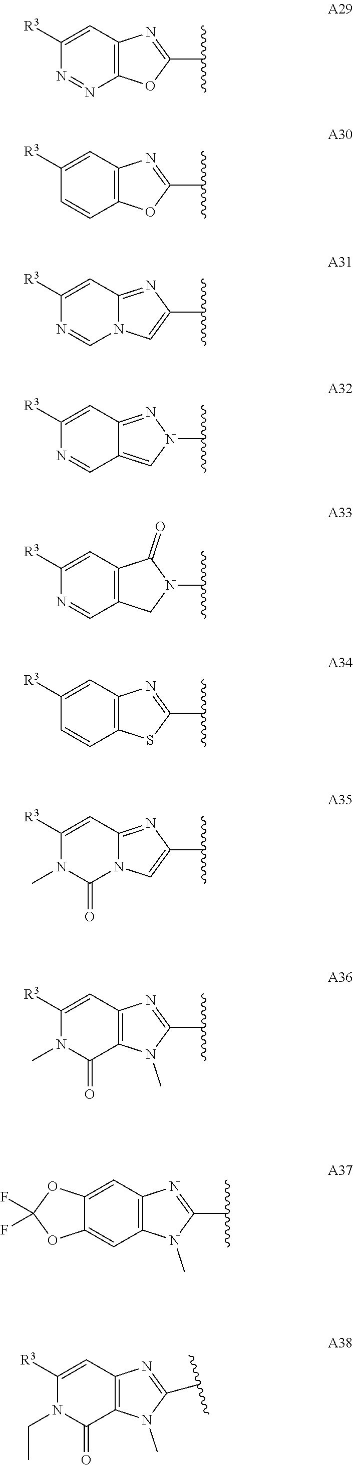

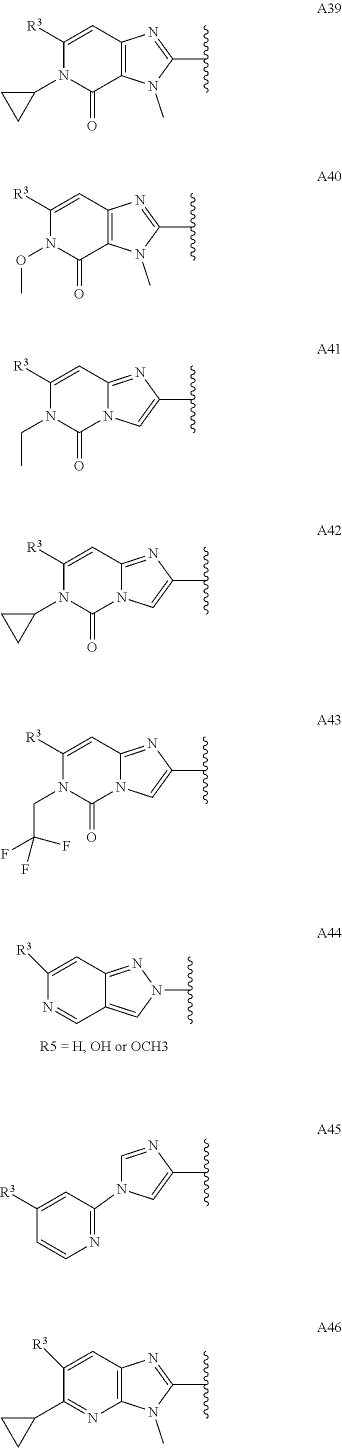

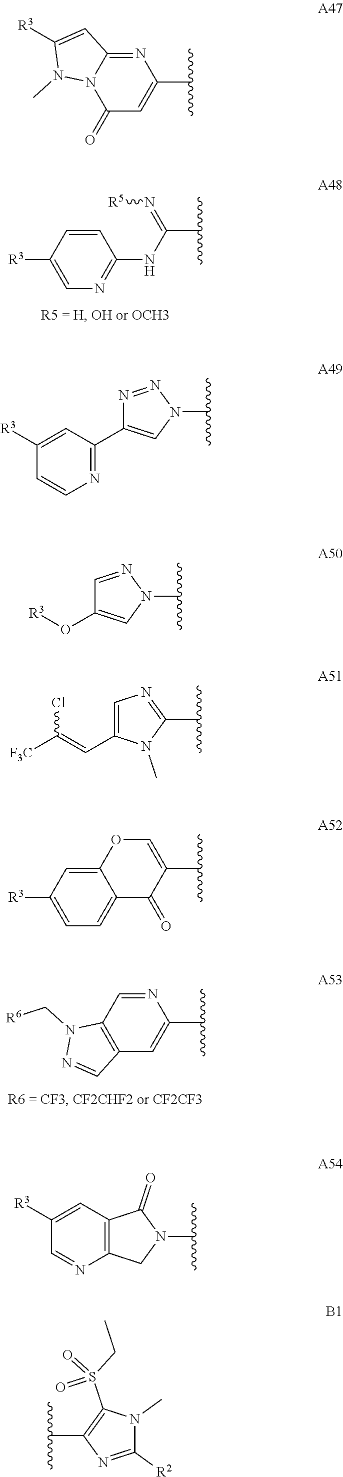

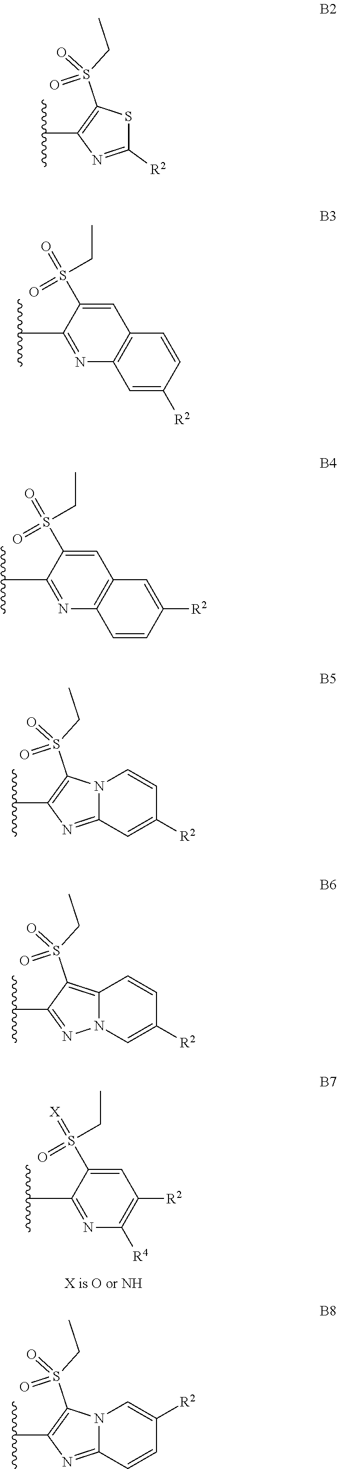

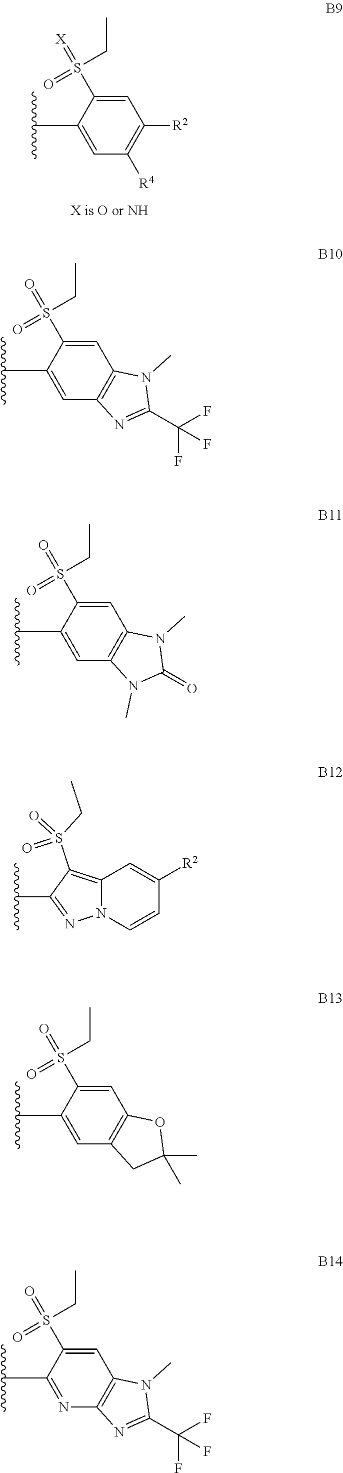

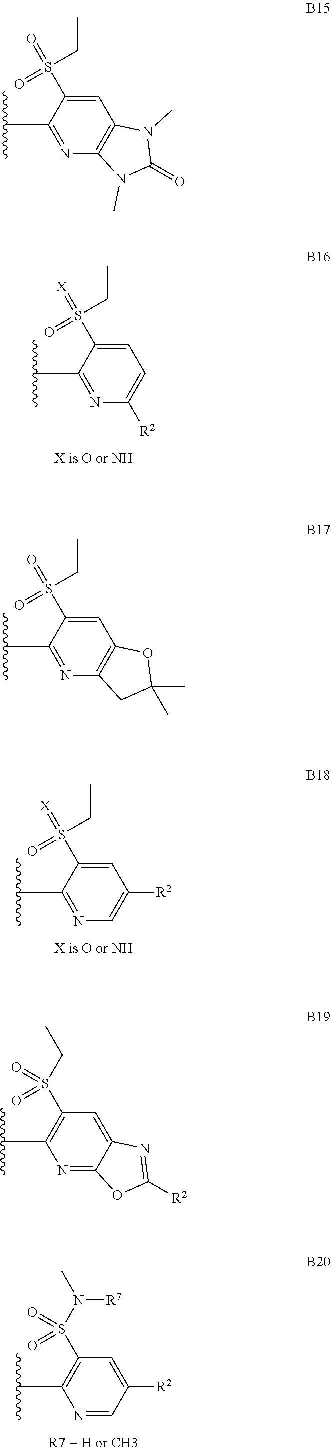

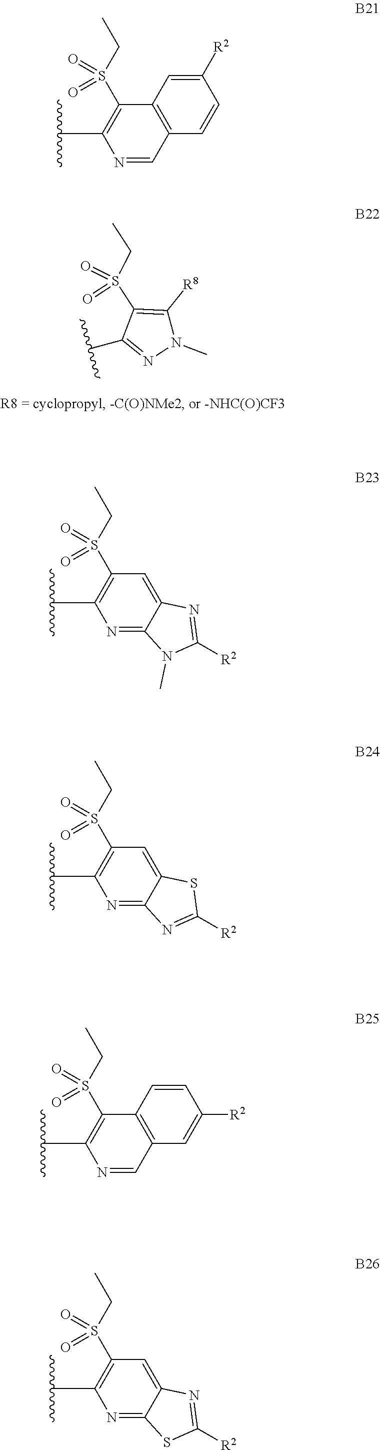

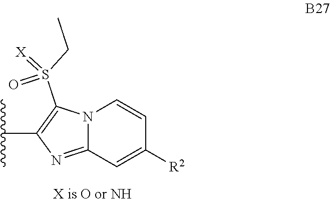

wherein
R² is hydrogen, bromine, CHF₂, CF₃, CF₂CF₃, or one of R2-1 to R2-25;
R³ is CHF₂, CF₃, CF₂CF₃, OCHF₂, OCF₃, OCF₂CF₃, SCF₃, SOCF₃, SO₂CF₃, SCHF₂, SOCHF₂, or SO₂CHF₂; and
R⁴ is hydrogen or methyl;
as well as agrochemically acceptable salts, enantiomers, diastereomers, tautomers, and N-oxides of formula I; where R2-1 to R2-25 is:

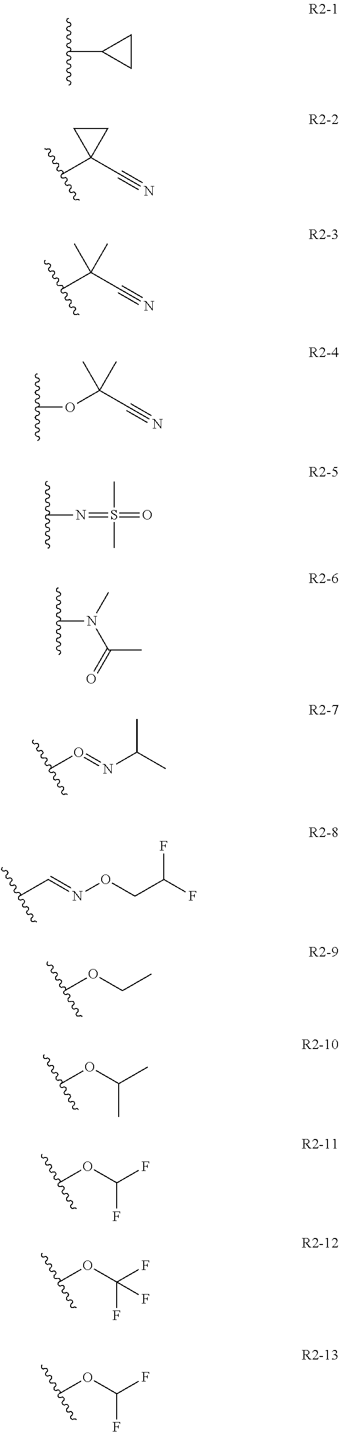

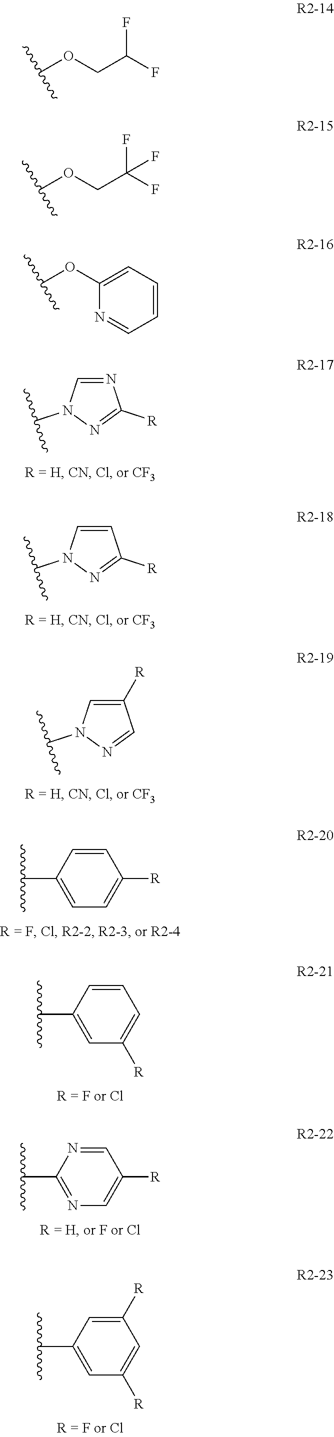

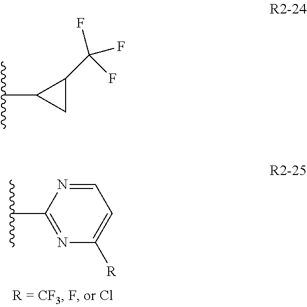

In a further aspect, present invention provide the use of a compound of formula I as defined in the first aspect, in controlling a multi-resistant insect, wherein the compound is insecticidally active by inhibition of, or affect the function of, the vesicular acetylcholine transporter (VAChT) of the pest.

In a second aspect, present invention provides a method for combating and controlling a pest, preferably an arthropod pest, such as an insect, resistant to one or more, preferably more than one, insecticides to
(i) reduce damage on a plant, which comprises applying to the pest, to a locus of the pest, or to a plant susceptible to attack by the pest, an effective amount of a compound of formula I; or
(ii) protect plant propagation material, which comprises treating the propagation material or the site, where the propagation material is planted, with an effective amount of a compound of formula I;
   wherein the compound of formula I is as defined in the first aspect.

In an embodiment of the second aspect, the compound is insecticidally active by inhibition of, or affect the function of, the vesicular acetylcholine transporter (VAChT) of a pest.

In a third aspect, present invention provides a method of controlling or managing insecticide-resistance development of a pest comprising
a) applying to the pest, to a locus of the pest, to a plant susceptible to attack by the pest, or
b) treating a propagation material or its site;
   an effective amount of a compound, preferably a compound of the formula I as defined in in the first aspect, which compound is insecticidally active by inhibition of, of affect the function of, the vesicular acetylcholine transporter (VAChT) of such pest, optionally in combination with an effective amount of another compound which is insecticidally active other than by inhibition of, or affect the function of, the vesicular acetylcholine transporter (VAChT).

In an embodiment of the third aspect, the other compound is insecticidally active by inhibition of the voltage-dependent sodium channel (IRAC group 22).

Application methods for management of the development of pest resistance is known in the art, and availability of a compound, which is insecticidally active by inhibition of, or affect the function of, the vesicular acetylcholine transporter (VAChT) of such pest, now provides a further resource to growers and farmers.

Accordingly, the present invention also provides the use of a VAChT compound, preferably a compound of the formula I as defined in in the first aspect, for reducing the risk of development of resistance of a pest against an insecticide.

In an embodiment of each aspect, the pest is a multi-resistant arthropod pest, preferably a multi-resistant insect pest.

In an embodiment of each aspect, in a defined area, the ratio of the resistant pest to the sensitive pest is greater than 1:20 (based on number of pests); preferably greater 1:10; more preferably greater than 1:8, such as greater than 1:5.

In an embodiment of each aspect, the pest is resistant to insecticides belonging to one or more, preferably more than one, mode of action groups 1 to 34 as defined by the Insecticide Resistance Action Committee (IRAC; https://irac-online.org/mode-of-action/classification-online/).

The term “pest” as used herein refers those pests that cause damage and/or inconvenience in agriculture, in horticulture, in ornamentals, and in forests, or on organs, such as fruits, flowers, foliage, stalks, tubers, plant propagation material (such as seeds), and roots, of such plants, and in some cases even plant organs which are formed at a later point in time. Examples of pests include arthropod pests, and nematodes; preferably insects, mities and acarina, particularly insects.

A VAChT COMPOUND can control one or more insect species selected form Acrosternum hilare, Adoxyphyes orana, Aedes aegypti, Aedes albopictus, Agrositis ipsilon, Alphitobius diaperinus, Amrasca biguttula, Anopheles gambiae, Anopheles stephensi, Ant spp., Anthonomus grandis, Aphis citricola/spiraecola, Aphis glycines, Aphis gossypii, Bactericera cockerelli, Bemisia tabaci, Blatta orientalis, Blattella germanica, Blissus insularis barber, Blissus leucopterus, Chilo infuscatellus, Chilo suppressalis, Choristoneura rosaceana, Chrysodeixis includens, Cimex lectularius, Cnaphalocrosis medinalis, Crambus sp, Cydia pomonella, Dalbulus maidis, Diabrotica speciosa, Diabrotica balteata, Diabrotica virgifera, Diatraea saccharalis, Dichelops meloncanta/furcatus, Diphorinia citri, Elasmopalpus lignoselus, Euschistus heros, Euschistus servus, Euxesta eluta (spp), Exomala orientalis, Frankliniella fusca, Frankliniella occidentalis, Frankliniella schutzei, Grapholita molesta, Helicoverpa armigera, Helicoverpa zea, Heliothis virescens, Herpetogramma phaeopteralis, Hypothenemus hampei, Leptinotarsa decemlineata, Leucinodes orbonalis, Leucoptera coffeella, Liriomyza trifolii/hudibriensis, Lissorhoptrus oryzophilus, Listronotus maculicollis, Lygus lineolaris, Mahanarva fimbriolata, Maladera castanea, Maruca testulalis, Musca domestica, Myzus persicae, neoleucinoides, Nezara viridula, Nilaparvata lugens, Ostrinia spp., Parapediasia teterrella, Pectinophora gossypiella, Periplaneta americana, Phyllocnistis citrella, Phyllotreata spp., Piezodorus guildini, Plutella xylostella, Popillia japonica, Psylla pyricola (spp), Rhizotrogus majalis, Scirpophaga incertulas, Scirtothrips aurantii, Scirtothrips citri, Scirtothrips dorsalis, Sesamia inferens, Sogatella furcifera, Spenophorus sp. Sphenophorus parvulus Gyllenhal; S. fenatus, S. cicatristriatus, Spodoptera cosmiodies, Spodoptera eridania, Spodoptera exigua, Spodoptera frugiperda, Spodoptera litura, Striacosta albicosta, Termite spp., Thrips palmi, Thrips tabaci, Tipula oleracea, Tipula paludosa, Trialeurodes vaporariorum, and Tuta absoluta.

In an embodiment of each aspect, a VAChT COMPOUND, preferably of the formula I, such as any one of formula Ia to In, controls one or more insect strains or biotypes selected from Acrosternum hilare, Adoxyphyes orana, Amrasca biguttula, Anthonomus grandis, Aphis citricola/spiraecola, Aphis glycines, Aphis gossypii, Bactericera cockerelli, Bemisia tabaci, Chilo infuscatellus, Chilo suppressalis, Choristoneura rosaceana, Chrysodeixis includens, Cnaphalocrosis medinalis, Cydia pomonella, Dalbulus maidis, Diabrotica speciosa, Diabrotica virgifera, Diatraea saccharalis, Dichelops meloncanta/furcatus, Diphorinia citri, Elasmopalpus lignoselus, Euschistus heros, Euschistus servus, Euxesta eluta (spp), Frankliniella fusca, Frankliniella occidentalis, Frankliniella schutzei, Grapholita molesta, Helicoverpa armigera, Helicoverpa zea, Heliothis virescens, Hypothenemus hampei, Leptinotarsa decemlineata, Leucinodes orbonalis, Leucoptera coffeella, Liriomyza trifolii/hudibriensis, Lissorhoptrus oryzophilus, Lygus lineolaris, Mahanarva fimbriolata, Maruca testulalis, Myzus persicae, neoleucinoides, Nezara viridula, Nilaparvata lugens, Ostrinia spp., Pectinophora gossypiella, Phyllocnistis citrella, Phyllotreata spp., Piezodorus guildini, Plutella xylostella, Psylla pyricola (spp), Scirpophaga incertulas, Scirtothrips aurantii, Scirtothrips citri, Scirtothrips dorsalis, Sesamia inferens, Sogatella furcifera, Spodoptera cosmiodies, Spodoptera eridania, Spodoptera exigua, Spodoptera frugiperda, Spodoptera litura, Striacosta albicosta, Thrips palmi, Thrips tabaci, Trialeurodes vaporariorum, and Tuta absoluta,

In an embodiment of each aspect, a VAChT COMPOUND, preferably of the formula I, such as any one of formula Ia to In, controls one or more insect strains or biotypes in the table below, in particular for the crop(s)/use(s) indicated. The insect strains are resistant against one or more, preferably more than one, insecticides belonging to different IRAC groups (IRAC stands for the “Insecticide Resistance Action Committee”; https://irac-online.org/mode-of-action/classification-online/), The role of IRAC is to prolong the effectiveness of insecticides, acaricides and traits by implementing insecticide resistance management strategies, countering the development of resistance in the three core sectors of traditional Crop Protection, Plant Biotechnology and Public Health.

In an embodiment of each aspect, a VAChT compound, preferably of the formula I, such as any one of formula Ia to In, controls a Myzus persicae species having enhanced P450 metabolism (CYP6CY3); having target site mutations, which confer resistance to neonicotinoids (nAChR: R81T); and to pyrethroids (VGSC: L1014F and M918T); and carrying the FE4 R3 carboxylesterase overexpression which confers resistance to organophosphates, carbamates and pyrethroids.

In an embodiment of each aspect, a VAChT compound, preferably of the formula I, such as any one of formula Ia to In, controls a Nilaparvata lugen species having an enhanced P450-mediated metabolism conferring resistance to neonicotinoids IRAC 4A.

In an embodiment of each aspect, a VAChT compound, preferably of the formula I, such as any one of formula Ia to In, controls a Bemisia tabaci species having mutations, which confer resistance to pyrethroids (IRAC 3A) (VGSC: L925I); and to tetronic and tetramic acid derivatives (IRAC Group 23) (ACCase_A2083V); and having a higher expression of the P450 (CYP6CM1) conferring metabolic resistance to neonicotinoids.

In an embodiment of each aspect, a VAChT compound, preferably of the formula I, such as any one of formula Ia to In, controls Plutella xylostella species having a number of target-sites mutations, which confer resistance to pyrethroids (VGSC: L1014F, T929I); organophosphates and carbamates (IRAC group 1) (AChE: A298S, F386F/V, G324A); organochlorines (rdl: A298S); diamides (ryr: G4546E); oxadiazines (IRAC Group 22A) (VGSC: V1848I); and benzoylureas (IRAC Group 15) (CHS1: I1042M).

In an embodiment of each aspect, a VAChT compound, preferably of the formula I, such as any one of formula Ia to In, controls Diabrotica balteata species having target site mutations, which confers resistance to organochlorines (rdl: A280S, V311I, and Q340R).

In an embodiment of each aspect, a VAChT compound, preferably of the formula I, such as any one of formula Ia to In, controls houseflies having kdr mutation (L1014F), or super-kdr mutation (M918T), conferring resistance to pyrethroids.

| | Resistance against insecticides | |
|---|---|---|
| Species | in the IRAC Group | Crop(s) |
| Chrysodeixis includens | 3, 18, 28 | Soybean |
| Euschistus heros | 3, 4 | Soybean |
| Anthonomus grandis | 1, 2, 3 | Cotton |
| Amrasca biguttula | 4 | Cotton |
| Frankliniella fusca | 4 | Cotton |
| Lygus lineolaris | 1, 2, 3 | Cotton |
| Thrips tabaci | 1, 2, 3, 4, 5, 6 | Cotton/Vegetables |
| Bemisia tabaci | 1, 2, 3, 4, 7, 9, 16, 23 | Cotton/Soybean/ |
| | | Vegetables/Potato |
| Aphis gossypii | 1, 2, 3, 4 | Cotton/Vegetables |
| Pectinophora gossypiella | 1, 3, 5, 11 | Cotton |
| Heliothis virescens | 1, 2, 3, 5, 11, 22 | Cotton |
| Helicoverpa armigera | 1, 3, 5, 6, 11, 13, 22, | Cotton/Soybean/ |
| | | Vegetables |
| Dichelops | 3 | Corn |
| Meloncanta/Furcatus | | |
| Spodoptera frugiperda | 1, 3, 5, 6, 11, 15, 28 | Corn/Vegetables |
| Helicoverpa zea | 1, 2, 3, 11 | Corn |
| Diabrotica virgifera | 1, 2, 11 | Corn |
| Ostrinia spp. | 3, 11 | Corn |
| Sesamia inferens | 2, 5 | Rice/Corn |
| Nilaparvata lugens | 1, 2, 4, 16 | Rice |
| Sogatella furcifera | 1, 2, 4, 16 | Rice |
| Chilo suppressalis | 1, 2, 3, 11, 28 | Rice |
| Scirpophaga incertulas | 1, 28 | Rice |
| Lissorhoptrus oryzophilus | 1, 2 | Rice |
| Myzus persicae | 1, 2, 3, 4, 29 | Vegetables/Potato |
| Frankliniella occidentalis | 1, 2, 3, 4, 5, 6, 7 | Vegetables |
| Thrips palmi | 1, 3, 5 | Vegetables |
| Scirtothrips dorsalis | 5 | Vegetables |
| Trialeurodes vaporariorum | 1, 2, 3, 4, 7, 9, 16, 23 | Vegetables |
| Leucinodes orbonalis | 28 | Vegetables |
| Tuta absoluta | 1, 3, 5, 6, 14, 15, 22 | Vegetables |
| Spodoptera exigua | 1, 3, 5, 6, 11, 13, 15, 18, 22, 28, UN | Vegetables/Brassica |
| Spodoptera litura | 1, 2, 3, 5, 6, 13, 15, 18, 22, 28 | Vegetables/Soybean |
| Liriomyza | 1, 3, 5, 6, 17 | Vegetables |
| trifolii/Hudibriensis | | |
| Plutella xylostella | 1, 2, 3, 5, 6, 7, 11, 12, | Brassica |
| | 13, 14, 15, 18, 22, 28, 31 | |
| Phyllotreata spp. | 2 | Brassica/Canola |
| Cydia pomonella | 1, 2, 3, 4, 7, 15, 18, 22, 31 | Pome Fruit |
| Grapholita molesta | 3 | Pome Fruit |
| Adoxyphyes orana | 1 | Pome Fruit |
| Psylla pyricola (spp) | 1, 2 | Pome Fruit |
| Choristoneura rosaceana | 1, 3, 11, 18, 22 | Pome Fruit |
| Bactericera cockerelli | 4 | Potato |
| Leptinotarsa decemlineata | 1, 2, 3, 4, 5, 6, 11 | Potato |
| Phyllocnistis citrella | 1 | Citrus |
| Diphorinia citri | 3, 4, 13 | Citrus |
| Aphis citricola/Spiraecola | 1, 4 | Citrus |
| Scirtothrips citri | 1, 2, 3 | Citrus |
| Diatraea saccharalis | 1, 2, 11 | Sugarcane |
| Leucoptera coffeella | 1, 28 | Coffee |
| Hypothenemus hampei | 2 | Coffee |
| Blissus insularis barber | 1B, 2A, 3A, 4 | Turf - St. Augustine |
| | | Stenotaphrum secundatum |
| Blissus leucopterus | 1B, 2A, 3A, 4 | Turf - Poa pratensis, |
| | | Festuca sp., Lolium sp. |
| Listronotus maculicollis | 3A, 1B, 22A | Turf - Poa annua |
| Popillia japonica | 4A | Turf - Poa pratensis, |
| | | Festuca sp., Lolium sp. |
| Rhzotrogus Majalis | 4A | Turf - Poa pratensis, |
| | | Festuca sp., Lolium sp. |
| Exomala orientalis | 4A | Turf - Poa pratensis, |
| | | Festuca sp., Lolium sp. |
| Maladera castanea | 4A | Turf - Poa pratensis, |
| | | Festuca sp., Lolium sp. |
| Spenophorus sp. | 3A, 4A | Turf |
| Sphenophorus parvulus | | |
| Gyllenhal; S. Fenatus, | | |
| S. cicatristriatus | | |
| Blattella germanica | 1A, 1B, 2A, 2B, 3A, 3B, 4A, etc. | Professional Pest |
| | | Management (PPM) |
| Blatta orientalis | 1A, 1B, 2A, 2B, 3A, 3B, 4A, etc. | PPM |
| Periplaneta americana | 1A, 1B, 2A, 2B, 3A, 3B, 4A, etc. | PPM |
| Musca domestica | 1A, 1B, 2A, 2B, 3A, 3B, 4A, 5, etc. | PPM |
| Cimex lectularius | 1A, 1B, 2A, 2B, 3A, 3B, 4A, | PPM |
| Aedes aegypti | 1A, 1B, 2A, 2B, 3A, 3B, 4A, 7A, 11 | Vector Control (VC) |
| Aedes albopictus | 1A, 1B, 2A, 2B, 3A, 3B, 4A, 7A | VC |
| Anopheles gambiae | 1A, 1B, 2A, 2B, 3A, 3B, 4A | VC |
| Anopheles stephensi | 1A, 1B, 2A, 2B, 3A, 3B, 4A | VC |
| Alphitobius diaperinus | 1A, 1B, 2A, 2B, 3A, 3B | Farm hygiene |

The pests in the table can be resistant to the listed insecticide groups via target site mutations (such as kdr, rdl, MACE) or other mechanisms, such as metabolic processes, sequestration, or reduced cuticular penetation

In an embodiment of each aspect, the resistant insect is one or more of Chrysodeixis includens, Euschistus heros, Anthonomus grandis, Amrasca biguttula, Frankliniella fusca, Lygus lineolaris, Thrips tabaci, Bemisia tabaci, Aphis gossypii, Pectinophora gossypiella, Heliothis virescens, Helicoverpa armigera, Dichelops meloncanta/furcatus, Spodoptera frugiperda, Helicoverpa zea, Diabrotica virgifera, Diabrotica balteata, Ostrinia spp., Sesamia inferens, Nilaparvata lugens, Sogatella furcifera, Chilo suppressalis, Scirpophaga incertulas, Lissorhoptrus oryzophilus, Myzus persicae, Frankliniella occidentalis, Thrips palmi, Scirtothrips dorsalis, Trialeurodes vaporariorum, Leucinodes orbonalis, Tuta absoluta, Spodoptera exigua, Spodoptera litura, Liriomyza trifolii/hudibriensis, Plutella xylostella, Phyllotreata spp., Cydia pomonella, Grapholita molesta, Adoxyphyes orana, Choristoneura rosaceana, Leptinotarsa decemlineata, Phyllocnistis citrella, Diatraea saccharalis, Leucoptera coffeella, and Hypothenemus hampei.

In an embodiment of each aspect, the insecticide resistance comprises an insect biotype with resistance to single or multiple insecticides, single or multiple chemical classes and single or multiple 14nsecticide modes-of-action or via multiple resistance mechanisms.

In an embodiment of each aspect, the pest is resistant to insecticides belonging to one or more, preferably more than one, IRAC mode of action groups selected from 1, 2, 3, 4, 5, 6, 7, 9, 11, 12, 13, 14, 15, 16, 17, 18, 22, 23, 28, 29, and 31.

In an embodiment of each aspect, the pest is resistant to insecticides belonging to one or more, preferably more than one, IRAC mode of action groups selected 1, 2, 3, 4, 5, 6, 7, 9, 11, 12, 13, 14, 15, 16, 18, 22, 23, 28, 29, and 31.

In an embodiment of each aspect, the pest is resistant to insecticides belonging to one or more, preferably more than one, IRAC mode of action groups selected 1A, 1B, 2B, 3A, 4A, 6, and 28.

In a further embodiment of each aspect, the resistant insect is one or more of Thrips tabaci, Bemisia tabaci, Aphis gossypii, Nilaparvata lugens, Sogatella furcifera, Myzus persicae, Frankliniella occidentalis, Trialeurodes vaporariorum, Tuta absoluta, and Plutella xylostella.

In an embodiment of each aspect, the resistant insect is one or more of Bemisia tabaci, Nilaparvata lugens, Myzus persicae, and Plutella xylostella.

In a further embodiment of each aspect, the pest, preferably an arthropod pest, such as an insect, is resistant to least one insecticide selected from diamides, pyrethroids, carbamates, organophosphates, and neonicotinoids.

In an embodiment of each aspect, the pest, preferably an arthropod pest, such as an insect, is resistant to neonicotinoids or diamides.

The VAChT COMPOUNDS are active against all life stages of the resistant pest, preferably an arthropod pest, such as an insect.

In an embodiment of each aspect, a VAChT compound controls a multi-resistant insect species.

The VAChT COMPOUNDS are preferably compounds of the formula I as defined in herein.

In an embodiment of each aspect, formula I is represented by
a) formula Ia wherein A-B is A3 and B7; or
b) formula Ib wherein A-B is A12 and B7; or
c) formula Ic wherein A-B is A23 and B7; or
d) formula Id wherein A-B is A23 and B6; or
e) formula Ie wherein A-B is A23 and B5; or
f) formula If wherein A-B is A23 and B8; or
g) formula Ig wherein A-B is A23 and B12; or
h) formula Ih wherein A-B is A24 and B7; or
i) formula Ii wherein A-B is A25 and B7; or
j) formula Ij wherein A-B is A26 and B7; or
k) formula Ik wherein A-B is A27 and B7; or
l) formula Il wherein A-B is A30 and B7; or
m) formula Im wherein A-B is A37 and B7; or
n) formula In wherein A-B is A30 and B16
   wherein in each of (a) to (m), independent of each other, R³ (if present) is CF₃, CF₂CF₃, OCHF₂, OCF₃, OCF₂CF₃, SCF₃, SOCF₃, SO₂CF₃, SCHF₂, SOCHF₂, or SO₂CHF₂; R² is hydrogen, CHF₂, CF₃, CF₂CF₃, or one of R2-1 to R2-25; R⁴ (if present) is hydrogen or methyl; and X (if present) is oxygen or NH.

In an embodiment of each aspect, formula I is composed of radicals A23 and B7, wherein R³ is CF₃; R² is hydrogen, CF₃, R2-1, R2-2, R2-3, or R2-4; R⁴ is hydrogen, or methyl; and X is oxygen or NH.

In an embodiment of each aspect, formula I is composed of radicals A23 and B7, wherein R³ is CF₃; R² is R2-1, or R2-2; R⁴ is hydrogen; and X is oxygen or NH.

In an embodiment of each aspect, formula I is composed of radicals A23 and B8, wherein R³ is CF₃; R² is hydrogen, CF₃, R2-1, R2-2, R2-3, or R2-4; R⁴ is hydrogen, or methyl; and X is oxygen or NH.

In an embodiment of each aspect, formula I is composed of radicals A23 and B8, wherein R³ is CF₃; R² is CF₃; R⁴ is hydrogen; and X is oxygen or NH.

In an embodiment of each aspect, formula I is composed of radicals A24 and B7, wherein R³ is CF₃; R² is hydrogen, CF₃, R2-1, R2-2, R2-3, or R2-4; R⁴ is hydrogen, or methyl; and X is oxygen or NH.

In an embodiment of each aspect, formula I is composed of radicals A24 and B7, wherein R³ is CF₃; R² is R2-1, or R2-2; R⁴ is hydrogen; and X is oxygen or NH.

In an embodiment of each aspect, formula I is composed of radicals A26 and B7, wherein R³ is CF₃; R² is hydrogen, CF₃, R2-1, R2-2, R2-3, or R2-4; R⁴ is hydrogen, or methyl; and X is oxygen or NH.

In an embodiment of each aspect, formula I is composed of radicals A26 and B7, wherein R³ is CF₃; R² is R2-1, or R2-2; R⁴ is hydrogen; and X is oxygen or NH.

In an embodiment of each aspect, formula I is composed of radicals A27 and B7, wherein R³ is CF₃, or SO₂CF₃; R² is hydrogen, CF₃, R2-1, R2-2, R2-3, or R2-4; R⁴ is hydrogen, or methyl; and X is oxygen.

In an embodiment of each aspect, formula I is composed of radicals A27 and B7, wherein R³ is CF₃; R² is R2-1, or R2-2; R⁴ is hydrogen; and X is oxygen.

In an embodiment of each aspect, formula I is composed of radicals A30 and B7, wherein R³ is CF₃, SOCF₃, or SO₂CF₃; R² is hydrogen, CF₃, R2-1, R2-2, R2-3, or R2-4; R⁴ is hydrogen, or methyl; and X is oxygen.

In an embodiment of each aspect, formula I is composed of radicals A30 and B7, wherein R³ is SOCF₃, or SO₂CF₃; R² is hydrogen, or R2-1; R⁴ is hydrogen; and X is oxygen.

In an embodiment of each aspect, formula I is composed of radicals A12 and B7, wherein R³ is CF₃; R² and R⁴ are each hydrogen; and X is oxygen.

In an embodiment of each aspect, formula I is composed of radicals A3 and B7, wherein R² and R⁴ are each hydrogen; and X is oxygen.

In an embodiment of each aspect, formula I is composed of radicals A37 and B7, wherein R² is R2-1 or R2-2; R⁴ is hydrogen; and X is oxygen.

In an embodiment of each aspect, formula I is composed of radicals A23 and B6, wherein R³ is CF₃; R² is CF₃; and X is oxygen.

In an embodiment of each aspect, formula I is composed of radicals A23 and B12, wherein R³ is CF₃; R² is CF₃; and X is oxygen.

In an embodiment of each aspect, formula I is composed of radicals A23 and B5, wherein R³ is CF₃; R² is CF₃; and X is oxygen.

In an embodiment of each aspect, formula I is composed of radicals A23 and B8, wherein R³ is CF₃; R² is CF₃; and X is oxygen.

In an embodiment of each aspect, formula I is composed of radicals A30 and B16, wherein R³ is SO₂CF₃; X is oxygen; and R² is hydrogen.

In an embodiment of each aspect, the VAChT COMPOUND is selected from the Table below:

VAChT-1

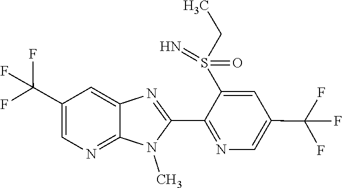 [SMILES: CCS(=N)(=O)c1cc(C(F)(F)F)cnc1-c1nc2cc(C(F)(F)F)cnc2n1C]

VAChT-2

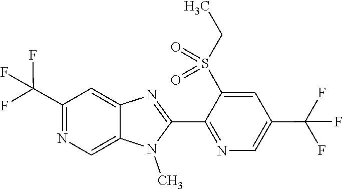 [SMILES: CCS(=O)(=O)c1cc(C(F)(F)F)cnc1-c1nc2cc(C(F)(F)F)ncc2n1C]

VAChT-3

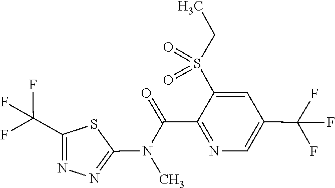 [SMILES: CCS(=O)(=O)c1cc(C(F)(F)F)cnc1C(=O)N(C)c1nnc(C(F)(F)F)s1]

VAChT-4

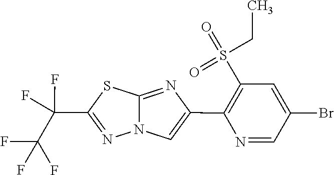 [SMILES: CCS(=O)(=O)c1cc(Br)cnc1-c1cn2nc(C(F)(F)C(F)(F)F)sc2n1]

VAChT-5

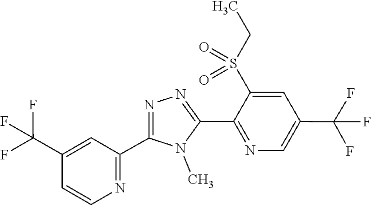 [SMILES: CCS(=O)(=O)c1cc(C(F)(F)F)cnc1-c1nnc(-c2cc(C(F)(F)F)ccn2)n1C]

VAChT-6

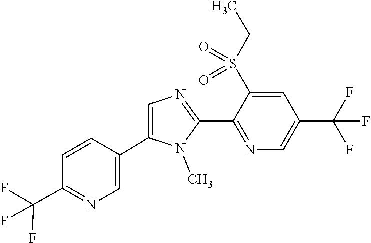 [SMILES: CCS(=O)(=O)c1cc(C(F)(F)F)cnc1-c1ncc(-c2ccc(C(F)(F)F)nc2)n1C]

VAChT-7

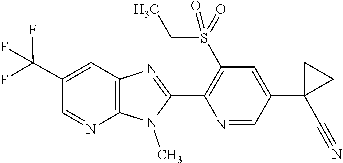 [SMILES: CCS(=O)(=O)c1cc(C2(C#N)CC2)cnc1-c1nc2cc(C(F)(F)F)cnc2n1C]

VAChT-8

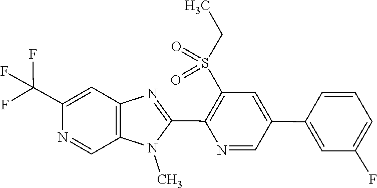 [SMILES: CCS(=O)(=O)c1cc(-c2cccc(F)c2)cnc1-c1nc2cc(C(F)(F)F)ncc2n1C]

VAChT-9

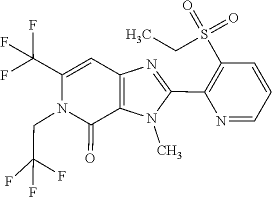 [SMILES: CCS(=O)(=O)c1cccnc1-c1nc2cc(C(F)(F)F)n(CC(F)(F)F)c(=O)c2n1C]

VAChT-10

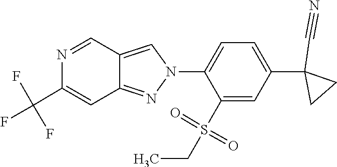 [SMILES: CCS(=O)(=O)c1cc(C2(C#N)CC2)ccc1-n1cc2cnc(C(F)(F)F)cc2n1]

VAChT-11

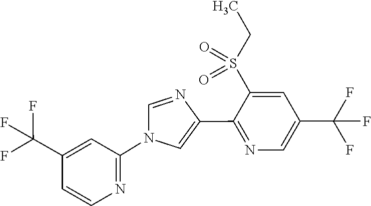 [SMILES: CCS(=O)(=O)c1cc(C(F)(F)F)cnc1-c1cn(-c2cc(C(F)(F)F)ccn2)cn1]

VAChT-12

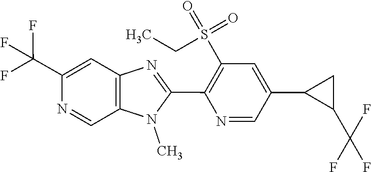 [SMILES: CCS(=O)(=O)c1cc(C2CC2C(F)(F)F)cnc1-c1nc2cc(C(F)(F)F)ncc2n1C]

VAChT-13

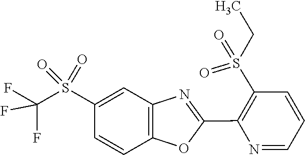 [SMILES: CCS(=O)(=O)c1cccnc1-c1nc2cc(S(=O)(=O)C(F)(F)F)ccc2o1]

VAChT-14

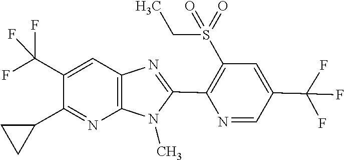 [SMILES: CCS(=O)(=O)c1cc(C(F)(F)F)cnc1-c1nc2cc(C(F)(F)F)c(C3CC3)nc2n1C]

VAChT-15

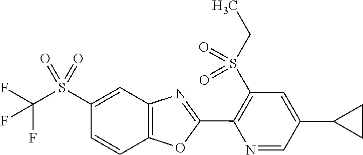 [SMILES: CCS(=O)(=O)c1cc(C2CC2)cnc1-c1nc2cc(S(=O)(=O)C(F)(F)F)ccc2o1]

VAChT-16

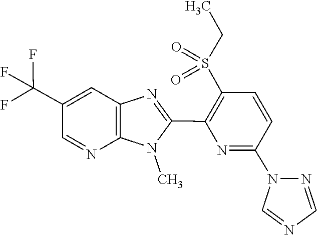 [SMILES: CCS(=O)(=O)c1ccc(-n2cncn2)nc1-c1nc2cc(C(F)(F)F)cnc2n1C]

VAChT-17

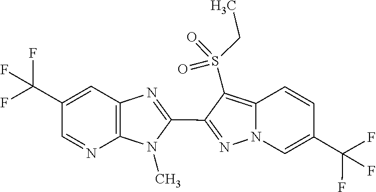 [SMILES: CCS(=O)(=O)c1c(-c2nc3cc(C(F)(F)F)cnc3n2C)nn2cc(C(F)(F)F)ccc12]

VAChT-18

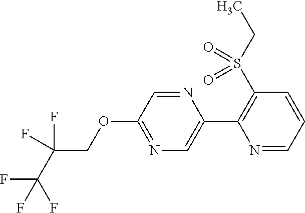 [SMILES: CCS(=O)(=O)c1cccnc1-c1cnc(OCC(F)(F)C(F)(F)F)cn1]

VAChT-19

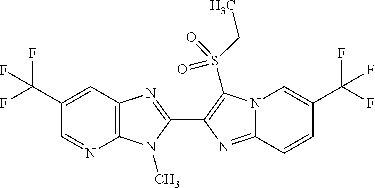 [SMILES: CCS(=O)(=O)c1c(-c2nc3cc(C(F)(F)F)cnc3n2C)nc2ccc(C(F)(F)F)cn12]

VAChT-20

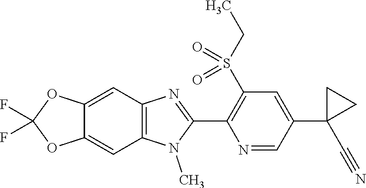 [SMILES: CCS(=O)(=O)c1cc(C2(C#N)CC2)cnc1-c1nc2cc3c(cc2n1C)OC(F)(F)O3]

VAChT-21

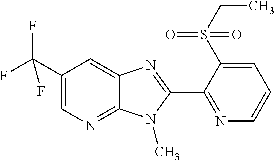 [SMILES: CCS(=O)(=O)c1cccnc1-c1nc2cc(C(F)(F)F)cnc2n1C]

VAChT-22

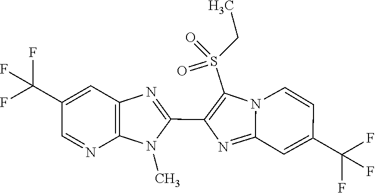 [SMILES: CCS(=O)(=O)c1c(-c2nc3cc(C(F)(F)F)cnc3n2C)nc2cc(C(F)(F)F)ccn12]

VAChT-23

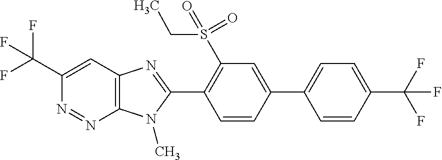 [SMILES: CCS(=O)(=O)c1cc(-c2ccc(C(F)(F)F)cc2)ccc1-c1nc2cc(C(F)(F)F)nnc2n1C]

VAChT-24

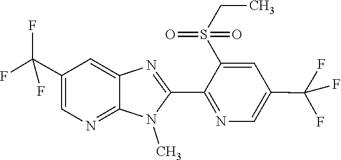 [SMILES: CCS(=O)(=O)c1cc(C(F)(F)F)cnc1-c1nc2cc(C(F)(F)F)cnc2n1C]

VAChT-25

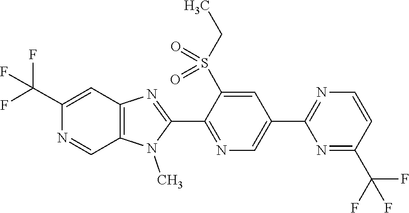 [SMILES: CCS(=O)(=O)c1cc(-c2nccc(C(F)(F)F)n2)cnc1-c1nc2cc(C(F)(F)F)ncc2n1C]

VAChT-26

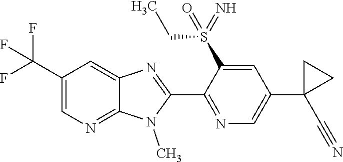

VAChT-27

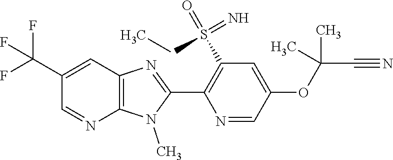

VAChT-28

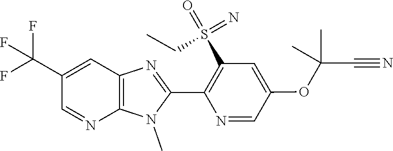

VAChT-29

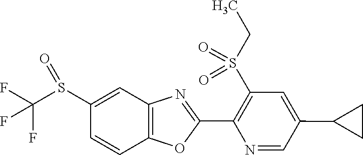 [SMILES: CCS(=O)(=O)c1cc(C2CC2)cnc1-c1nc2cc(S(=O)C(F)(F)F)ccc2o1]

VAChT-30

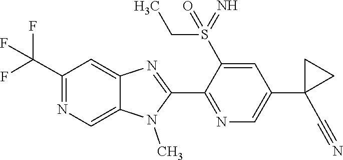 [SMILES: CCS(=N)(=O)c1cc(C2(C#N)CC2)cnc1-c1nc2cc(C(F)(F)F)ncc2n1C]

VAChT-31

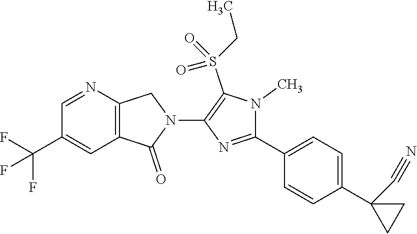 [SMILES: CCS(=O)(=O)c1c(N2Cc3ncc(C(F)(F)F)cc3C2=O)nc(-c2ccc(C3(C#N)CC3)cc2)n1C]

VAChT-32

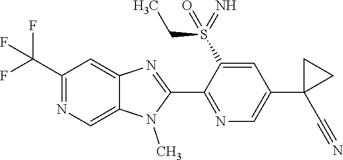 [SMILES: CC[S@](=N)(=O)c1cc(C2(C#N)CC2)cnc1-c1nc2cc(C(F)(F)F)ncc2n1C]

VAChT-33

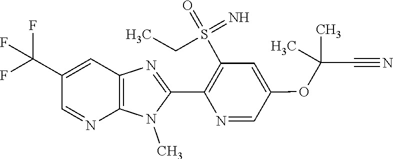 [SMILES: CCS(=N)(=O)c1cc(OC(C)(C)C#N)cnc1-c1nc2cc(C(F)(F)F)cnc2n1C]

VAChT-34

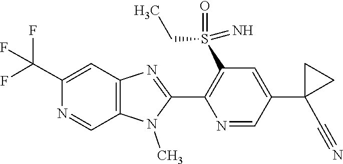 [SMILES: CC[S@@](=N)(=O)c1cc(C2(C#N)CC2)cnc1-c1nc2cc(C(F)(F)F)ncc2n1C]

VAChT-35

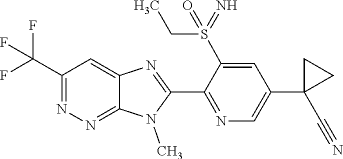 [SMILES: CCS(=N)(=O)c1cc(C2(C#N)CC2)cnc1-c1nc2cc(C(F)(F)F)nnc2n1C]

VAChT-36

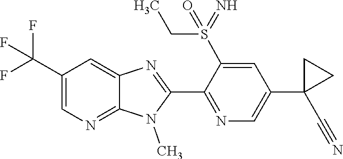 [SMILES: CCS(=N)(=O)c1cc(C2(C#N)CC2)cnc1-c1nc2cc(C(F)(F)F)cnc2n1C]

VAChT-37

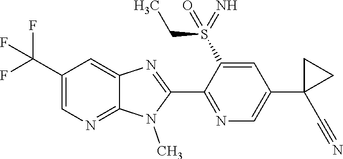 [SMILES: CC[S@](=N)(=O)c1cc(C2(C#N)CC2)cnc1-c1nc2cc(C(F)(F)F)cnc2n1C]

VAChT-38

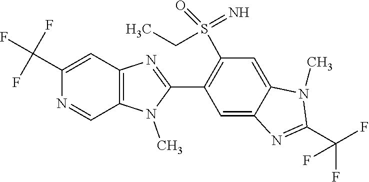 [SMILES: CCS(=N)(=O)c1cc2c(cc1-c1nc3cc(C(F)(F)F)ncc3n1C)nc(C(F)(F)F)n2C]

VAChT-39

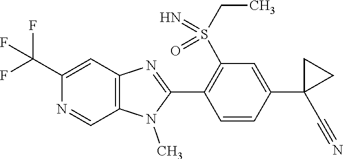 [SMILES: CCS(=N)(=O)c1cc(C2(C#N)CC2)ccc1-c1nc2cc(C(F)(F)F)ncc2n1C]

VAChT-40

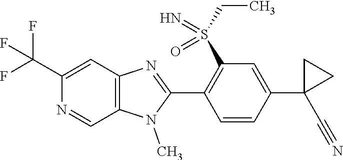 [SMILES: CC[S@@](=N)(=O)c1cc(C2(C#N)CC2)ccc1-c1nc2cc(C(F)(F)F)ncc2n1C]

VAChT-41

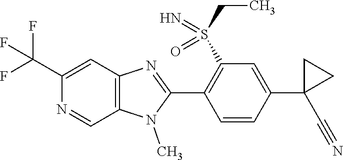 [SMILES: CC[S@](=N)(=O)c1cc(C2(C#N)CC2)ccc1-c1nc2cc(C(F)(F)F)ncc2n1C]

VAChT-42

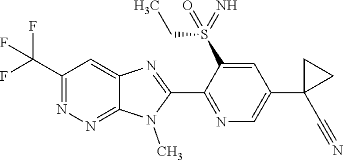 [SMILES: CC[S@@](=N)(=O)c1cc(C2(C#N)CC2)cnc1-c1nc2cc(C(F)(F)F)nnc2n1C]

VAChT-43

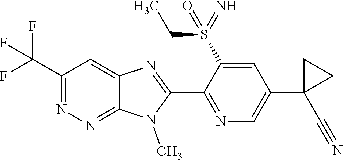 [SMILES: CC[S@](=N)(=O)c1cc(C2(C#N)CC2)cnc1-c1nc2cc(C(F)(F)F)nnc2n1C]

VAChT-44

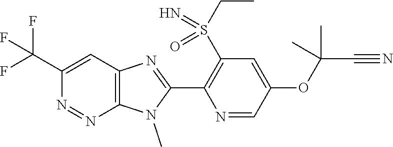 [SMILES: CCS(=N)(=O)c1cc(OC(C)(C)C#N)cnc1-c1nc2cc(C(F)(F)F)nnc2n1C]

VAChT-45

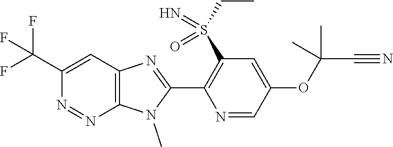 [SMILES: CC[S@@](=N)(=O)c1cc(OC(C)(C)C#N)cnc1-c1nc2cc(C(F)(F)F)nnc2n1C]

VAChT-46

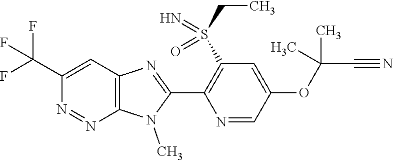 [SMILES: CC[S@](=N)(=O)c1cc(OC(C)(C)C#N)cnc1-c1nc2cc(C(F)(F)F)nnc2n1C]

VAChT-47

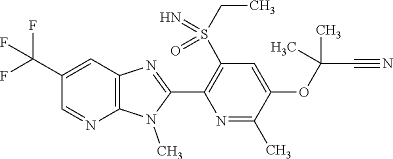 [SMILES: CCS(=N)(=O)c1cc(OC(C)(C)C#N)c(C)nc1-c1nc2cc(C(F)(F)F)cnc2n1C]

VAChT-48

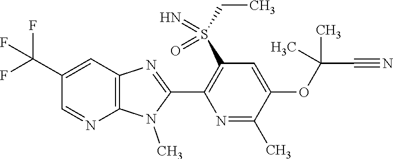 [SMILES: CC[S@@](=N)(=O)c1cc(OC(C)(C)C#N)c(C)nc1-c1nc2cc(C(F)(F)F)cnc2n1C]

VAChT-49

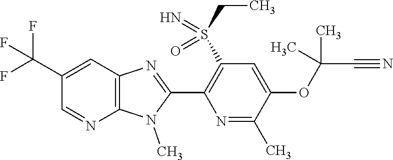 [SMILES: CC[S@](=N)(=O)c1cc(OC(C)(C)C#N)c(C)nc1-c1nc2cc(C(F)(F)F)cnc2n1C]

VAChT-50

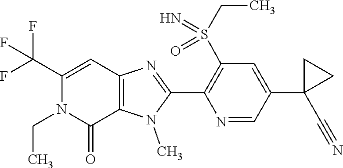 [SMILES: CCn1c(C(F)(F)F)cc2nc(-c3ncc(C4(C#N)CC4)cc3S(=N)(=O)CC)n(C)c2c1=O]

VAChT-51

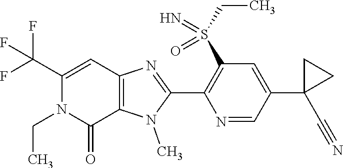 [SMILES: CCn1c(C(F)(F)F)cc2nc(-c3ncc(C4(C#N)CC4)cc3[S@](=N)(=O)CC)n(C)c2c1=O]

VAChT-52

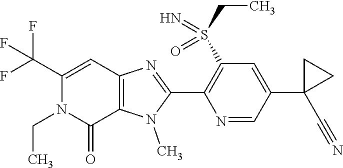 [SMILES: CCn1c(C(F)(F)F)cc2nc(-c3ncc(C4(C#N)CC4)cc3[S@@](=N)(=O)CC)n(C)c2c1=O]

VAChT-53

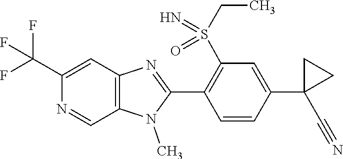 [SMILES: CCS(=N)(=O)c1cc(C2(C#N)CC2)ccc1-c1nc2cc(C(F)(F)F)ncc2n1C]

VAChT-54

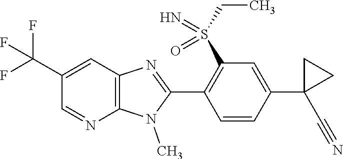 [SMILES: CC[S@@](=N)(=O)c1cc(C2(C#N)CC2)ccc1-c1nc2cc(C(F)(F)F)cnc2n1C]

VAChT-55

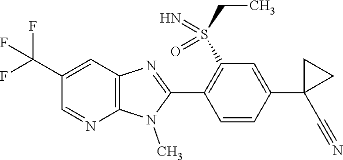 [SMILES: CC[S@](=N)(=O)c1cc(C2(C#N)CC2)ccc1-c1nc2cc(C(F)(F)F)cnc2n1C]

VAChT-56

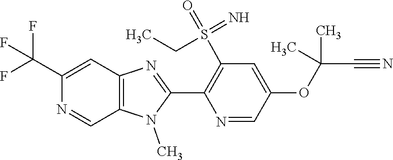 [SMILES: CCS(=N)(=O)c1cc(OC(C)(C)C#N)cnc1-c1nc2cc(C(F)(F)F)ncc2n1C]

VAChT-57

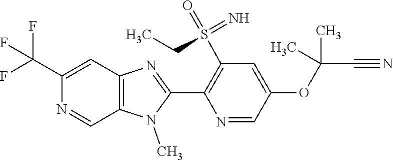 [SMILES: CC[S@](=N)(=O)c1cc(OC(C)(C)C#N)cnc1-c1nc2cc(C(F)(F)F)ncc2n1C]

VAChT-58

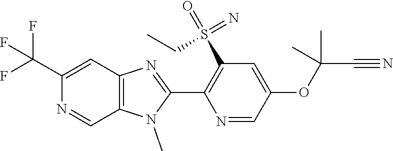 [SMILES: CC[S@@](=N)(=O)c1cc(OC(C)(C)C#N)cnc1-c1nc2cc(C(F)(F)F)ncc2n1C]

VAChT-59

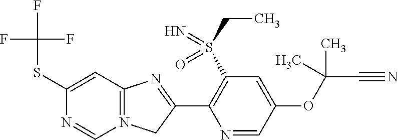

VAChT-60

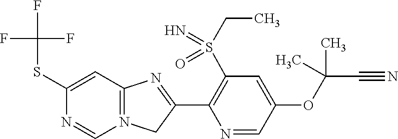

VAChT-61

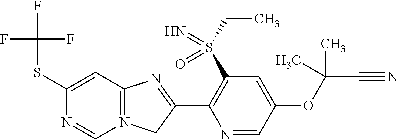

VAChT-62

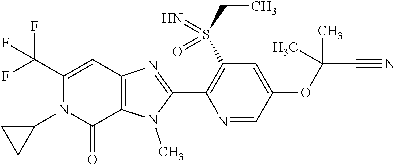 [SMILES: CC[S@](=N)(=O)c1cc(OC(C)(C)C#N)cnc1-c1nc2cc(C(F)(F)F)n(C3CC3)c(=O)c2n1C]

VAChT-63

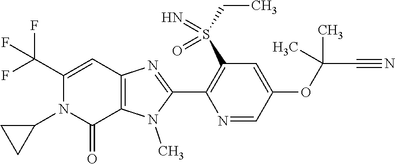 [SMILES: CC[S@@](=N)(=O)c1cc(OC(C)(C)C#N)cnc1-c1nc2cc(C(F)(F)F)n(C3CC3)c(=O)c2n1C]

VAChT-64

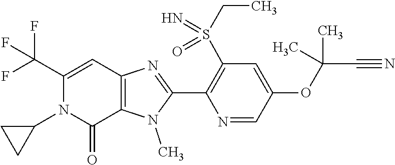 [SMILES: CCS(=N)(=O)c1cc(OC(C)(C)C#N)cnc1-c1nc2cc(C(F)(F)F)n(C3CC3)c(=O)c2n1C]

In an embodiment of each aspect, VAChT COMPOUND is selected from VAChT-1 to VAChT-64.

In an embodiment of each aspect, VAChT COMPOUND is selected from VAChT-1, VAChT-7, VAChT-10, VAChT-13, VAChT-16, VAChT-19, VAChT-20, VAChT-24, VAChT-27, VAChT-28, VAChT-29, VAChT-30, VAChT-31, VAChT-32, VAChT-34, VAChT-35, VAChT-36, VAChT-37, VAChT-38, VAChT-39, VAChT-40, and VAChT-56.

In an embodiment, VAChT-13, VAChT-19, VAChT-20, or VAChT-29 controls one or more resistant insects selected from Nilaparvata lugens, Sogatella furcifera, Chilo suppressalis, Scirpophaga incertulas, Cnaphalocrosis medinalis and Lissorhoptrus oryzophilus, particularly in rice crops.

In an embodiment, compound of formula I composed of radicals A37 and B7, wherein R² is R2-1 or R2-2; R⁴ is hydrogen; and X is oxo, preferably VAChT-20, controls one or more resistant insects selected from Adoxyphyes orana, Choristoneura rosaceana, Cydia pomonella, Frankliniella occidentalis, Frankliniella schutzei, Grapholita molesta, Liriomyza trifolii/hudibriensis, Phyllocnistis citrella, Phyllotreata spp., Plutella xylostella, Scirtothrips aurantii, Scirtothrips citri, Spodoptera exigua, Spodoptera litura, Thrips palmi; particularly for crop(s)/use(s) indicated in the table above corresponding to the designated insect pest.

In an embodiment, VAChT-1, VAChT-7, VAChT-10, VAChT-13, VAChT-16, VAChT-19, VAChT-20, VAChT-24, VAChT-27, VAChT-29, VAChT-30, VAChT-31, VAChT-32, VAChT-34, VAChT-35, VAChT-38, or VAChT-56 controls one or more resistant insects selected from Acrosternum hilare, Adoxyphyes orana, Amrasca biguttula, Anthonomus grandis, Aphis glycines, Aphis gossypii, Bemisia tabaci, Chilo infuscatellus, Chilo suppressalis, Choristoneura rosaceana, Chrysodeixis includens, Cnaphalocrosis medinalis, Cydia pomonella, Dalbulus maidis, Diabrotica virgifera, Diatraea saccharalis, Dichelops meloncanta/furcatus, Elasmopalpus lignoselus, Euschistus heros, Euschistus servus, Frankliniella fusca, Frankliniella occidentalis, Frankliniella schutzei, Frankliniella schutzei, Grapholita molesta, Helicoverpa armigera, Helicoverpa zea, Heliothis virescens, Hypothenemus hampei, Leptinotarsa decemlineata, Leucinodes orbonalis, Leucoptera coffeella, Liriomyza trifolii/hudibriensis, Lissorhoptrus oryzophilus, Lygus lineolaris, Mahanarva fimbriolata, Maruca testulalis, Myzus persicae, neoleucinoides, Nezara viridula, Nilaparvata lugens, Ostrinia spp., Pectinophora gossypiella, Phyllocnistis citrella, Phyllotreata spp., Piezodorus guildini, Plutella xylostella, Scirpophaga incertulas, Scirtothrips dorsalis, Sesamia inferens, Sogatella furcifera, Spodoptera cosmiodies, Spodoptera eridania, Spodoptera exigua, Spodoptera frugiperda, Spodoptera litura, Striacosta albicosta, Thrips palmi, Thrips tabaci, Trialeurodes vaporariorum, and Tuta absoluta.

In an embodiment, VAChT-1, VAChT-7, VAChT-10, VAChT-13, VAChT-16, VAChT-19, VAChT-20, VAChT-24, VAChT-27, VAChT-29, VAChT-30, VAChT-31, VAChT-32, VAChT-34, VAChT-35, VAChT-38, or VAChT-56 controls one or more resistant insects selected from Adoxyphyes orana, Amrasca biguttula, Anthonomus grandis, Aphis glycines, Aphis gossypii, Bemisia tabaci, Chilo suppressalis, Chrysodeixis includens, Cnaphalocrosis medinalis, Cydia pomonella, Dalbulus maidis, Diabrotica virgifera, Dichelops meloncanta/furcatus, Euschistus heros, Euschistus servus, Grapholita molesta, Helicoverpa armigera, Helicoverpa zea, Heliothis virescens, Leptinotarsa decemlineata, Leucinodes orbonalis, Liriomyza trifolii/hudibriensis, Mahanarva fimbriolata, Maruca testulalis, Myzus persicae, Nezara viridula, Nilaparvata lugens, Pectinophora gossypiella, Phyllotreata spp., Piezodorus guildini, Plutella xylostella, Scirpophaga incertulas, Sesamia inferens, Sogatella furcifera, Spodoptera cosmiodies, Spodoptera eridania, Spodoptera exigua, Spodoptera frugiperda, Spodoptera litura, Trialeurodes vaporariorum, and Tuta absoluta; particularly for the crop(s)/use(s) indicated in the table above corresponding to the designated insect pest.

In an embodiment of each aspect, a VAChT compound (preferably VAChT-1, VAChT-7, VAChT-10, VAChT-13, VAChT-16, VAChT-19, VAChT-20, VAChT-24, VAChT-27, VAChT-28, VAChT-29, VAChT-30, VAChT-31, VAChT-32, VAChT-34, VAChT-35, VAChT-36, VAChT-37, VAChT-38, VAChT-39, VAChT-40, and VAChT-56) controls a Myzus persicae species having enhanced P450 metabolism (CYP6CY3); having target site mutations, which confer resistance to neonicotinoids (nAChR: R81T); and to pyrethroids (VGSC: L1014F and M918T); and carrying the FE4 R3 carboxylesterase overexpression which confers resistance to organophosphates, carbamates and pyrethroids.

In an embodiment of each aspect, a VAChT compound (preferably VAChT-1, VAChT-7, VAChT-10, VAChT-13, VAChT-16, VAChT-19, VAChT-20, VAChT-24, VAChT-27, VAChT-28, VAChT-29, VAChT-30, VAChT-31, VAChT-32, VAChT-34, VAChT-35, VAChT-36, VAChT-37, VAChT-38, VAChT-39, VAChT-40, and VAChT-56) controls a Nilaparvata lugen species having an enhanced P450-mediated metabolism conferring resistance to neonicotinoids IRAC 4A.

In an embodiment of each aspect, a VAChT compound (preferably VAChT-1, VAChT-7, VAChT-10, VAChT-13, VAChT-16, VAChT-19, VAChT-20, VAChT-24, VAChT-27, VAChT-28, VAChT-29, VAChT-30, VAChT-31, VAChT-32, VAChT-34, VAChT-35, VAChT-36, VAChT-37, VAChT-38, VAChT-39, VAChT-40, and VAChT-56) controls a Bemisia tabaci species having mutations, which confer resistance to pyrethroids (IRAC 3A) (VGSC: L925I); and to tetronic and tetramic acid derivatives (IRAC Group 23) (ACCase_A2083V); and having a higher expression of the P450 (CYP6CM1) conferring metabolic resistance to neonicotinoids.

In an embodiment of each aspect, a VAChT compound (preferably VAChT-1, VAChT-7, VAChT-10, VAChT-13, VAChT-16, VAChT-19, VAChT-20, VAChT-24, VAChT-27, VAChT-28, VAChT-29, VAChT-30, VAChT-31, VAChT-32, VAChT-34, VAChT-35, VAChT-36, VAChT-37, VAChT-38, VAChT-39, VAChT-40, and VAChT-56) controls Plutella xylostella species having a number of target-sites mutations, which confer resistance to pyrethroids (VGSC: L1014F, T929I); organophosphates and carbamates (IRAC group 1) (AChE: A298S, F386F/V, G324A); organochlorines (rdl: A298S); diamides (ryr: G4546E); oxadiazines (IRAC Group 22A) (VGSC: V1848I); and benzoylureas (IRAC Group 15) (CHS1: I1042M).

In an embodiment of each aspect, a VAChT compound (preferably VAChT-1, VAChT-7, VAChT-10, VAChT-13, VAChT-16, VAChT-19, VAChT-20, VAChT-24, VAChT-27, VAChT-28, VAChT-29, VAChT-30, VAChT-31, VAChT-32, VAChT-34, VAChT-35, VAChT-36, VAChT-37, VAChT-38, VAChT-39, VAChT-40, and VAChT-56) controls Diabrotica balteata species having target site mutations, which confers resistance to organochlorines (rdl: A280S, V311I, and Q340R).

In an embodiment of each aspect, a VAChT compound (preferably VAChT-1, VAChT-7, VAChT-10, VAChT-13, VAChT-16, VAChT-19, VAChT-20, VAChT-24, VAChT-27, VAChT-28, VAChT-29, VAChT-30, VAChT-31, VAChT-32, VAChT-34, VAChT-35, VAChT-36, VAChT-37, VAChT-38, VAChT-39, VAChT-40, and VAChT-56) controls houseflies having kdr mutation (L1014F), or super-kdr mutation (M918T), conferring resistance to pyrethroids.

The compounds of formula I are known, and particular examples are those disclosed in WO 2009/131237, WO 2010/125985, WO 2011/043404, WO 2011/162364, WO 2012/074135, WO 2012/086848, WO 2013/018928, WO 2013/180193, WO 2013/180194, WO 2013/191041, WO 2013/191112, WO 2013/191113, WO 2013/191188, WO 2013/191189, WO 2014/002754, WO 2014/021468, WO 2014/104407, WO 2014/123205, WO 2014/123206, WO 2014/132971, WO 2014/132972, WO 2014/142292, WO 2014/148451, WO 2014/157600, WO 2015/000715, WO 2015/002211, WO 2015/059088, WO 2015/067647, WO 2015/071180, WO 2015/072463, WO 2015/087458, WO 2015/091945, WO 2015/117912, WO 2015/121136, WO 2015/133603, WO 2015/144826, WO 2015/144895, WO 2015/163478, WO 2015/177063, WO 2015/198859, WO 2016/005263, WO 2016/012395, WO 2016/020286, WO 2016/023954, WO 2016/026848, WO 2016/030229, WO 2016/039441, WO 2016/039444, WO 2016/041819, WO 2016/046071, WO 2016/052247, WO 2016/052455, WO 2016/058928, WO 2016/059145, WO 2016/071214, WO 2016/087257, WO 2016/087265, WO 2016/091731, WO 2016/096584, WO 2016/104746, WO 2016/107742, WO 2016/107831, WO 2016/113155, WO 2016/116338, WO 2016/120182, WO 2016/121969, WO 2016/121970, WO 2016/121997, WO 2016/124557, WO 2016/124563, WO 2016/125621, WO 2016/125622, WO 2016/129684, WO 2016/142326, WO 2016/142327, WO 2016/162318, WO 2016/169882, WO 2016/169886, WO 2016/182021, WO 2017/001311, WO 2017/001314, WO 2017/016910, WO 2017/016922, WO 2017/025419, WO 2017/026384, WO 2017/050685, WO 2017/050751, WO 2017/055147, WO 2017/055185, WO 2017/061497, WO 2017/065183, WO 2017/065228, WO 2017/069105, WO 2017/072039, WO 2017/077911, WO 2017/077968, WO 2017/082132, WO 2017/084879, WO 2017/089190, WO 2017/093180, WO 2017/094750, WO 2017/121674, WO 2017/125340, WO 2017/133994, WO 2017/134066, WO 2017/144341, WO 2017/146220, WO 2017/146221, WO 2017/146226, WO 2017/150209, WO 2017/155103, WO 2017/164108, WO 2017/169894, WO 2017/174414, WO 2017/174449, WO 2017/175613, WO 2017/188078, WO 2018/003976, WO 2018/008727, WO 2018/015289, WO 2018/033455, WO 2018/041729, WO 2018/043597, WO 2018/043675, WO 2018/050825, WO 2018/052119, WO 2018/065288, WO 2018/065292, WO 2018/070502, WO 2018/070503, WO 2018/077565, WO 2018/084141, WO 2018/084142, WO 2018/091389, WO 2018/095795, WO 2018/095953, WO 2018/099812, WO 2018/101424, WO 2018/105632, WO 2018/108726, WO 2018/113900, WO 2018/124128, WO 2018/124129, WO 2018/130437, WO 2018/130443, WO 2018/138050, WO 2018/139436, WO 2018/141954, WO 2018/153778, WO 2018/174170, WO 2018/197257, WO 2018/197315, WO 2018/199208, WO 2018/199209, WO 2018/199210, WO 2018/202494, WO 2018/202501, WO 2018/202540, WO 2018/206348, WO 2018/215304, WO 2018/221720, WO 2019/008072, WO 2019/008115, WO 2019/013273, WO 2019/038195, WO 2019/053182, WO 2019/059244, WO 2019/065568, WO 2019/065570, WO 2019/068572, WO 2019/076778, WO 2019/124529, WO 2019/124548, WO 2019/124568, WO 2019/131575, WO 2019/131587, WO 2019/138018, WO 2019/162174, WO 2019/168140, WO 2019/175045, WO 2019/175046, WO 2019/189731, WO 2019/201921, WO 2019/219689, WO 2019/225663, WO 2019/229088, WO 2019/229089, WO 2019/234158, WO 2019/234160, WO 2020/002082, WO 2020/013147, WO 2020/040075, WO 2020/040077, WO 2020/053282, WO 2020/054790, WO 2020/084075, WO 2020/141135, WO 2020/141136, WO 2020/158889, WO 2020/171077, WO 2020/171129, WO 2020/173860, WO 2020/173861, WO 2020/174094, WO 2020/174096, WO 2020/182577, WO 2020/203763, WO 2020/241606, WO 2020/254530, WO 2021/009311, WO 2021/049595, WO 2021/049596, WO 2021/049597, WO 2021/053110, WO 2021/107110, WO 2021/107113, WO 2021/136722, WO 2021/140122, WO 2021/141106, WO 2021/213929, WO 2021/213978, WO 2021/219810, WO 2021/224409, WO 2022/002818, WO 2022/013417, WO 2022/017975, WO 2022/043576, WO 2022/049141, WO 2022/049144, WO 2022/049146, WO 2022/053567, WO 2022/071428, WO 2022/071434, WO2023/072945, WO 2022/092180, WO2023/148368, WO2023/148369, WO 2022/157334, WO 2022/186133, WO2023/187191, WO 2022/238391, WO 2022/253841, WO 2022/255465, WO 2023/017094, WO2023/036934, WO2023/088718, WO 2023/090336, WO 2023/090337, WO 2023/090344, WO 2023/090345, WO 2023/136142, WO2023/17183, WO2023/194496, WO2023/210792, and WO2024/022362.

As used herein, the term “controlling” refers to reducing the number of pests (or insects), eliminating pests and/or preventing further pest damage such that damage to a plant or to a plant derived product is reduced. The pest encompasses all stages in the life cycle of the pest.

As used herein, the term “effective amount” refers to the amount of the compound, or a salt thereof, which, upon single or multiple applications provides the desired effect.

As used herein, the term “inhibition” can also be interpreted as to block, antagonise, restrict, limit, act on, affect the function, or similar mechanistic actions.

The staggered line as used herein, for example, in A1 to A54 or B1 to B27 or R2-1 to R2-25, represent the point of connection/attachment to the rest of the compound.

An effective amount is readily determined by the skilled person in the art, by the use of known techniques and by observing results obtained under analogous circumstances. In determining the effective amount a number of factors are considered including, but not limited to: the type of plant or derived product to be applied; the pest to be controlled & its lifecycle; the particular compound applied; the type of application; and other relevant circumstances.

Pesticide or insecticide resistance refers to the insecticide-selected inheritable ability of a pest or other arthropod (such as an insect) population to withstand the exposure to a dose of an insecticide that would kill the majority of a normal (susceptible or sensitive) population of the same species. Pests and other arthropods acquire resistance to natural, synthetic or bioengineered insecticides through various genetic alterations. Pesticide resistance is known to occur in target species for virtually all insecticide classes.

In contrast to resistance, pesticide tolerance is a natural tendency and is not a result of forced change in the genetic makeup of a population. Therefore, tolerance is often known as natural resistance. Many factors can lead to tolerance to insecticides in a pest. For example, old larvae of many lepidopteran insects are more tolerant to many insecticides than young larvae of the same species due to substantial differences in body size, cuticle thickness, and detoxification ability. Such differences should be identified as tolerance or natural resistance rather than true insecticide resistance. The term “resistant” or “resistance” as used herein can therefore be equally considered as “tolerant” or “tolerance” respectively.

The resistance factor or ratio of an insecticide is a characteristic afforded to the insecticide to represent the level of resistance developed by the pest against the insecticide, and this is determined by dividing the LC50 of a field population (or resistant strain) by the LC50 of a susceptible strain.

When a pest is said to have developed resistance, or a pest is resistant against an insecticide, the resistance factor of the insecticide can be multiple fold, such as 10 or greater, or 20 or greater, or 30 or greater, 40 or greater, 50 or greater, 100 or greater, 200 or greater, or multiple of hundreds or greater.

In an embodiment of each aspect, the pest is resistant to insecticides having a resistance factor of 10 of greater, or 20 or greater, or 30 or greater, 40 or greater, 50 or greater, 100 or greater, 200 or greater, or multiple of hundreds or greater.

In an embodiment of each aspect, VAChT-1, VAChT-7, VAChT-10, AChT-13, VAChT-16, VAChT-19, VAChT-20, VAChT-24, VAChT-29, VAChT-30, VAChT-31, VAChT-32, VAChT-34, VAChT-35, or VAChT-38 is not cross resistant.

In an embodiment of each aspect, VAChT-1, VAChT-7, VAChT-10, AChT-13, VAChT-16, VAChT-19, VAChT-20, VAChT-24, VAChT-29, VAChT-30, VAChT-31, VAChT-32, VAChT-34, VAChT-35, or VAChT-38 can be applied in rotation with another active ingredient belonging to a different IRAC mode of action group.

In an embodiment of each aspect, VAChT-1, VAChT-7, VAChT-10, AChT-13, VAChT-16, VAChT-19, VAChT-20, VAChT-24, VAChT-29, VAChT-30, VAChT-31, VAChT-32, VAChT-34, VAChT-35, or VAChT-38 can be applied to crops more than two times, up to four times, in a season.

In an embodiment of each aspect, VAChT-1, VAChT-7, VAChT-10, AChT-13, VAChT-16, VAChT-19, VAChT-20, VAChT-24, VAChT-29, VAChT-30, VAChT-31, VAChT-32, VAChT-34, VAChT-35, or VAChT-38 provides improved control over resistant pests compared to another compound belonging to a different IRAC mode of action group.

In an embodiment of the first aspect, the use comprises applying an effective amount of the compound to the pest, to a locus of the pest, to a plant susceptible to attack by the pest, or to a plant propagation material, which comprises treating the propagation material or the site,

In a further aspect, the present invention provides the use of a compound of formula I as defined in the first aspect for combatting or controlling a pest, comprising applying an effective amount of the compound to the pest, to a locus of the pest, to a plant susceptible to attack by the pest, or to a plant propagation material, which comprises treating the propagation material or the site, wherein the compound is insecticidally active by inhibition of, affect the function of, the vesicular acetylcholine transporter (VAChT) of the pest.

In a further aspect, the present invention provides the use of a compound of formula I as defined in the first aspect for combatting or controlling the pest, comprising applying an effective amount of the compound to the pest, to a locus of the pest, to a plant susceptible to attack by the pest, or to a plant propagation material, which comprises treating the propagation material or the site, wherein the compound has not developed resistance against one or more pests.

In a further aspect, the present invention provides a method of obtaining a regulatory approval as a pesticide in a country comprising the action of representing a compound of formula I as defined in the first aspect as a compound that is insecticidally active by inhibition of, or affect the function of, the vesicular acetylcholine transporter (VAChT) of the pest.

In a further aspect, the present invention provides a method/process comprising submitting data relating to a VAChT mode of action of a VAChT COMPOUND to a governmental authority in order to obtain product registration approval for a product comprising a VAChT COMPOUND.

Suitable target crops are, in particular, cereals, such as wheat, barley, rye, oats, rice, maize or sorghum; beet, such as sugar or fodder beet; fruit, for example pomaceous fruit, stone fruit or soft fruit, such as apples, pears, plums, peaches, almonds, cherries or berries, for example strawberries, raspberries or blackberries; leguminous crops, such as beans, lentils, peas or soya; oil crops, such as oilseed rape, mustard, poppies, olives, sunflowers, coconut, castor, cocoa or ground nuts; cucurbits, such as pumpkins, cucumbers or melons; fibre plants, such as cotton, flax, hemp or jute; citrus fruit, such as oranges, lemons, grapefruit or tangerines; vegetables, such as spinach, lettuce, asparagus, cabbages, carrots, onions, tomatoes, potatoes or bell peppers; Lauraceae, such as avocado, Cinnamonium or camphor; and also tobacco, nuts, coffee, eggplants, sugarcane, tea, pepper, grapevines, hops, the plantain family, latex plants and ornamentals.

The term “crops” is to be understood as including also crop plants which have been so transformed by the use of recombinant DNA techniques that they are capable of synthesising one or more selectively acting toxins, such as are known, for example, from toxin-producing bacteria, especially those of the genus Bacillus.

Toxins that can be expressed by such transgenic plants include, for example, insecticidal proteins, for example insecticidal proteins from Bacillus cereus or Bacillus popilliae; or insecticidal proteins from Bacillus thuringiensis, such as δ-endotoxins, e.g. Cry1Ab, Cry1Ac, Cry1F, Cry1Fa2, Cry2Ab, Cry3A, Cry3Bb1 or Cry9C, or vegetative insecticidal proteins (Vip), e.g. Vip1, Vip2, Vip3 or Vip3A; or insecticidal proteins of bacteria colonising nematodes, for example Photorhabdus spp. or Xenorhabdus spp., such as Photorhabdus luminescens, Xenorhabdus nematophilus; toxins produced by animals, such as scorpion toxins, arachnid toxins, wasp toxins and other insect-specific neurotoxins; toxins produced by fungi, such as Streptomycetes toxins, plant lectins, such as pea lectins, barley lectins or snowdrop lectins; agglutinins; proteinase inhibitors, such as trypsin inhibitors, serine protease inhibitors, patatin, cystatin, papain inhibitors; ribosome-inactivating proteins (RIP), such as ricin, maize-RIP, abrin, luffin, saporin or bryodin; steroid metabolism enzymes, such as 3-hydroxysteroidoxidase, ecdysteroid-UDP-glycosyl-transferase, cholesterol oxidases, ecdysone inhibitors, HMG-COA-reductase, ion channel blockers, such as blockers of sodium or calcium channels, juvenile hormone esterase, diuretic hormone receptors, stilbene synthase, bibenzyl synthase, chitinases and glucanases.

In the context of the present invention there are to be understood by δ-endotoxins, for example Cry1Ab, Cry1Ac, Cry1F, Cry1Fa2, Cry2Ab, Cry3A, Cry3Bb1 or Cry9C, or vegetative insecticidal proteins (Vip), for example Vip1, Vip2, Vip3 or Vip3A, expressly also hybrid toxins, truncated toxins and modified toxins. Hybrid toxins are produced recombinantly by a new combination of different domains of those proteins (see, for example, WO 02/15701). Truncated toxins, for example a truncated Cry1Ab, are known. In the case of modified toxins, one or more amino acids of the naturally occurring toxin are replaced. In such amino acid replacements, preferably non-naturally present protease recognition sequences are inserted into the toxin, such as, for example, in the case of Cry3A055, a cathepsin-G-recognition sequence is inserted into a Cry3A toxin (see WO 03/018810).

Examples of such toxins or transgenic plants capable of synthesising such toxins are disclosed, for example, in EP-A-0 374 753, WO 93/07278, WO 95/34656, EP-A-0 427 529, EP-A-451 878 and WO 03/052073.

The processes for the preparation of such transgenic plants are generally known to the person skilled in the art and are described, for example, in the publications mentioned above. Cryl-type deoxyribonucleic acids and their preparation are known, for example, from WO 95/34656, EP-A-0 367 474, EP-A-0 401 979 and WO 90/13651.

The toxin contained in the transgenic plants imparts to the plants tolerance to harmful insects. Such insects can occur in any taxonomic group of insects, but are especially commonly found in the beetles (Coleoptera), two-winged insects (Diptera) and moths (Lepidoptera).

Transgenic plants containing one or more genes that code for an insecticidal resistance and express one or more toxins are known and some of them are commercially available. Examples of such plants are: YieldGard® (maize variety that expresses a Cry1Ab toxin); YieldGard Rootworm® (maize variety that expresses a Cry3Bb1 toxin); YieldGard Plus® (maize variety that expresses a Cry1Ab and a Cry3Bb1 toxin); Starlink® (maize variety that expresses a Cry9C toxin); Herculex I® (maize variety that expresses a Cry1 Fa2 toxin and the enzyme phosphinothricin N-acetyltransferase (PAT) to achieve tolerance to the herbicide glufosinate ammonium); NuCOTN 33B® (cotton variety that expresses a Cry1Ac toxin); Bollgard I® (cotton variety that expresses a Cry1Ac toxin); Bollgard II® (cotton variety that expresses a Cry1Ac and a Cry2Ab toxin); VipCot® (cotton variety that expresses a Vip3A and a Cry1Ab toxin); NewLeaf® (potato variety that expresses a Cry3A toxin); NatureGard®, Agrisure® GT Advantage (GA21 glyphosate-tolerant trait), Agrisure® CB Advantage (Bt11 corn borer (CB) trait) and Protecta®.

Further examples of such transgenic crops are:
1. Bt11 Maize from Syngenta Seeds SAS, Chemin de l'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a truncated Cry1Ab toxin. Bt11 maize also transgenically expresses the enzyme PAT to achieve tolerance to the herbicide glufosinate ammonium.
2. Bt176 Maize from Syngenta Seeds SAS, Chemin de l'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a Cry1Ab toxin. Bt176 maize also transgenically expresses the enzyme PAT to achieve tolerance to the herbicide glufosinate ammonium.
3. MIR604 Maize from Syngenta Seeds SAS, Chemin de l'Hobit 27, F-31 790 St. Sauveur, France, registration number C/FR/96/05/10. Maize which has been rendered insect-resistant by transgenic expression of a modified Cry3A toxin. This toxin is Cry3A055 modified by insertion of a cathepsin-G-protease recognition sequence. The preparation of such transgenic maize plants is described in WO 03/018810.
4. MON 863 Maize from Monsanto Europe S.A. 270-272 Avenue de Tervuren, B-1150 Brussels, Belgium, registration number C/DE/02/9. MON 863 expresses a Cry3Bb1 toxin and has resistance to certain Coleoptera insects.
5. IPC 531 Cotton from Monsanto Europe S.A. 270-272 Avenue de Tervuren, B-1150 Brussels, Belgium, registration number C/ES/96/02.
6. 1507 Maize from Pioneer Overseas Corporation, Avenue Tedesco, 7 B-1160 Brussels, Belgium, registration number C/NL/00/10. Genetically modified maize for the expression of the protein Cry1F for achieving resistance to certain Lepidoptera insects and of the PAT protein for achieving tolerance to the herbicide glufosinate ammonium.
7. NK603 x MON 810 Maize from Monsanto Europe S.A. 270-272 Avenue de Tervuren, B-1150 Brussels, Belgium, registration number C/GB/02/M3/03. Consists of conventionally bred hybrid maize varieties by crossing the genetically modified varieties NK603 and MON 810. NK603 x MON 810 Maize transgenically expresses the protein CP4 EPSPS, obtained from Agrobacterium sp. strain CP4, which imparts tolerance to the herbicide Roundup® (contains glyphosate), and also a Cry1Ab toxin obtained from Bacillus thuringiensis subsp. kurstaki which brings about tolerance to certain Lepidoptera, include the European corn borer.

Transgenic crops of insect-resistant plants are also described in BATS (Zentrum für Biosicherheit und Nachhaltigkeit, Zentrum BATS, Clarastrasse 13, 4058 Basel, Switzerland) Report 2003, (http://bats.ch).

The term “crops” is to be understood as including also crop plants which have been so transformed by the use of recombinant DNA techniques that they are capable of synthesising antipathogenic substances having a selective action, such as, for example, the so-called “pathogenesis-related proteins” (PRPs, see e.g. EP-A-0 392 225). Examples of such antipathogenic substances and transgenic plants capable of synthesising such antipathogenic substances are known, for example, from EP-A-0 392 225, WO 95/33818 and EP-A-0 353 191. The methods of producing such transgenic plants are generally known to the person skilled in the art and are described, for example, in the publications mentioned above.

Crops may also be modified for enhanced resistance to fungal (for example Fusarium, Anthracnose, or Phytophthora), bacterial (for example Pseudomonas) or viral (for example potato leafroll virus, tomato spotted wilt virus, cucumber mosaic virus) pathogens.

Crops also include those that have enhanced resistance to nematodes, such as the soybean cyst nematode.

Crops that are tolerance to abiotic stress include those that have enhanced tolerance to drought, high salt, high temperature, chill, frost, or light radiation, for example through expression of NF-YB or other proteins known in the art.

Antipathogenic substances which can be expressed by such transgenic plants include, for example, ion channel blockers, such as blockers for sodium and calcium channels, for example the viral KP1, KP4 or KP6 toxins; stilbene synthases; bibenzyl synthases; chitinases; glucanases; the so-called “pathogenesis-related proteins” (PRPs; see e.g. EP-A-0 392 225); antipathogenic substances produced by microorganisms, for example peptide antibiotics or heterocyclic antibiotics (see e.g. WO 95/33818) or protein or polypeptide factors involved in plant pathogen defence (so-called “plant disease resistance genes”, as described in WO 03/000906).

In an embodiment, the VAChT COMPOUNDS are especially suitable for controlling resistant insect pests in soybean, cotton, vegetables, potato, corn, rice, brassica, canola, pome fruit, citrus, sugarcane and coffee.

The VAChT COMPOUNDS can be used as pesticidal agents in unmodified form, but they are generally formulated into compositions in various ways using formulation adjuvants, such as carriers, solvents and surface-active substances. The formulations can be in various physical forms, e.g. in the form of dusting powders, gels, wettable powders, water-dispersible granules, water-dispersible tablets, effervescent pellets, emulsifiable concentrates, microemulsifiable concentrates, oil-in-water emulsions, oil-flowables, aqueous dispersions, oily dispersions, suspo-emulsions, capsule suspensions, emulsifiable granules, soluble liquids, water-soluble concentrates (with water or a water-miscible organic solvent as carrier), impregnated polymer films or in other forms known e.g. from the Manual on Development and Use of FAO and WHO Specifications for Pesticides, United Nations, First Edition, Second Revision (2010). Such formulations can either be used directly or diluted prior to use. The dilutions can be made, for example, with water, liquid fertilisers, micronutrients, biological organisms, oil or solvents.

The formulations can be prepared e.g. by mixing the active ingredient with the formulation adjuvants in order to obtain compositions in the form of finely divided solids, granules, solutions, dispersions or emulsions. The active ingredients can also be formulated with other adjuvants, such as finely divided solids, mineral oils, oils of vegetable or animal origin, modified oils of vegetable or animal origin, organic solvents, water, surface-active substances or combinations thereof.

The active ingredients can also be contained in very fine microcapsules. Microcapsules contain the active ingredients in a porous carrier. This enables the active ingredients to be released into the environment in controlled amounts (e.g. slow-release). Microcapsules usually have a diameter of from 0.1 to 500 microns. They contain active ingredients in an amount of about from 25 to 95% by weight of the capsule weight. The active ingredients can be in the form of a monolithic solid, in the form of fine particles in solid or liquid dispersion or in the form of a suitable solution. The encapsulating membranes can comprise, for example, natural or synthetic rubbers, cellulose, styrene/butadiene copolymers, polyacrylonitrile, polyacrylate, polyesters, polyamides, polyureas, polyurethane or chemically modified polymers and starch xanthates or other polymers that are known to the person skilled in the art. Alternatively, very fine microcapsules can be formed in which the active ingredient is contained in the form of finely divided particles in a solid matrix of base substance, but the microcapsules are not themselves encapsulated.

The formulation adjuvants that are suitable for the preparation of the compositions according to the invention are known per se. As liquid carriers there may be used: water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, N,N-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropylbenzene, isopropyl myristate, lactic acid, laurylamine, mesityl oxide, methoxy-propanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol, propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weight, such as amyl alcohol, tetrahydrofurfuryl alcohol, hexanol, octanol, ethylene glycol, propylene glycol, glycerol, N-methyl-2-pyrrolidone and the like.

Suitable solid carriers are, for example, talc, titanium dioxide, pyrophyllite clay, silica, attapulgite clay, kieselguhr, limestone, calcium carbonate, bentonite, calcium montmorillonite, cottonseed husks, wheat flour, soybean flour, pumice, wood flour, ground walnut shells, lignin and similar substances.

A large number of surface-active substances can advantageously be used in both solid and liquid formulations, especially in those formulations which can be diluted with a carrier prior to use. Surface-active substances may be anionic, cationic, non-ionic or polymeric and they can be used as emulsifiers, wetting agents or suspending agents or for other purposes. Typical surface-active substances include, for example, salts of alkyl sulfates, such as diethanolammonium lauryl sulfate; salts of alkylarylsulfonates, such as calcium dodecylbenzenesulfonate; alkylphenol/alkylene oxide addition products, such as nonylphenol ethoxylate; alcohol/alkylene oxide addition products, such as tridecylalcohol ethoxylate; soaps, such as sodium stearate; salts of alkylnaphthalenesulfonates, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryltrimethylammonium chloride, polyethylene glycol esters of fatty acids, such as polyethylene glycol stearate; block copolymers of ethylene oxide and propylene oxide; and salts of mono- and di-alkylphosphate esters; and also further substances described e.g. in McCutcheon's Detergents and Emulsifiers Annual, MC Publishing Corp., Ridgewood New Jersey (1981).

Further adjuvants that can be used in pesticidal formulations include crystallisation inhibitors, viscosity modifiers, suspending agents, dyes, anti-oxidants, foaming agents, light absorbers, mixing auxiliaries, antifoams, complexing agents, neutralising or pH-modifying substances and buffers, corrosion inhibitors, fragrances, wetting agents, take-up enhancers, micronutrients, plasticisers, glidants, lubricants, dispersants, thickeners, antifreezes, microbicides, and liquid and solid fertilisers.

The compositions of the VAChT COMPOUNDS can include an additive comprising an oil of vegetable or animal origin, a mineral oil, alkyl esters of such oils or mixtures of such oils and oil derivatives. The amount of oil additive in the composition is generally from 0.01 to 10%, based on the mixture to be applied. For example, the oil additive can be added to a spray tank in the desired concentration after a spray mixture has been prepared. Preferred oil additives comprise mineral oils or an oil of vegetable origin, for example rapeseed oil, olive oil or sunflower oil, emulsified vegetable oil, alkyl esters of oils of vegetable origin, for example the methyl derivatives, or an oil of animal origin, such as fish oil or beef tallow. Preferred oil additives comprise alkyl esters of C₈-C₂₂ fatty acids, especially the methyl derivatives of C₁₂-C₁₈ fatty acids, for example the methyl esters of lauric acid, palmitic acid and oleic acid (methyl laurate, methyl palmitate and methyl oleate, respectively). Many oil derivatives are known from the Compendium of Herbicide Adjuvants, 10^{th} Edition, Southern Illinois University, 2010.

The compositions generally comprise from 0.1 to 99% by weight, especially from 0.1 to 95% by weight, of the VAChT COMPOUNDS and from 1 to 99.9% by weight of a formulation adjuvant which preferably includes from 0 to 25% by weight of a surface-active substance. Whereas commercial products may preferably be formulated as concentrates, the end user will normally employ dilute formulations.

Formulation types include an emulsion concentrate (EC), a suspension concentrate (SC), a suspo-emulsion (SE), a capsule suspension (CS), a water dispersible granule (WG), an emulsifiable granule (EG), an emulsion, water in oil (EO), an emulsion, oil in water (EW), a micro-emulsion (ME), an oil dispersion (OD), an oil miscible flowable (OF), an oil miscible liquid (OL), a soluble concentrate (SL), an ultra-low volume suspension (SU), an ultra-low volume liquid (UL), a technical concentrate (TK), a dispersible concentrate (DC), a wettable powder (WP), a soluble granule (SG) or any technically feasible formulation in combination with agriculturally acceptable adjuvants.

The rates of application vary within wide limits and depend on the nature of the soil, the method of application, the crop plant, the pest to be controlled, the prevailing climatic conditions, and other factors governed by the method of application, the time of application and the target crop. As a general guideline, the VAChT COMPOUND may be applied at a rate of from 1 to 2000 g of active ingredient per hectare, in particular 10 to 1000 g/ha, preferably 10 to 600 g/ha, especially 10 to 200 g/ha, which rate is not significantly different for the control of resistant insect pests and sensitive insect pests.

Preferred formulations can have the following compositions (weight %):

Emulsifiable concentrates:

| | |
|---|---|
| active ingredient: | 1 to 95%, preferably 60 to 90% |
| surface-active agent: | 1 to 30%, preferably 5 to 20% |
| liquid carrier: | 1 to 80%, preferably 1 to 35% |

Dusts:

| | |
|---|---|
| active ingredient: | 0.1 to 10%, preferably 0.1 to 5% |
| solid carrier: | 99.9 to 90%, preferably 99.9 to 99% |

Suspension concentrates:

| | |
|---|---|
| active ingredient: | 5 to 75%, preferably 10 to 50% |
| water: | 94 to 24%, preferably 88 to 30% |
| surface-active agent: | 1 to 40%, preferably 2 to 30% |

Wettable powders:

| | |
|---|---|
| active ingredient: | 0.5 to 90%, preferably 1 to 80% |
| surface-active agent: | 0.5 to 20%, preferably 1 to 15% |
| solid carrier: | 5 to 95%, preferably 15 to 90% |

Granules:

| | |
|---|---|
| active ingredient: | 0.1 to 30%, preferably 0.1 to 15% |
| solid carrier: | 99.5 to 70%, preferably 97 to 85% |

The following Examples further illustrate, but do not limit, the invention.

| Wettable powders | a) | b) | c) |
|---|---|---|---|
| active ingredients | 25% | 50% | 75% |
| sodium lignosulfonate | 5% | 5% | — |
| sodium lauryl sulfate | 3% | — | 5% |
| sodium diisobutylnaphthalenesulfonate | — | 6% | 10% |
| phenol polyethylene glycol ether (7-8 mol of | — | 2% | — |
| ethylene oxide) | | | |
| highly dispersed silicic acid | 5% | 10% | 10% |
| Kaolin | 62% | 27% | — |

The combination is thoroughly mixed with the adjuvants and the mixture is thoroughly ground in a suitable mill, affording wettable powders that can be diluted with water to give suspensions of the desired concentration.

| Powders for dry seed treatment | a) | b) | c) |
|---|---|---|---|
| active ingredients | 25% | 50% | 75% |
| light mineral oil | 5% | 5% | 5% |
| highly dispersed silicic acid | 5% | 5% | — |
| Kaolin | 65% | 40% | — |
| Talcum | — | | 20% |

The combination is thoroughly mixed with the adjuvants and the mixture is thoroughly ground in a suitable mill, affording powders that can be used directly for seed treatment.

Emulsifiable concentrate

| | |
|---|---|
| active ingredients | 10% |
| octylphenol polyethylene glycol ether (4-5 mol of ethylene | 3% |
| oxide) | |
| calcium dodecylbenzenesulfonate | 3% |
| castor oil polyglycol ether (35 mol of ethylene oxide) | 4% |
| Cyclohexanone | 30% |
| xylene mixture | 50% |

Emulsions of any required dilution, which can be used in plant protection, can be obtained from this concentrate by dilution with water.

| Dusts | a) | b) | c) |
|---|---|---|---|
| Active ingredients | 5% | 6% | 4% |
| Talcum | 95% | — | — |
| Kaolin | — | 94% | — |
| mineral filler | — | — | 96% |

Ready-for-use dusts are obtained by mixing the combination with the carrier and grinding the mixture in a suitable mill. Such powders can also be used for dry dressings for seed.

Extruder granules

| | |
|---|---|
| Active ingredients | 15% |
| sodium lignosulfonate | 2% |
| carboxymethylcellulose | 1% |
| Kaolin | 82% |

The combination is mixed and ground with the adjuvants, and the mixture is moistened with water. The mixture is extruded and then dried in a stream of air.

Coated granules

| | |
|---|---|
| Active ingredients | 8% |
| polyethylene glycol (mol. wt. 200) | 3% |
| Kaolin | 89% |

The finely ground combination is uniformly applied, in a mixer, to the kaolin moistened with polyethylene glycol. Non-dusty coated granules are obtained in this manner.

Suspension concentrate

| | |
|---|---|
| active ingredients | 40% |
| propylene glycol | 10% |
| nonylphenol polyethylene glycol ether (15 mol of ethylene oxide) | 6% |
| Sodium lignosulfonate | 10% |
| carboxymethylcellulose | 1% |
| silicone oil (in the form of a 75% emulsion in water) | 1% |
| Water | 32% |

The finely ground combination is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

Flowable concentrate for seed treatment

| | |
|---|---|
| active ingredients | 40% |
| propylene glycol | 5% |
| copolymer butanol PO/EO | 2% |
| Tristyrenephenole with 10-20 moles EO | 2% |
| 1,2-benzisothiazolin-3-one (in the form of a 20% solution in | 0.5% |
| water) | |
| monoazo-pigment calcium salt | 5% |
| Silicone oil (in the form of a 75% emulsion in water) | 0.2% |
| Water | 45.3% |

The finely ground combination is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

### Slow Release Capsule Suspension

28 parts of the combination are mixed with 2 parts of an aromatic solvent and 7 parts of toluene diisocyanate/polymethylene-polyphenylisocyanate-mixture (8:1). This mixture is emulsified in a mixture of 1.2 parts of polyvinylalcohol, 0.05 parts of a defoamer and 51.6 parts of water until the desired particle size is achieved. To this emulsion a mixture of 2.8 parts 1,6-diaminohexane in 5.3 parts of water is added. The mixture is agitated until the polymerization reaction is completed. The obtained capsule suspension is stabilized by adding 0.25 parts of a thickener and 3 parts of a dispersing agent. The capsule suspension formulation contains 28% of the active ingredients. The medium capsule diameter is 8-15 microns. The resulting formulation is applied to seeds as an aqueous suspension in an apparatus suitable for that purpose.

A VACht COMPOUND and/or suitable mixture with one or more active ingredient from another IRAC mode of action group can be used in a method for controlling pests, with the exception of a method for treatment of the human or animal body by surgery or therapy and diagnostic methods practised on the human or animal body.

The mixtures comprising a VAChT COMPOUND and one or more active ingredient from another IRAC mode of action group can be applied, for example, in a single “ready-mix” form, in a combined spray mixture composed from separate formulations of the single active ingredient components, such as a “tank-mix”, and in a combined use of the single active ingredients when applied in a sequential manner, i.e. one after the other with a reasonably short period, such as a few hours or days. The order of applying a VAChT COMPOUND and one or more other active ingredients as described above is not essential for working the present invention.

The compositions can also comprise further solid or liquid auxiliaries, such as stabilizers, for example unepoxidized or epoxidized vegetable oils (for example epoxidized coconut oil, rapeseed oil or soya oil), antifoams, for example silicone oil, preservatives, viscosity regulators, binders and/or tackifiers, fertilizers or other active ingredients for achieving specific effects, for example bactericides, fungicides, nematocides, plant activators, molluscicides or herbicides.

The compositions are prepared in a manner known per se, in the absence of auxiliaries for example by grinding, screening and/or compressing a solid active ingredient and in the presence of at least one auxiliary for example by intimately mixing and/or grinding the active ingredient with the auxiliary (auxiliaries). These processes for the preparation of the compositions and the use of the compounds I for the preparation of these compositions are also a subject of the invention.

The application methods for the compositions, that is the methods of controlling pests of the abovementioned type, such as spraying, atomizing, dusting, brushing on, dressing, scattering or pouring—which are to be selected to suit the intended aims of the prevailing circumstances—and the use of the compositions for controlling pests of the abovementioned type are other subjects of the invention.

A preferred method of application in the field of crop protection is application to the foliage of the plants (foliar application), it being possible to select frequency and rate of application to match the danger of infestation with the pest in question. Alternatively, the active ingredient can reach the plants via the root system (systemic action), by drenching the locus of the plants with a liquid composition or by incorporating the active ingredient in solid form into the locus of the plants, for example into the soil, for example in the form of granules (soil application). In the case of paddy rice crops, such granules can be metered into the flooded paddy-field.

The VAChT COMPOUNDS and compositions thereof are also suitable for the protection of plant propagation material, for example seeds, such as fruit, tubers or kernels, or nursery plants, against pests of the abovementioned type. The propagation material can be treated with the compound prior to planting, for example seed can be treated prior to sowing. Alternatively, the compound can be applied to seed kernels (coating), either by soaking the kernels in a liquid composition or by applying a layer of a solid composition. It is also possible to apply the compositions when the propagation material is planted to the site of application, for example into the seed furrow during drilling. These treatment methods for plant propagation material and the plant propagation material thus treated are further subjects of the invention. Typical treatment rates would depend on the plant and pest/fungi to be controlled and are generally between 1 to 200 grams of Al per 100 kg of seeds, preferably between 5 to 150 grams of Al per 100 kg of seeds, such as between 10 to 100 grams of Al per 100 kg of seeds.

The term seed embraces seeds and plant propagules of all kinds including but not limited to true seeds, seed pieces, suckers, corns, bulbs, fruit, tubers, grains, rhizomes, cuttings, cut shoots and the like and means in a preferred embodiment true seeds.

The term “coated or treated with and/or containing” generally signifies that the active ingredient is for the most part on the surface of the seed at the time of application, although a greater or lesser part of the ingredient may penetrate into the seed material, depending on the method of application. When the said seed product is (re)planted, it may absorb the active ingredient.

Seed treatment comprises all suitable seed treatment techniques known in the art, such as seed dressing, seed coating, seed dusting, seed soaking and seed pelleting. The seed treatment application of active ingredient can be carried out by any known methods, such as spraying or by dusting the seeds before sowing or during the sowing/planting of the seeds.

In each aspect and embodiment of the invention, “consisting essentially” and inflections thereof are a preferred embodiment of “comprising” and its inflections, and “consisting of” and inflections thereof are a preferred embodiment of “consisting essentially of” and its inflections.

The disclosure in the present application makes available each and every combination of embodiments disclosed herein.

The VAChT COMPOUNDS of the invention can be distinguished from other similar compounds by virtue of greater efficacy at low application rates and/or different pest control, which can be verified by the person skilled in the art using the experimental procedures, using lower concentrations if necessary, for example 10 ppm, 5 ppm, 2 ppm, 1 ppm or 0.2 ppm; or lower application rates, such as 300, 200 or 100, mg of Al per m². The greater efficacy can be observed by an increased safety profile (against non-target organisms above and below ground (such as fish, birds and bees), improved physico-chemical properties, or increased biodegradability).

### EXPERIMENTAL

### Mode of Action Studies

Radioligand binding with a tritiated alkylsulfone permitted the identification of the vesicular acetylcholine transported as the site of insecticidal action. The VAChT as a target for insecticides was first identified by Sluder et al 2012 for the Spiroindline class of chemistry (PLOS ONE 7(5): e34712. https://doi.org/10.1371/journal.pone.0034712). Methods herein were generally adapted from this publication.

### Methodology

All alkylsulfone test compounds Table P were synthesized according to methods described in the patent literature. The syntheses of 5-CI-CASPP (also known as SYN351) and 5-F-CASPP (also known as SYN876) are described in Sluder et al 2012. [³H]-A1 was synthesized by a tritium gas exchange method to a specific activity of in excess of 1TBq.mmol⁻¹. [³H]-A1 was purified by HPLC and stored at 37 MBq.ml⁻¹ in ethanol.

### [³H]-A1 Binding

Binding of [³H]-A1 was measured using Lucilia sericata head membrane suspended in 50 mM Tris HCL buffer (pH7.4) containing 120 mM NaCl, and 100 mM EDTA, at a protein concentration of 1 mg/ml for dispensing into 96 well plates to give 50 μg protein per well. [³H]-A1 was added to plates as a 37 MBq/ml ethanol stock dissolved in 2.2 ml assay buffer to give an approximate final well concentration of 9 nM. Test compounds were incubated at 25° C. for 90 min with 9 nM [³H]-A1 (or a range of concentrations for saturation analysis) at either 8 rates (where prepared manually) or 6 or 10 rates where prepared using robotics. The binding incubation was terminated by vacuum filtration through glass fibre filter mats (PerkinElmerFilterMat A, Seer Green, UK), pre-treated with 0.5% polyethyleneimine and mounted on a Tomtec cell harvester. The filters were then washed rapidly with ice-cold water, dried and bound radioactivity measured using an EG&GWallac betaplate scintillation counter after impregnating the filter with solid scintillant (PerkinElmer MeltiLex). Non specific binding was subtracted from the counts at each data point to give the specific binding. The amount of displacement was calculated as a % of the control and the IC50 calculated from a curve fitted using a single-exponential algorithm. The IC50 for the assay standard in each assay was typically close to 10 nM.

### Binding IC50 Measurements of Test Compounds

Relative binding potencies were calculated from data derived from 6 or 8-doses where the highest concentration used was 1 ppm. Data was fitted with a single-exponential model.

TABLE X1
experimental compounds*

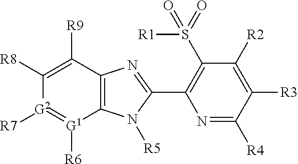

Core A

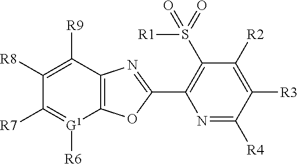

Core B

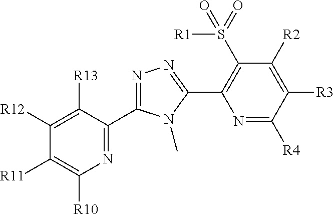

Core C

| Example | | | | | | | | | | | | | | | |
|---|---|---|---|---|---|---|---|---|---|---|---|---|---|---|---|
| compound | G¹ | G² | R1 | R2 | R3 | R4 | R5 | R6 | R7 | R8 | R9 | R10 | R11 | R12 | R13 |
| A1 | N | C | Et | H | H | H | Me | | H | CF₃ | H | | | | |
| A2 | C | N | Et | H | CF₃ | H | Me | H | | CF₃ | | | | | |
| A3 | N | C | Et | H | CF₃ | H | Me | | H | CF₃ | H | | | | |
| B1 | C | | Et | H | H | H | | H | H | SO₂CF₃ | H | | | | |
| C1 | | | Et | H | CF₃ | H | | | | | | H | H | CF₃ | H |

*Preparation of A1, A3 and analogs: Takahashi M, Tanabe T, Ito M, et al. Preparation of sulfanylpyridinylimidazopyridine derivatives and analogs for use as pesticides, WO2013/018928 (2013). Preparation of A2: Edmunds A, Muehlebach M, Stoller A, et al. Pesticidally active bi- or tricyclic heterocycles with sulfur containing substituents and their preparation, WO2015/000715 (2015). Preparation of B1: Takahashi M, Tanabe T, Ito M, et al. Preparation of fused oxazole compounds
useful for pest control, WO2014/104407 (2014). Preparation of C1: Muehlebach M, Titulaer R, Emery D, et al. Preparation of 1,2,4-triazole derivatives with sulfur containing substituents as pesticides such as insecticides, WO2015/144826 (2015).

To explore the binding of alkylsulfones to insect-derived protein samples we generated a radiolabelled sample of example compound A1 by catalytic tritium exchange. [³H]-A1 was found to bind with high affinity to membrane preparations from the blowfly Lucilia serracata with a K_{D} value of approximately 14.5 nM. The ratio of specific to total including non-specific binding in whole head membrane samples was typically >90% using the filtration method. Affinity at the [³H]-A1 binding site for analogues was evaluated in competitive displacement studies, A2—39 nM, A3—10 nM, B1—2 nM and C1—6.3 nM.

TABLE
IC50 Displacement Values of [³H]-A1

| VAChT compound | nM |
|---|---|
| VAChT-1 | 100 |
| VAChT-7 | 8 |
| VAChT-13 | 2 |
| VAChT-16 | 10 |
| VAChT-19 | 2 |
| VAChT-20 | 4 |
| VAChT-27 | 25 |
| VAChT-34 | 40 |
| VAChT-35 | 79 |

To determine whether the potency of compounds in displacing [³H]-A1 from its binding-site would correlate with their insecticidal potency, the competitive displacement IC50 values were compared to measures of insecticidal activity that were based on scoring the breakpoint dose at which 80% or greater mortality was achieved (BP80). Table X2 provides a distribution of in-vitro potencies across different levels of insecticidal activity against Spodoptera littoralis L1 larvae (as previously described in Sluder et al 2012), and in-vitro activity measured as potency for displacement of [³H]-A1). There is a clear correlation between binding affinity and insecticidal potency against Spodoptera larvae confirming that this specific binding represents the insecticidal relevant target protein for alkylsulfones.

TABLE X2
Insecticidal activity measured against
Spodoptera littoralis L1 larvae

| | | weak | | strong |
|---|---|---|---|---|
| | Inactive* | biology* | Moderate* | biology* |
| IC50 > 1000 nM | 115 | 4 | 0 | 0 |
| IC50 > 100 nM, ≤1 μM | 154 | 21 | 2 | 0 |
| IC50 > 10 nM, ≤100 nM | 270 | 155 | 112 | 16 |
| IC50 ≤ 10 nM | 90 | 143 | 137 | 79 |

*in-vivo activity consisted of strong (pBP80 >5.5), moderate (pBP80 >4.5 and ≤5.5), weak (pBP80 >3 and ≤4.5), inactive (BP80 could not be scored at doses up to 200 ppm). The molar effective concentrations (pBP80) were calculated using the method developed by Copeland et al (Copeland RA, Lombardo D, Giannaras J and Decicco CP, Estimating KI values for tight binding inhibitors from dose-response plots. Bioorg Med Lett 5(17): 1947-1952 (1995)): Concentrations in mg/L−1 causing 80% mortality (BP80) were determined with the means of the corrected mortality values. In addition, the molar weight (MW) of different test compounds and a correction factor of 1000 to convert to molar units were applied before log transformation: pBP80 = −log (BP80/1000/MW).

### Pharmacology of [³H]-A1 Binding

To identify the insecticidal target-protein for alkylysulfones we examined the ability of a range of ligands with identified target proteins to displace [³H]-A1 from its site on Lucilia membranes (see Table X3). Three compounds showed potent displacement of [³H]-A1. All three compounds are known drugs acting at the vesicular acetylcholine transporter (VAChT) demonstrating that the binding-site for [³H]-A1 is located on this protein.

TABLE X3

| Drug/Insecticide | Target Protein | [³H]-A1 displacement IC₅₀ (nM) |
|---|---|---|
| Aldicarb | acetylcholinesterase | Inactive or IC50 >52610 |
| Pirimiphos-methyl | acetylcholinesterase | Inactive or IC50 >32780 |
| Emamectin Benzoate | Glutamate-gated chloride channel | 11280 |
| Fipronil | GABA-gated chloride channel | Inactive or IC50 >22900 |
| Endrin | GABA-gated chloride channel | Inactive or IC50 >26460 |
| Dieldrin | GABA-gated chloride channel | Inactive or IC50 >26500 |
| Spinosad | Nicotinic ACh-receptor | Inactive or IC50 >13700 |
| Imidacloprid | Nicotinic ACh-receptor | Inactive or IC50 >19800 |
| Dinotofuran | Nicotinic ACh-receptor | Inactive or IC50 >49500 |
| Chlorantraniliprole | Ryanodine receptor | Inactive or IC50 >20800 |
| Cyantraniliprole | Ryanodine receptor | Inactive or IC50 >21186 |
| Ryanodine | Ryanodine receptor | Inactive or IC50 >22900 |
| Fenvalerate | Voltage-gated sodium channel | Inactive or IC50 >23900 |
| Tetramethrin | Voltage-gated sodium channel | 17400 |
| Indoxacarb | Voltage-gated sodium channel | Inactive or IC50 >19000 |
| DCJW (active ingredient | Voltage-gated sodium channel | Inactive or IC50 >21300 |
| of indoxacarb) | | |
| Aminobenzovesamicol | Vesicular ACh-transporter | 17.6 |
| 5-CI-CASPP | Vesicular ACh-transporter | 3.3 |
| 5-F-CASPP | Vesicular ACh-transporter | 2.3 |
| Spirotetramat enol | acetyl-CoA carboxylase | Inactive or IC50 >33200 |
| Amitraz | Octopamine receptor | Inactive or IC50> |
| Chlordimeform | Octopamine receptor | Inactive or IC50> |
| Tebufenozide | ecdysone receptor | Inactive or IC50 >28390 |
| Halofenozide | ecdysone receptor | Inactive or IC50 >30290 |
| Antimycin A1 | ubiquinol-cytochrome c | Inactive or IC50 >18240 |
| | oxidoreductase | |

To further define that the high-affinity binding site of [³H]-A1, representing alkylsulfone chemistry is located on the VAChT protein we carried out binding assays in PC12 cells engineered to express Drosophila VAChT. A binding site was produced in PC12 cells only when transformed to express the D. melanogaster gene for VAChT (Table X4) no evidence of specific binding was observed in PCC12 cells transfected with the transformation vector only.

### Biological Trials

Myzus persicae (Green Peach Aphid), Mixed Population, Feeding/Contact (sMP)

Pepper plants were infested with an Myzus persicae population of mixed ages. One day after infestation the plants were treated with the diluted test solutions in a spray chamber. 5 days after treatment samples were assessed for mortality.

Resistant Myzus persicae (rMP)

Originally field-collected in 2009 from Southern France (East of Avignon, close to Monteux). Population displayed from 40 to >3000-fold resistance to IRAC 4A compounds (Thiamethoxam, acetamiprid, thiacloprid, clothianidin, sulfoxaflor, nitenpyram, dinotefuran) and >5000-fold resistance to IRAC 3A (Lambda-cyhalothrin). Bioassays using the synergist PBO indicated that enhanced P450 metabolism (CYP6CY3) was part of resistance mechanism. A mutation in the nAChR (R81T) was found in 100% allele frequency, which confers target site resistance to IRAC 4A. Voltage-gated sodium channel mutations L1014F and M918T conferring resistance to IRAC 3A were also detected in the strain in heterozygous and homozygous forms, respectively. Finally, the strain carries the FE4 R3 carboxylesterase overexpression which confers resistance to organophosphates, carbamates and pyrethroids.

Bemisia tabaci (Cotton Whitefly), Adult, Feeding/Contact (sBT)

Cotton leaf discs were placed upside down in petri dishes on water agar and treated with the diluted test solutions in a spray chamber. After drying, leaf discs were infested with 10 adult Bemisia tabaci. Dishes were covered with a fabric filter and sealed with a perforated plastic lid. 4 days after treatment samples were assessed for mortality.

Resistant Bemisia tabaci (rBT)

Biotype Q originally field-collected in 2000 from Almeria, Spain. Population displayed up to 200-fold resistance to neonicotinoids IRAC 4A (Thiamethoxam, Thiacloprid), and 40-fold resistance to pyrethroids IRAC 3A (Lambda-cyhalothrin). The strain carried the mutation L925I in the voltage-gated sodium channel conferring resistance to pyrethroids. It also had higher expression of the p450 CYP6CM1 conferring metabolic resistance to neonicotinoids.

Nilaparvata lugens (Brown Plant Hopper), Nymphs, Feeding/Contact (sNIL)

Rice plants were treated with the diluted test solutions in a spray chamber. After drying, plants were infested with ~20 Nilaparvata lugens nymphs (N5). 7 days after the treatment samples were assessed for mortality. The adults were then removed and 15 days after the treatment samples were assessed for effect on F1 generation.

Resistant Nilaparvata lugens (rNIL)

Originally collected from Hosa-Hally, Karnataka district, India in 2005. Strain displayed high levels of resistance to IRAC 4A neonicotinoids (5000-fold resistance to imidacloprid, 200-fold to Thiamethoxam and clothianidin and 30-fold to Dinotefuran and Nitenpyram). Investigations suggest that strain has an enhanced P450-mediated metabolism.

Plutella xylostella (Diamond Back Moth), Larvae, Feeding/Contact (sPLU)

Chinese cabbage plants were treated with the diluted test solutions in a spray chamber. After drying, the leaves were cut off and placed in petri dishes with wetted filter paper. One day after treatment, the leaves were infested with 10 Plutella xylostella larvae (L3). Samples were assessed 4 days after infestation for mortality and growth regulation.

Resistant Plutella xylostella (rPLU)

Originally collected from Changhua, Taiwan in 2013 demonstrated to have high levels of resistance to diamides IRAC 28 (1500-fold to chlorantraniliprole, 300-fold to cyantraniliprole and flubendiamide), organophosphates IRAC 1B (100-fold to chlorpyrifos), phenylpyrazoles IRAC 2B (300-fold to fipronil), pyrethroids IRAC 3A (>800-fold to lambda-cyhalothrin) and IRAC 6 (>200-fold to abamectin). A number of target-sites mutations were identified in this strain which confer resistance to pyrethroids (L1014F, T929I), organophosphates and carbamates (mAChE: A298S and G324A), and organochlorines (rdl: A298S), and diamides (ryr: G4546E). Additional metabolic mechanisms have been suggested to occur in the strain as well.

TABLE X4
Saturation isotherm for [³H]A1 binding in PC12
transfected with Drosophila VAChT or empty vector*

| | | | WT VAchT | | | | Vector only | |
|---|---|---|---|---|---|---|---|---|
| | WT VAchT | | Non-Specific | | Vector only | | Non-Specific | |
| [3H-A1] | Total Binding | | Binding | | Total Binding | | Binding | |
| nM | (dpm) | | (dpm) | | (dpm) | | (dpm) | |
| 228.44 | 4844.5 | 5503.2 | 1800.2 | 1541.9 | | | | |
| 105.59 | 3438.9 | 3924.95 | 749.5 | 794.8 | | | | |
| 54.04 | 3348.2 | 3368.7 | 439.5 | 342 | | | | |
| 28.11 | 2842.1 | 2902.45 | 226.1 | 230.4 | | | | |
| 14.33 | 2089.5 | 2150.55 | 113.3 | 71.3 | | | | |
| 7.45 | 1562.7 | 1567.9 | 58 | 82.9 | | | | |
| 3.8 | 945.2 | 1094.35 | 72.1 | 42.1 | | | | |
| 1.93 | 611.5 | 632.9 | 53.5 | 45.3 | | | | |
| 1.03 | 441.6 | 422.9 | 39.4 | 31.1 | | | | |
| 0.53 | 258.3 | 233.5 | 25.8 | 19.4 | | | | |
| 0.29 | 176.2 | 151.05 | 18.9 | 14.7 | | | | |
| 99.02 | | | | | 512.1 | 503.8 | 545.4 | 439.4 |
| 50.55 | | | | | 246.7 | 228.2 | 71.3 | 192.7 |
| 26.8 | | | | | 157.5 | 124.9 | 86 | 103.6 |
| 12.78 | | | | | 51.8 | 66.7 | 46.1 | 64.2 |

*NSB—Non-specific binding (determined in presence of excess cold version of A1)

TABLE P
pBP80 of VAChT COMPOUNDS on sensitive and resistance species

| | | | | | | | sNIL- | sNIL- | rNIL- | rNIL- | | |
|---|---|---|---|---|---|---|---|---|---|---|---|---|
| | | | s- | r- | | | 7 | 15 | 7 | 15 | s- | r- |
| # | Structure | Chemical Name | MP | MP | sBT | rBT | days | days | days | days | PLU | PLU |
| P1 | 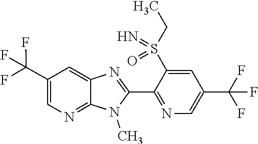 [SMILES: CCS(=N)(=O)c1cc(C(F)(F)F)cnc1-c1nc2cc(C(F)(F)F)cnc2n1C] | 2-[3- ethylsulfonyl-5- (trifluoromethyl)-2- pyridyl]-3-methyl- 6- (trifluoromethyl) imidazo[4,5-c] pyridine | | | 4.4 | 4.4 | 5.1 | 5.1 | 4.5 | 5.2 | 5.2 | 4.4 |
| P2 | 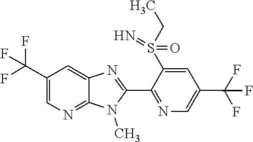 [SMILES: CCS(=N)(=O)c1cc(C(F)(F)F)cnc1-c1nc2cc(C(F)(F)F)cnc2n1C] | ethyl-imino-[2-[3- methyl-6- (trifluoromethyl) imidazo[4,5-b] pyridin-2-yl]-5- (trifluoromethyl)- 3-pyridyl]-oxo- lambda6-sulfane | | | 3.9 | 3.9 | | | | | 3.9 | 3.9 |
| P3 | 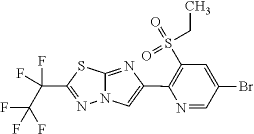 [SMILES: CCS(=O)(=O)c1cc(Br)cnc1-c1cn2nc(C(F)(F)C(F)(F)F)sc2n1] | 6-(5-bromo-3- ethylsulfonyl-2- pyridyl)-2- (1,1,2,2,2- pentafluoroethyl) imidazo[2,1-b] [1,3,4]thiadiazole | | | | | | | | | 5.8 | 0.0 |
| P4 | 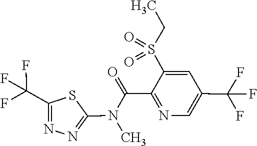 [SMILES: CCS(=O)(=O)c1cc(C(F)(F)F)cnc1C(=O)N(C)c1nnc(C(F)(F)F)s1] | 3-ethylsulfonyl-N- methyl-5- (trifluoromethyl)- N-[5-(trifluoro- methyl)-1,3,4- thiadiazol-2-yl] pyridine-2- carboxamide | | | | | | | | | 4.6 | 0.0 |
| P5 | 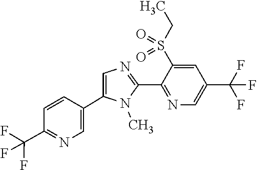 [SMILES: CCS(=O)(=O)c1cc(C(F)(F)F)cnc1-c1ncc(-c2ccc(C(F)(F)F)nc2)n1C] | 3-ethylsulfonyl- 2-[1- methyl-5-[6- (trifluoromethyl)- 3-pyridyl]imidazol- 2-yl]-5- (trifluoromethyl) pyridine | | | 4.0 | 4.0 | | | | | 4.0 | 4.0 |
| P6 | 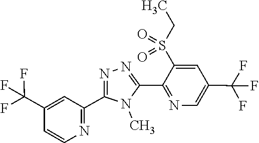 [SMILES: CCS(=O)(=O)c1cc(C(F)(F)F)cnc1-c1nnc(-c2cc(C(F)(F)F)ccn2)n1C] | 3-ethylsulfonyl- 2-[4- methyl-5-[4- (trifluoromethyl)- 2-pyridyl]-1,2,4- triazol-3-yl]-5- (trifluoromethyl) pyridine | | | 5.2 | 5.2 | | | | | 4.5 | 3.4 |
| P7 | 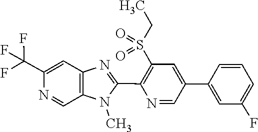 [SMILES: CCS(=O)(=O)c1cc(-c2cccc(F)c2)cnc1-c1nc2cc(C(F)(F)F)ncc2n1C] | 2-[3-ethylsulfonyl- 5-(3- fluorophenyl)-2- pyridyl]-3-methyl- 6-(trifluoromethyl) imidazo[4,5-c] pyridine | | | | | | | | | 6.9 | 5.7 |
| P8 | 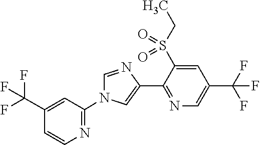 [SMILES: CCS(=O)(=O)c1cc(C(F)(F)F)cnc1-c1cn(-c2cc(C(F)(F)F)ccn2)cn1] | 3-ethylsulfonyl-5- (trifluoromethyl)- 2-[1-[4- (trifluoromethyl)- 2-pyridyl] imidazol-2- yl]pyridine | | | | | | | | | 4.5 | 4 |
| P9 | 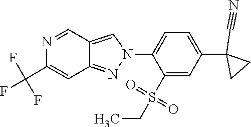 [SMILES: CCS(=O)(=O)c1cc(C2(C#N)CC2)ccc1-n1cc2cnc(C(F)(F)F)cc2n1] | 1-[3-ethylsulfonyl- 4-[6-(trifluoro- methyl)pyrazolo [4,3-c]pyridin-2- yl]phenyl]cyclo- propanecarbonitrile | | | 5.1 | 5.1 | | | | | 6.8 | 4.5 |
| P10 | 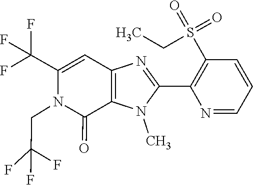 [SMILES: CCS(=O)(=O)c1cccnc1-c1nc2cc(C(F)(F)F)n(CC(F)(F)F)c(=O)c2n1C] | 2-(3-ethylsulfonyl- 2-pyridyl)-3- methyl-5- (2,2,2-trifluoro- ethyl)-6- (trifluoromethyl) imidazo[4,5-c] pyridin-4-one | | | | | | | | | 5.8 | 4.6 |
| P11 | 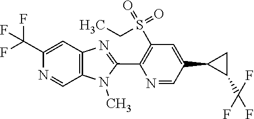 [SMILES: CCS(=O)(=O)c1cc([C@H]2C[C@@H]2C(F)(F)F)cnc1-c1nc2cc(C(F)(F)F)ncc2n1C] | 2-[3-ethylsulfonyl- 5-[(1S,2S)-2- (trifluoromethyl) cyclopropyl]-2- pyridyl]-3-methyl- 6-(trifluoromethyl) imidazo[4,5-c] pyridine | | | 5.2 | 4.6 | | | | | 6.4 | 5.2 |
| P12 | 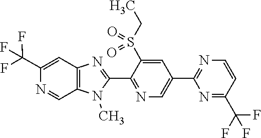 [SMILES: CCS(=O)(=O)c1cc(-c2nccc(C(F)(F)F)n2)cnc1-c1nc2cc(C(F)(F)F)ncc2n1C] | 2-[3-ethylsulfonyl- 5-[4-(trifluoro- methyl)pyrimidin- 2-yl]-2-pyridyl]-3- methyl-6- (trifluoromethyl) imidazo[4,5-c] pyridine | | | | | | | | | 5.2 | 4 |
| P13 | 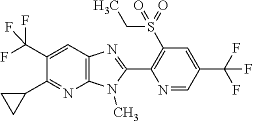 [SMILES: CCS(=O)(=O)c1cc(C(F)(F)F)cnc1-c1nc2cc(C(F)(F)F)c(C3CC3)nc2n1C] | 5-cyclopropyl-2-[3- ethylsulfonyl-5- (trifluoromethyl)-2- pyridyl]-3-methyl- 6- (trifluoromethyl) imidazo[4,5-b] pyridine | | | | | | | | | 5.2 | 4.0 |
| P14 | 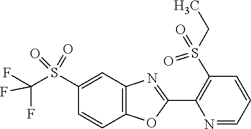 [SMILES: CCS(=O)(=O)c1cccnc1-c1nc2cc(S(=O)(=O)C(F)(F)F)ccc2o1] | 2-(3-ethylsulfonyl- 2-pyridyl)-5- (trifluoromethyl- sulfonyl)-1,3- benzoxazole | | | 0 | 0 | 5.6 | 5.0 | 5.7 | 5.7 | 4.5 | 4.5 |
| P15 | 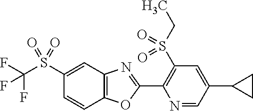 [SMILES: CCS(=O)(=O)c1cc(C2CC2)cnc1-c1nc2cc(S(=O)(=O)C(F)(F)F)ccc2o1] | 2-(5-cyclopropyl- 3-ethylsulfonyl-2- pyridyl)-5- (trifluoromethyl- sulfonyl)-1,3- benzoxazole | | | 0 | 0 | | | | | 5.8 | 5.8 |
| P16 | 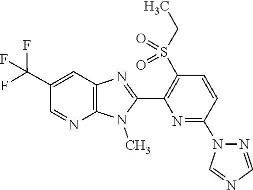 [SMILES: CCS(=O)(=O)c1ccc(-n2cncn2)nc1-c1nc2cc(C(F)(F)F)cnc2n1C] | 2-[3-ethylsulfonyl- 6-(1,2,4-triazol-1- yl)-2-pyridyl]-3- methyl-6- (trifluoromethyl) imidazo[4,5-b] pyridine | | | 0 | 0 | 5.7 | 5.7 | 5.7 | 5.7 | 6.3 | 5.2 |
| P17 | 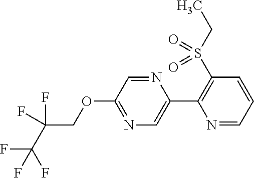 [SMILES: CCS(=O)(=O)c1cccnc1-c1cnc(OCC(F)(F)C(F)(F)F)cn1] | 2-(3-ethylsulfonyl- 2-pyridyl)-5-(2,2,3, 3,3-pentafluoro- propoxy) pyrazine | | | 0 | 0 | | | | | 4.5 | 0.0 |
| P18 | 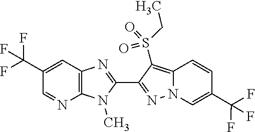 [SMILES: CCS(=O)(=O)c1c(-c2nc3cc(C(F)(F)F)cnc3n2C)nn2cc(C(F)(F)F)ccc12] | 2-[3-ethylsulfonyl- 6-(trifluoromethyl) pyrazolo[1,5-a] pyridin-2-yl]-3- methyl-6- (trifluoromethyl) imidazo[4,5-b] pyridine | | | 0.0 | 0 | | | | | 7.0 | 6.4 |
| P19 | 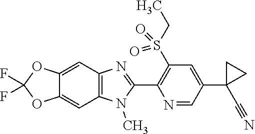 [SMILES: CCS(=O)(=O)c1cc(C2(C#N)CC2)cnc1-c1nc2cc3c(cc2n1C)OC(F)(F)O3] | 1-[6-(2,2- difluoro-7-methyl- [1,3]dioxolo[4,5- f]benzimidazol- 6-yl)-5-ethyl- sulfonyl-3- pyridyl]cyclo- propanecarbonitrile | | | 4 | 4 | | | | | 7.0 | 5.7 |
| P20 | 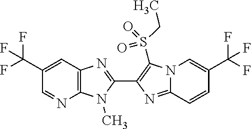 [SMILES: CCS(=O)(=O)c1c(-c2nc3cc(C(F)(F)F)cnc3n2C)nc2ccc(C(F)(F)F)cn12] | 2-[3-ethylsulfonyl- 6-(trifluoromethyl) imidazo[1,2-a] pyridin-2-yl]-3- methyl-6- (trifluoromethyl) imidazo[4,5-b] pyridine | | | 0 | 0 | | | | | 6.4 | 5.8 |
| P21 | 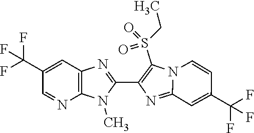 [SMILES: CCS(=O)(=O)c1c(-c2nc3cc(C(F)(F)F)cnc3n2C)nc2cc(C(F)(F)F)ccn12] | 2-[3-ethylsulfonyl- 7-(trifluoromethyl) imidazo[1,2-a] pyridin-2-yl]-3- methyl-6- (trifluoromethyl) imidazo[4,5-b] pyridine | | | 0 | 0 | | | | | 6.4 | 5.8 |
| P21 | 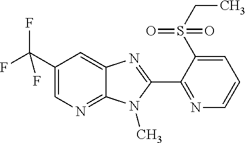 [SMILES: CCS(=O)(=O)c1cccnc1-c1nc2cc(C(F)(F)F)cnc2n1C] | 2-(3- ethylsulfonyl-2- pyridyl)-3- methyl-6- (trifluoromethyl) imidazo[4,5-b] pyridine | | | | | 3.9 | 3.9 | 3.3 | 3.9 | 5.6 | 3.9 |
| P22 | 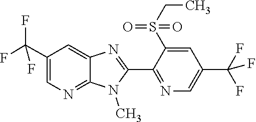 [SMILES: CCS(=O)(=O)c1cc(C(F)(F)F)cnc1-c1nc2cc(C(F)(F)F)cnc2n1C] | 2-[3- ethylsulfonyl-5- (trifluoromethyl)- 2-pyridyl]- 3-methyl-6- (trifluoromethyl) imidazo[4,5-b] pyridine | | | 4.5 | 4.5 | 4.5 | 4.9 | 4.5 | 4.5 | 5.7 | 5.2 |
| P23 | 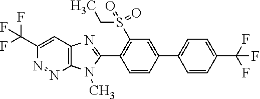 [SMILES: CCS(=O)(=O)c1cc(-c2ccc(C(F)(F)F)cc2)ccc1-c1nc2cc(C(F)(F)F)nnc2n1C] | 6-[2-ethylsulfonyl- 4-[4-(trifluoro- methyl)phenyl] phenyl]-7-methyl- 3-(trifluoromethyl) imidazo[4,5-c] pyridine | | | | | | | | | 5.7 | 5.2 |
| P24 | 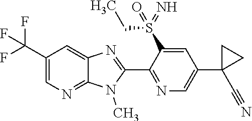 | (R)-1-[5-(ethyl- sulfonimidoyl)- 6-[3-methyl-6- (trifluoromethyl) imidazo[4,5-b] pyridin-2-yl]-3- pyridyl]cyclo- propanebonitrile | 5.2 | 4.5 | 5.1 | 3.9 | | | | | | |
| P25 | 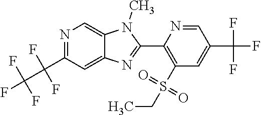 [SMILES: CCS(=O)(=O)c1cc(C(F)(F)F)cnc1-c1nc2cc(C(F)(F)C(F)(F)F)ncc2n1C] | 2-[3- ethylsulfonyl-5- (trifluoromethyl)- 2-pyridyl]-3- methyl-6- (1,1,2,2,2- pentafluoroethyl) imidazo[4,5-c] | | | 5.2 | 4.6 | | | | | | |
| | | pyridine | | | | | | | | | | |
| P26 | 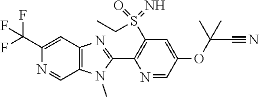 [SMILES: CCS(=N)(=O)c1cc(OC(C)(C)C#N)cnc1-c1nc2cc(C(F)(F)F)ncc2n1C] | 2-[[5-(ethyl- sulfonimidoyl)- 6-[3-methyl-6- (trifluoromethyl) imidazo[4,5-c] pyridin-2-yl]-3- pyridyl]oxy]-2- | 4.6 | 4.6 | 5.1 | 4.5 | | | | | | |
| | | methylpropane- | | | | | | | | | | |
| | | nitrile | | | | | | | | | | |
| P27 | 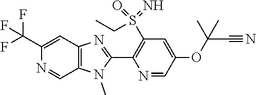 [SMILES: CCS(=N)(=O)c1cc(OC(C)(C)C#N)cnc1-c1nc2cc(C(F)(F)F)ncc2n1C] | 2-[[5-(ethyl- sulfonimidoyl)-6- [3-methyl-6-(tri- fluoromethyl) imidazo[4,5-c] pyridin-2-yl]-3- | 4.6 | 4 | 4 | 4.59 | | | | | | |
| | | pyridyl]oxy]-2- | | | | | | | | | | |
| | | methylpropane- | | | | | | | | | | |
| | | nitrile | | | | | | | | | | |
| P28 | 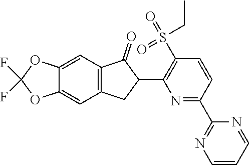 [SMILES: CCS(=O)(=O)c1ccc(-c2ncccn2)nc1C1Cc2cc3c(cc2C1=O)OC(F)(F)O3] | 6-(3-ethylsulfonyl- 6-pyrimidin-2-yl-2- pyridyl)-2,2- difluoro-5H-[1,3] dioxolo[4,5-f] isoindol-7-one | | | | | | | | | 5.2 | 4.6 |
| P29 | 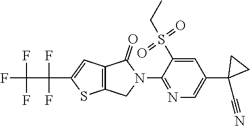 [SMILES: CCS(=O)(=O)c1cc(C2(C#N)CC2)cnc1N1Cc2sc(C(F)(F)C(F)(F)F)cc2C1=O] | 1-[5-ethylsulfonyl- 6-[4-oxo-2- (1,1,2,2,2- pentafluoroethyl)- 6H-thieno[2,3-c] pyrrol-5-yl]-3- pyridyl]cyclopro- panecarbonitrile | | | 4.6 | 4.6 | | | | | 6.9 | 6.4 |
| P30 | 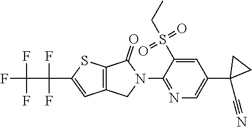 [SMILES: CCS(=O)(=O)c1cc(C2(C#N)CC2)cnc1N1Cc2cc(C(F)(F)C(F)(F)F)sc2C1=O] | 1-[5- ethylsulfonyl-6- [6-oxo-2-(1,1,2,2,2- pentafluoroethyl)- 4H-theino[2,3-c] pyrrol-5-yl]-3- pyridyl]cyclo- propanecarbonitrile | | | 0.05 | 4.6 | | | | | 5.8 | 5.2 |
| P31 | 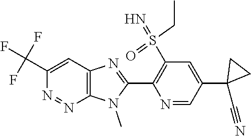 [SMILES: CCS(=N)(=O)c1cc(C2(C#N)CC2)cnc1-c1nc2cc(C(F)(F)F)nnc2n1C] | 1-[5-(ethyl- sulfonimidoyl)- 6-[7-methyl-3- (trifluoromethyl) imidazo[4,5-c] pyridazin-6-yl]-3- pyridyl]cyclo- propanecarbonitrile | 5.2 | 4.5 | 3.9 | 4.5 | 5.2 | 5.2 | 5.2 | 5.2 | | |
| P32 | 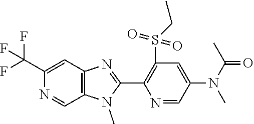 [SMILES: CCS(=O)(=O)c1cc(N(C)C(C)=O)cnc1-c1nc2cc(C(F)(F)F)ncc2n1C] | N-[5-ethylsulfonyl- 6-[3-methyl-6- (trifluoromethyl) imidazo[4,5-c] pyridin-2-yl]-3- pyridyl]-N-methyl- acetamide | 4.5 | 4.5 | | | 5.1 | 5.2 | 5.2 | 5.2 | | |
| P33 | 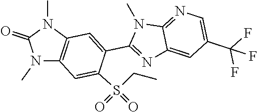 [SMILES: CCS(=O)(=O)c1cc2c(cc1-c1nc3cc(C(F)(F)F)cnc3n1C)n(C)c(=O)n2C] | 5-ethylsulfonyl- 1,3-dimethyl-6-[3- methyl-6-(trifluoro- methyl)imidazo [4,5-b]pyridin-2- yl]benzimidazol-2- one | | | 0.0 | 0 | 4.6 | 5.1 | 5.2 | 5.2 | | |
| P34 | 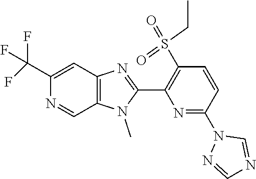 [SMILES: CCS(=O)(=O)c1ccc(-n2cncn2)nc1-c1nc2cc(C(F)(F)F)ncc2n1C] | 2-[3-ethylsulfonyl- 6-(1,2,4-triazol-1- yl)-2-pyridyl]-3- methyl-6- (trifluoromethyl) imidazo[4,5-c] pyridine | 5.2 | 4.5 | 4.5 | 3.9 | 5.2 | 5.69 | 5.71 | 5.71 | 5.69 | 4.5 |
| P35 | 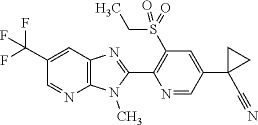 [SMILES: CCS(=O)(=O)c1cc(C2(C#N)CC2)cnc1-c1nc2cc(C(F)(F)F)cnc2n1C] | 1-[5-ethylsulfonyl- 6-[3-methyl-6- (trifluoromethyl) imidazo[4,5-b] pyridin-2-yl]-3- pyridyl]cyclo- propanecarbonitrile | 5.2 | 5.2 | 5.6 | 5.1 | 5.6 | 5.6 | 5.6 | 5.6 | 6.9 | 6.3 |
| P36 | 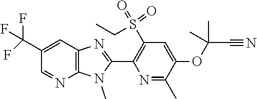 [SMILES: CCS(=O)(=O)c1cc(OC(C)(C)C#N)c(C)nc1-c1nc2cc(C(F)(F)F)cnc2n1C] | 2-[[5-ethylsulfonyl- 2-methyl-6-[3- methyl-6-(trifluoro- methyl)imidazo [4,5-b]pyridin-2- yl]-3-pyridyl] oxy]-2-methylpro- | | | 5.2 | 0 | | | | | 4.6 | 4.6 |
| | | panenitrile | | | | | | | | | | |
| P37 | 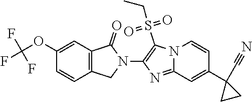 [SMILES: CCS(=O)(=O)c1c(N2Cc3ccc(OC(F)(F)F)cc3C2=O)nc2cc(C3(C#N)CC3)ccn12] | 1-[3-ethylsulfonyl- 2-[1-oxo- 6-(trifluoro- methoxy)isoindolin- 2-yl]imidazo[1,2-a] pyridin-7-yl]cyclo- propanecarbonitrile | | | 4.6 | 4 | | | | | 5.8 | 5.8 |
| P38 | 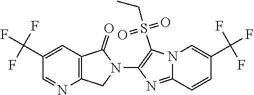 [SMILES: CCS(=O)(=O)c1c(N2Cc3ncc(C(F)(F)F)cc3C2=O)nc2ccc(C(F)(F)F)cn12] | 6-[3-ethylsulfonyl- 6-(trifluoromethyl) imidazo[1,2-a] pyridin-2-yl]-3- (trifluoromethyl)- 7H-pyrrolo[3,4-b] pyridin-5-one | | | | | | | | | 5.2 | 4.6 |
| P39 | 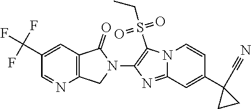 [SMILES: CCS(=O)(=O)c1c(N2Cc3ncc(C(F)(F)F)cc3C2=O)nc2cc(C3(C#N)CC3)ccn12] | 1-[3- ethylsulfonyl-2- [5-oxo-3-(trifluoro- methyl)-7H-pyrrolo [3,4-b]pyridin-6- yl]imidazo[1,2-a] pyridin-7-yl]cyclo- propanecarbonitrile | | | 4.6 | 0.05 | | | | | 5.8 | 4.6 |
| P40 | 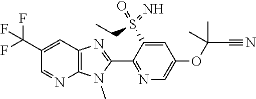 [SMILES: CC[S@](=N)(=O)c1cc(OC(C)(C)C#N)cnc1-c1nc2cc(C(F)(F)F)cnc2n1C] | (S)-2-[[5-(ethyl- sulfonimidoyl)- 6-[3-methyl-6- (trifluoromethyl) imidazo[4,5-b] pyridin-2-yl]-3- pyridyl]oxy]-2- | 4.6 | 4.6 | 4.6 | 4.6 | | | | | 0.05 | 0 |
| | | methyl- | | | | | | | | | | |
| | | propanenitrile | | | | | | | | | | |
| P41 | 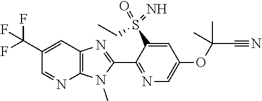 [SMILES: CC[S@@](=N)(=O)c1cc(OC(C)(C)C#N)cnc1-c1nc2cc(C(F)(F)F)cnc2n1C] | (R)-2-[[5-(ethyl- sulfonimidoyl)- 6-[3-methyl- 6-(trifluoro- methyl)imidazo [4,5-b]pyridin- 2-yl]-3-pyridyl] | 4.59 | 4.6 | 4 | 0 | | | | | 0 | 0 |
| | | oxy]-2-methyl- | | | | | | | | | | |
| | | propanenitrile | | | | | | | | | | |
| P42 | 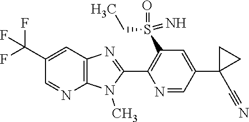 [SMILES: CC[S@@](=N)(=O)c1cc(C2(C#N)CC2)cnc1-c1nc2cc(C(F)(F)F)cnc2n1C] | (R)-1-[5-(ethyl- sulfonimidoyl)- 6-[3-methyl- 6-(trifluoro- methyl)imidazo [4,5-c]pyridin- 2-yl]-3- pyridyl]cyclo- | 4.5 | 4.5 | 5.1 | 4.5 | | | | | | |
| | | propanecarbonitrile | | | | | | | | | | |
| P43 elu- ted iso- mer of P94 (2 or 2) | 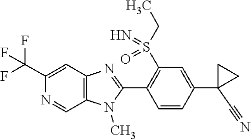 [SMILES: CCS(=N)(=O)c1cc(C2(C#N)CC2)ccc1-c1nc2cc(C(F)(F)F)ncc2n1C] | 1-[3-(ethyl- sulfonimidoyl)-4- [3-methyl-6- (trifluoromethyl) imidazo[4,5-c] pyridin-2-yl] phenyl]cyclo- propanecarbonitrile | 0.05 | 3.9 | 0.05 | 0.05 | | | | | | |
| P44 elu- ted is- omer P94 (1 of 2) | 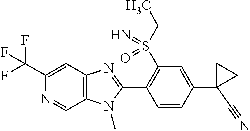 [SMILES: CCS(=N)(=O)c1cc(C2(C#N)CC2)ccc1-c1nc2cc(C(F)(F)F)ncc2n1C] | 1-[3-(ethyl- sulfonimidoyl)-4- [3-methyl-6- (trifluoromethyl) imidazo[4,5-c] pyridin-2-yl] phenyl]cyclo- propanecarbonitrile | 4.5 | 4.5 | 4.5 | 4.5 | | | | | | |
| P45 | 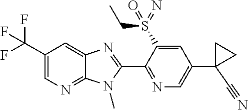 [SMILES: CC[S@](=N)(=O)c1cc(C2(C#N)CC2)cnc1-c1nc2cc(C(F)(F)F)cnc2n1C] | (S)-1-[5-(ethyl- sulfonimidoyl)- 6-[3-methyl-6- (trifluoromethyl) imidazo[4,5-c] pyridin-2-yl]-3- pyridyl]cyclo- | 5.2 | 5.2 | 4.5 | 4.5 | | | | | | |
| | | propanecarbonitrile | | | | | | | | | | |
| P46 | 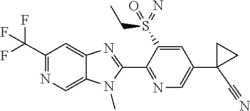 [SMILES: CC[S@](=N)(=O)c1cc(C2(C#N)CC2)cnc1-c1nc2cc(C(F)(F)F)ncc2n1C] | (S)-1-[5-(ethyl- sulfonimidoyl)-6- [3-methyl-6- (trifluoromethyl) imidazo[4,5-c] pyridin-2-yl]-3- pyridyl]cyclo- propanecarbonitrile | 4.5 | 4.5 | 3.9 | 4.5 | | | | | | |
| P47 elu- ted is- omer of the race- mate (1 or 2) | 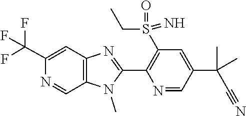 [SMILES: CCS(=N)(=O)c1cc(C(C)(C)C#N)cnc1-c1nc2cc(C(F)(F)F)ncc2n1C] | 2-[5-(ethyl- sulfonimidoyl)-6- [3- methyl-6-(trifluoro- methyl)imidazo[4,5- c]pyridin-2-yl]-3- pyridyl]-2-methyl- propanenitrile | 3.9 | 0 | 3.9 | 3.9 | | | | | | |
| P48 elu- ted is- omer of the race- mate (2 of 2) | 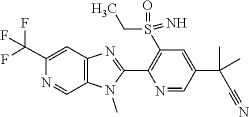 [SMILES: CCS(=N)(=O)c1cc(C(C)(C)C#N)cnc1-c1nc2cc(C(F)(F)F)ncc2n1C] | 2-[5-(ethyl- sulfonimidoyl)-6- [3- methyl-6-(trifluoro- methyl)imidazo[4,5- c]pyridin-2-yl]-3- pyridyl]-2-methyl- propanenitrile | 3.9 | 0 | 0.05 | 3.9 | | | | | | |
| P49 | 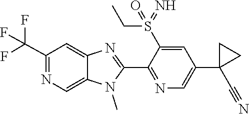 [SMILES: CCS(=N)(=O)c1cc(C2(C#N)CC2)cnc1-c1nc2cc(C(F)(F)F)ncc2n1C] | 1-[5-(ethyl- sulfonimidoyl)- 6-[3-methyl-6- (trifluoromethyl) imidazo[4,5- c]pyridin-2-yl]-3- pyridyl]cyclo- propanecarbonitrile | | | 3.9 | 3.9 | | | | | | |
| P50 elu- ted is- omer P93 (1 of 2) | 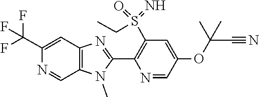 [SMILES: CCS(=N)(=O)c1cc(OC(C)(C)C#N)cnc1-c1nc2cc(C(F)(F)F)ncc2n1C] | 2-[[5-(ethyl- sulfonimidoyl)- 6-[3-methyl- 6-(trifluoromethyl) imidazo[4,5- c]pyridin-2-yl]-3- pyridyl]oxy]-2- methyl- propanenitrile | 4.6 | 4 | 4 | 4.59 | | | | | | |
| P51 | 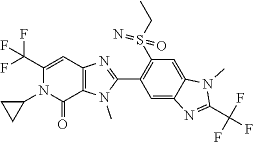 [SMILES: CCS(=N)(=O)c1cc2c(cc1-c1nc3cc(C(F)(F)F)n(C4CC4)c(=O)c3n1C)nc(C(F)(F)F)n2C] | 5-cyclopropyl-2- [6-(ethylsulfon- imidoyl)-1-methyl- 2-(trifluoromethyl) benzimidazol- 5-yl]-3-methyl-6- (trifluoromethyl) imidazo[4,5-c] pyridin-4-one | | | 5.3 | 4.6 | | | | | | |
| P52 | 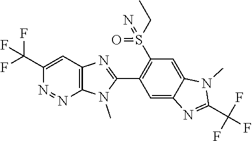 [SMILES: CCS(=N)(=O)c1cc2c(cc1-c1nc3cc(C(F)(F)F)nnc3n1C)nc(C(F)(F)F)n2C] | ethyl-imino-[3- methyl-6-[7- methyl- 3-(trifluoromethyl) imidazo[4,5-c] pyridazin-6-yl]-2- (trifluoromethyl) benzimidazol-5- yl]-oxo-λ⁶-sulfane | | | 5.2 | 5.2 | | | | | | |
| P53 | 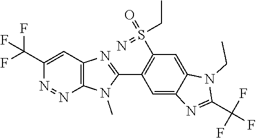 [SMILES: CCn1c(C(F)(F)F)nc2cc(-c3nc4cc(C(F)(F)F)nnc4n3C)c(S(=N)(=O)CC)cc21] | ethyl-[3-ethyl- 6-[7- methyl-3-(trifluoro- methyl)imidazo [4,5-c]pyridazin-6- yl]-2-(trifluoro- methyl) benzimidazol-5- yl]-imino-oxo- λ⁶-sulfane | | | 5.8 | 5.2 | | | | | | |
| P54 | 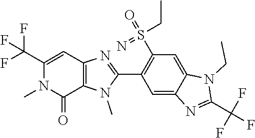 [SMILES: CCn1c(C(F)(F)F)nc2cc(-c3nc4cc(C(F)(F)F)n(C)c(=O)c4n3C)c(S(=N)(=O)CC)cc21] | 5-ethyl-2-[1-ethyl- 6-(ethyl- sulfonimidoyl)- 2-(trifluoromethyl) benzimidazol- 5-yl]- 3-methyl-6- (trifluoromethyl) imidazo[4,5-c] pyridin-4-one | | | 5.3 | 4 | | | | | | |
| P55 | 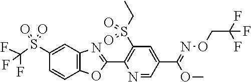 [SMILES: CCS(=O)(=O)c1cc(/C(=N/OCC(F)(F)F)OC)cnc1-c1nc2cc(S(=O)(=O)C(F)(F)F)ccc2o1] | 5-cyclopropyl-2-[1- ethyl-6-(ethyl- sulfonimidoyl)-2- (trifluoromethyl) benzimidazol-5- yl]-3-methyl-6- | | | 5.3 | 5.3 | | | | | | |
| | | (trifluoromethyl) | | | | | | | | | | |
| | | imidazo[4,5-c] | | | | | | | | | | |
| | | pyridin-4-one | | | | | | | | | | |
| P56 | 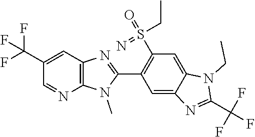 [SMILES: CCn1c(C(F)(F)F)nc2cc(-c3nc4cc(C(F)(F)F)cnc4n3C)c(S(=N)(=O)CC)cc21] | ethyl-[3-ethyl- 6-[3- methyl-6-(trifluoro- methyl)imidazo [4,5- b]pyridin-2-yl]-2- (trifluoromethyl) benzimidazol- 5-yl]-imino-oxo- λ⁶-sulfane | | | 5.2 | 5.2 | | | | | | |
| P57 | 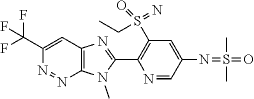 [SMILES: CCS(=N)(=O)c1cc(N=S(C)(C)=O)cnc1-c1nc2cc(C(F)(F)F)nnc2n1C] | [5-[[dimethyl(oxo)- λ⁶-sulfanylidene] amino]-2-[7- methyl- 3-(trifluoromethyl) imidazo[4,5-c] pyridazin-6-yl]-3- | | | 4.6 | 4.6 | | | | | | |
| | | pyridyl]-ethyl- | | | | | | | | | | |
| | | imino-oxo- | | | | | | | | | | |
| | | λ⁶-sulfane | | | | | | | | | | |
| P58 | 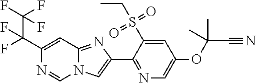 [SMILES: CCS(=O)(=O)c1cc(OC(C)(C)C#N)cnc1-c1cn2cnc(C(F)(F)C(F)(F)F)cc2n1] | 2-[[5-(ethyl- sulfonimidoyl)- 6-[7-(1,1,2,2,2- pentafluoro- ethyl)imidazo [1,2-c]pyrimidin-2- | | | 4.6 | 4.6 | | | | | | |
| | | yl]-3-pyridyl] | | | | | | | | | | |
| | | oxy]-2-methyl- | | | | | | | | | | |
| | | propanenitrile | | | | | | | | | | |
| P59 | 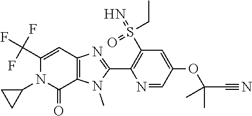 [SMILES: CCS(=N)(=O)c1cc(OC(C)(C)C#N)cnc1-c1nc2cc(C(F)(F)F)n(C3CC3)c(=O)c2n1C] | 2-[[6-[5- cyclopropyl- 3-methyl-4-oxo-6- (trifluoromethyl) imidazo[4,5-c] pyridin-2-yl]-5- (ethyl- sulfonimidoyl)- | | | 4 | 4.6 | | | | | | |
| | | 3-pyridyl]oxy]-2- | | | | | | | | | | |
| | | methyl- | | | | | | | | | | |
| | | propanenitrile | | | | | | | | | | |
| P60 | 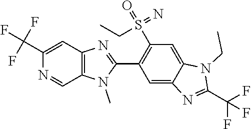 [SMILES: CCn1c(C(F)(F)F)nc2cc(-c3nc4cc(C(F)(F)F)ncc4n3C)c(S(=N)(=O)CC)cc21] | ethyl-[3-ethyl-6-[3- methyl-6-(trifluoro- methyl)imidazo [4,5- c]pyridin-2-yl]-2- (trifluoromethyl) benzimidazol- 5-yl]-imino-oxo- λ⁶-sulfane | | | 5.2 | 5.2 | | | | | | |
| P61 | 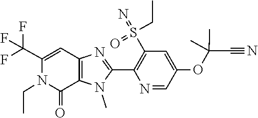 | 2-[[6-[5-ethyl-3- methyl-4-oxo-6- (trifluoromethyl) imidazo[4,5-c] pyridin-2-yl]-5- (ethylsulfon- imidoyl)-3-pyridyl] oxy]-2-methyl- | | | 4.6 | 4.6 | | | | | | |
| | | propanenitrile | | | | | | | | | | |
| P62 | 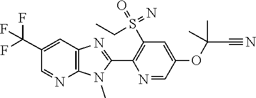 [SMILES: CCS(=N)(=O)c1cc(OC(C)(C)C#N)cnc1-c1nc2cc(C(F)(F)F)cnc2n1C] | 2-[[5-(ethyl- sulfonimidoyl)- 6-[3- methyl-6-(trifluoro- methyl)imidazo [4,5-b]pyridin-2-yl]- 3-pyridyl]oxy]-2- | 4.6 | 4.6 | 4.6 | 5.19 | | | | | 0 | 0 |
| | | methyl- | | | | | | | | | | |
| | | propanenitrile | | | | | | | | | | |
| P63 | 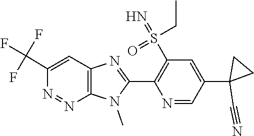 [SMILES: CCS(=N)(=O)c1cc(C2(C#N)CC2)cnc1-c1nc2cc(C(F)(F)F)nnc2n1C] | 1-[5-(ethyl- sulfonimidoyl)-6- [7-methyl-3- (trifluoromethyl) imidazo[4,5- c]pyridazin-6-yl]- 3-pyridyl]cyclo- propanecarbonitrile | 5.2 | 4.5 | 3.9 | 4.5 | 5.2 | 5.2 | 5.2 | | | |
| P64 | 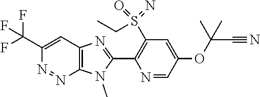 [SMILES: CCS(=N)(=O)c1cc(OC(C)(C)C#N)cnc1-c1nc2cc(C(F)(F)F)nnc2n1C] | 2-[[5-(ethyl- sulfonimidoyl)- 6-[7-methyl-3- (trifluoromethyl) imidazo[4,5- c]pyridazin-6-yl]-3- pyridyl]oxy]-2- | 5.2 | 4 | 4.6 | 4.6 | | | | | | |
| | | methyl- | | | | | | | | | | |
| | | propanenitrile | | | | | | | | | | |
| P65 | 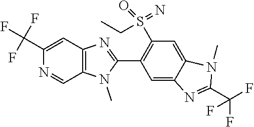 [SMILES: CCS(=N)(=O)c1cc2c(cc1-c1nc3cc(C(F)(F)F)ncc3n1C)nc(C(F)(F)F)n2C] | ethyl-imino-[3- methyl-6-[3- methyl- 6-(trifluoromethyl) imidazo[4,5-c] pyridin-2-yl]-2- (trifluoromethyl) benzimidazol-5- yl]-oxo-λ⁶-sulfane | 5.19 | 4.6 | 5.2 | 4.6 | 5.2 | 5.19 | 5.2 | 5.2 | | |
| P66 | 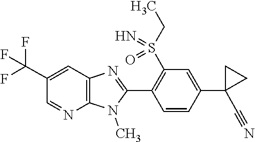 [SMILES: CCS(=N)(=O)c1cc(C2(C#N)CC2)ccc1-c1nc2cc(C(F)(F)F)cnc2n1C] | 1-[3-(ethyl- sulfonimidoyl)- 4-[3-methyl-6- (trifluoromethyl) imidazo[4,5- b]pyridin-2-yl] phenyl]cyclo- propanenitrile | 4.5 | 4.5 | 5.2 | 4.5 | | | | | | |
| P67 | 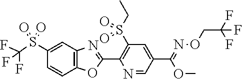 [SMILES: CCS(=O)(=O)c1cc(/C(=N/OCC(F)(F)F)OC)cnc1-c1nc2cc(S(=O)(=O)C(F)(F)F)ccc2o1] | methyl (3Z)- 5-ethyl- sulfonyl-N-(2,2,2- trifluoroethoxy)-6- [5-(tifluoromethyl- sulfonyl)-1,3- | | | | | | | | | 5.3 | 5.9 |
| | | benzoxazol-2-yl] | | | | | | | | | | |
| | | pyridine-3- | | | | | | | | | | |
| | | carboximidate | | | | | | | | | | |
| P68 | 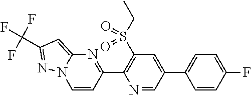 [SMILES: CCS(=O)(=O)c1cc(-c2ccc(F)cc2)cnc1-c1ccn2nc(C(F)(F)F)cc2n1] | 5-[3-ethylsulfonyl- 5-(4-fluorophenyl)- 2-pyridyl]-2- (trifluoromethyl) pyrazolo[1,5-a] pyrimidine | | | | | | | | | 6.4 | 6.4 |
| P69 | 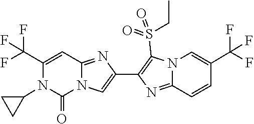 [SMILES: CCS(=O)(=O)c1c(-c2cn3c(=O)n(C4CC4)c(C(F)(F)F)cc3n2)nc2ccc(C(F)(F)F)cn12] | 6-cyclopropyl-2- [3-ethylsulfonyl-6- (trifluoromethyl) imidazo[1,2-a] pyridin-2-yl]-7- (trifluoromethyl) imidazo[1,2-c] pyrimidin-5-one | | | | | | | | | 5.2 | 4.6 |
| P70 | 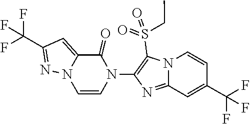 [SMILES: CCS(=O)(=O)c1c(-n2ccn3nc(C(F)(F)F)cc3c2=O)nc2cc(C(F)(F)F)ccn12] | 5-[3-ethylsulfonyl- 7-(trifluoromethyl) imidazo[1,2-a] pyridin-2-yl]-2- (trifluoromethyl) pyrazolo[1,5-a] pyrazin-4-one | | | | | | | | | 5.8 | 5.8 |
| P71 | 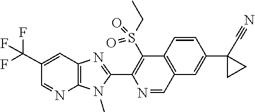 [SMILES: CCS(=O)(=O)c1c(-c2nc3cc(C(F)(F)F)cnc3n2C)ncc2cc(C3(C#N)CC3)ccc12] | 1-[4-ethylsulfonyl- 3-[3-methyl-6- (trifluoromethyl) imidazo[4,5-b] pyridin-2-yl]-7- isoquinolyl] cyclopropane- carbonitrile | | | | | | | | | 5.8 | 6.4 |
| P72 | 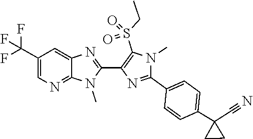 [SMILES: CCS(=O)(=O)c1c(-c2nc3cc(C(F)(F)F)cnc3n2C)nc(-c2ccc(C3(C#N)CC3)cc2)n1C] | 1-[4-[5-ethyl- sulfonyl-1-methyl- 4-[3-methyl-6- (trifluoromethyl) imidazo[4,5-b] pyridin-2-yl] imidazol-2-yl] phenyl]cyclo- propanenitrile | | | 0 | 0 | | | | | 5.8 | 5.2 |
| P73 | 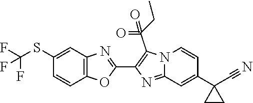 | 1-[3-ethylsulfonyl- 2-[5-(trifluoro- methylsulfanoyl)-1, 3-benzoxazol-2-yl] imidazo[1,2-a] pyridin-7-yl]cyclo- propanecarbonitrile | | | | | 4.6 | 0 | 4 | 0 | 5.2 | 5.8 |
| P74 | 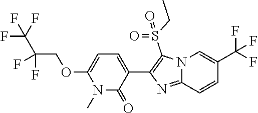 [SMILES: CCS(=O)(=O)c1c(-c2ccc(OCC(F)(F)C(F)(F)F)n(C)c2=O)nc2ccc(C(F)(F)F)cn12] | 3-[3-ethylsulfonyl- 6-(trifluoromethyl) imidazo[1,2-a] pyridin-2-yl]-1- methyl-6-(2,2,3, 3,3-pentafluoro- propoxy) pyridin-2-one | | | | | | | | | 6.4 | 6.4 |
| P75 | 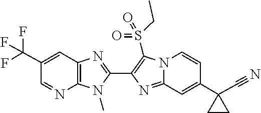 [SMILES: CCS(=O)(=O)c1c(-c2nc3cc(C(F)(F)F)cnc3n2C)nc2cc(C3(C#N)CC3)ccn12] | 1-[3-ethylsulfonyl- 2-[3-methyl-6-(tri- fluoromethyl) imidazo[4,5-b] pyridin-2-yl] imidazo[1,2-a] pyridin-7-yl]cyclo- propanecarbonitrile | | | | | | | | | 5.8 | 6.4 |
| P76 | 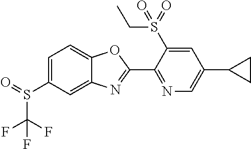 [SMILES: CCS(=O)(=O)c1cc(C2CC2)cnc1-c1nc2cc(S(=O)C(F)(F)F)ccc2o1] | 2-(5-cyclopropyl-3- ethylsulfonyl-2- pyridyl)-5- (trifluoromethyl- sulfinyl)-1,3- benzoxazole | | | 0 | 0 | | | | | 6.3 | 6.3 |
| P77 | 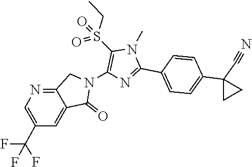 | 1-[4-[5-ethyl- sulfonyl-1-methyl- 4-[5-oxo-3- (trifluoromethyl)- 7H-pyrrolo[3,4-b] pyridin-6-yl] imidazol-2-yl] phenyl]cyclopro- panecarbonitrile | | | | | | | | | 5.8 | 5.8 |
| P78 | 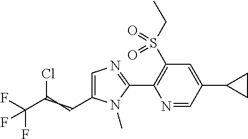 [SMILES: CCS(=O)(=O)c1cc(C2CC2)cnc1-c1ncc(C=C(Cl)C(F)(F)F)n1C] | 2-[5-(2-chloro- 3,3,3- trifluoro-prop-1- enyl)-1-methyl- imidazol-2-yl]-5- cyclopropyl-3- ethylsulfonyl- pyridine | 5.09 | 4.5 | | | 0.05 | 3.89 | 0.05 | 3.3 | 5.1 | 0.05 |
| P79 | 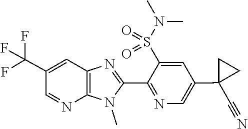 [SMILES: CN(C)S(=O)(=O)c1cc(C2(C#N)CC2)cnc1-c1nc2cc(C(F)(F)F)cnc2n1C] | 5-(1-cyanocyclo- propyl)-N,N- dimethyl-2-[3- methyl-6-(tri- fluoromethyl) imidazo[4,5-b] pyridin-2-yl] pyridine-3- sulfonamide | | | | | | | | | 4.6 | 0 |
| P80 | 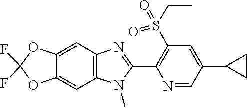 [SMILES: CCS(=O)(=O)c1cc(C2CC2)cnc1-c1nc2cc3c(cc2n1C)OC(F)(F)O3] | 6-(5-cyclopropyl- 3-ethylsulfonyl-2- pyridyl)-2,2- difluoro-7-methyl- [1,3]dioxolo[4,5-f] benzimidazole | | | | | | | | | 4.5 | 0.05 |
| P81 | 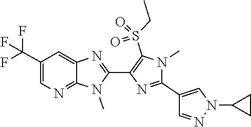 [SMILES: CCS(=O)(=O)c1c(-c2nc3cc(C(F)(F)F)cnc3n2C)nc(-c2cnn(C3CC3)c2)n1C] | 2-[2-(1- cyclopropylpyrazol- 4-yl)-5-ethyl- sulfonyl-1-methyl- imidazol-4-yl]-3- methyl-6-(trifluoro- methyl)imidazo [4,5-b]pyridine | | | | | | | | | 5.2 | 4.6 |
| P82 | 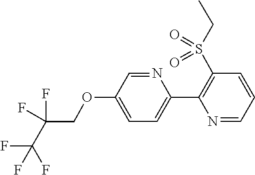 [SMILES: CCS(=O)(=O)c1cccnc1-c1ccc(OCC(F)(F)C(F)(F)F)cn1] | 3-ethylsulfonyl-2- [5-(2,2,3,3,3- pentafluoro- propoxy)-2-pyridyl] pyridine | | | | | | | | | 4.5 | 0.05 |
| P83 | 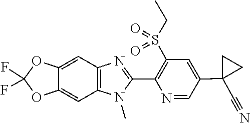 [SMILES: CCS(=O)(=O)c1cc(C2(C#N)CC2)cnc1-c1nc2cc3c(cc2n1C)OC(F)(F)O3] | 1-[6-(2,2- difluoro-7-methyl- [1,3]dioxolo[4,5-f] benzimidazol- 6-yl)-5-ethyl- sulfonyl-3-pyridyl] cyclopropane- carbonitrile | | | 4 | 4 | | | | | 7.01 | 5.7 |
| P84 | 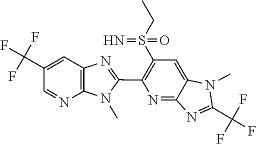 [SMILES: CCS(=N)(=O)c1cc2c(nc1-c1nc3cc(C(F)(F)F)cnc3n1C)nc(C(F)(F)F)n2C] | ethyl-imino-[1- methyl-5-[3- methyl-6-(trifluoro- methyl)imidazo[4,5- b]pyridin-2-yl]-2- (trifluoromethyl) imidazo[4,5-b] pyridin-6-yl]-oxo- λ⁶-sulfane | | | | | | | | | | |
| P85 | 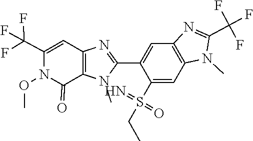 [SMILES: CCS(=N)(=O)c1cc2c(cc1-c1nc3cc(C(F)(F)F)n(OC)c(=O)c3n1C)nc(C(F)(F)F)n2C] | 2-[6-(ethyl- sulfonimidoyl)-1- methyl-2-(trifluoro- methyl)benz- imidazol-5-yl]-5- methoxy-3-methyl- 6-(trifluoromethyl) imidazo[4,5-c] pyridin-4-one | | | 5.3 | 4.6 | | | | | | |
| P86 | 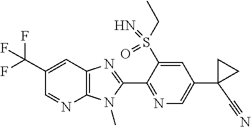 [SMILES: CCS(=N)(=O)c1cc(C2(C#N)CC2)cnc1-c1nc2cc(C(F)(F)F)cnc2n1C] | 1-[5-(ethyl- sulfonimidoyl)- 6-[3- methyl-6-(trifluoro- methyl)imidazo [4,5- b]pyridin-2-yl]-3- pyridyl]cyclo- propanecarbonitrile | | | 4.5 | 4.5 | | | | | | |
| P87 | 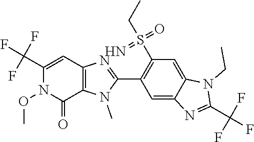 [SMILES: CCn1c(C(F)(F)F)nc2cc(-c3nc4cc(C(F)(F)F)n(OC)c(=O)c4n3C)c(S(=N)(=O)CC)cc21] | 2-[1-ethyl-6-(ethyl- sulfonimidoyl)-2- (trifluoromethyl) benzimidazol-5- yl]-5-methoxy-3- methyl-6-(trifluoro- methyl)imidazo [4,5-c]pyridin-4-one | | | 4.6 | 4.6 | | | | | | |
| P88 | 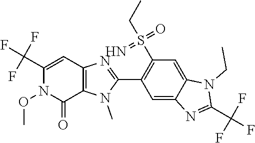 [SMILES: CCn1c(C(F)(F)F)nc2cc(-c3nc4cc(C(F)(F)F)n(OC)c(=O)c4n3C)c(S(=N)(=O)CC)cc21] | 2-[1-ethyl-6-(ethyl- sulfonimidoyl)-2- (trifluoromethyl) benzimidazol-5-yl]- 5-methoxy-3- methyl-6-(trifluoro- methyl)imidazo [4,5-c]pyridin-4-one | | | 0 | 0 | | | | | | |
| P89 | 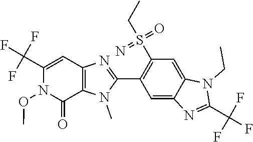 [SMILES: CCn1c(C(F)(F)F)nc2cc(-c3nc4cc(C(F)(F)F)n(OC)c(=O)c4n3C)c(S(=N)(=O)CC)cc21] | 2-[1-ethyl-6-(ethyl- sulfonimidoyl)-2- (trifluoromethyl) benzimidazol-5-yl]- 5-methoxy-3- methyl-6-(trifluoro- methyl)imidazo [4,5-c]pyridin- 4-one | | | 0 | 0 | | | | | | |
| P90 | 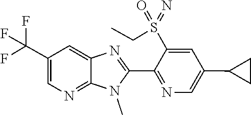 | [5-cyclopropyl- 2-[3-methyl-6- (trifluoromethyl) imidazo[4,5- b]pyridin-2-yl]-3- pyridyl]- ethyl-imino- oxo-λ⁶-sulfane | | | 0 | 0 | | | | | | |
| P91 | 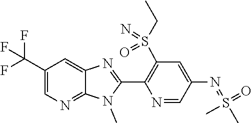 | [5-[[dimethyl(oxo- λ⁶-sulfanylidene] amino]-2-[3- methyl- 6-(trifluoromethyl) imidazo[4,5-b] pyridin-2-yl]-3- pyridyl]-ethyl- | | | 4.6 | 0.05 | | | | | | |
| | | imino- | | | | | | | | | | |
| | | oxo-λ⁶-sulfane | | | | | | | | | | |
| P92 | 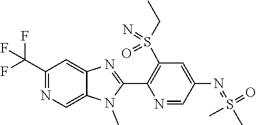 | 5-[[dimethyl(oxo)- λ⁶-sulfanylidene] amino]-2-[3- methyl-6-(trifluoro- methyl)imidazo[4,5- c]pyridin-2-yl]-3- pyridyl]-ethyl- imino- oxo-λ⁶-sulfane | | | 4.59 | 4 | | | | | | |
| P93 | 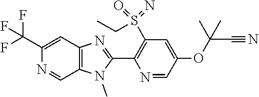 | 2-[[5-(ethyl- sulfonimidoyl)-6-[3- methyl-6-(trifluoro- methyl)imidazo[4,5- c]pyridin-2-yl]-3- pyridyl]oxy]-2- methyl- | | | 4.59 | 4.59 | | | | | | |
| | | propanenitrile | | | | | | | | | | |
| P94 | 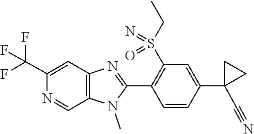 | 1-[3-(ethyl- sulfonimidoyl)-4-[3- methyl-6-(trifluoro- methyl)imidazo[4,5- c]pyridin-2-yl] phenyl]cyclo- propanecarbonitrile | | | 4.49 | 4.49 | | | | | | |
| P95 | 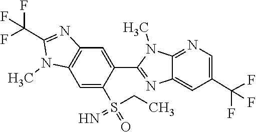 [SMILES: CCS(=N)(=O)c1cc2c(cc1-c1nc3cc(C(F)(F)F)cnc3n1C)nc(C(F)(F)F)n2C] | ethyl-imino-[3- methyl-6-[3-methyl- 6-(trifluoromethyl) imidazo[4,5-b] pyridin-2-yl]-2- (trifluoromethyl) benzimidazol-5-yl]- oxo-λ⁶-sulfane | | | 5.2 | 4.6 | | | | | | |
| P96 el- uted is- omer P93 (2 of | 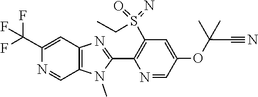 | 2-[[5-(ethyl- sulfonimidoyl)-6-[3- methyl-6-(trifluoro- methyl)imidazo[4,5- c]pyridin-2-yl]-3- pyridyl]oxy]-2- methyl- | 4.6 | 4.6 | 5.19 | 4.59 | | | | | | |
| 2) | | propanenitrile | | | | | | | | | | |

Note
pBP80 ‘0’ does mean that no acitivity was recorded at the highest tested dose. In the Myzus persicae, Bemisa tabaci and Nilaparvata lugens assays,
0 means BP80 is >50 ppm, and in the Plutella xylostella assay 0 means BP80 is >200 ppm.

1. A method of controlling a multi-resistant insect using a compound of formula I, wherein the compound is insecticidally active by inhibition of, or affect the function of, the vesicular acetylcholine transporter (VAChT) of the pest, wherein the compound of formula I is represented by the formula A-B. wherein A is selected from A1 to A54, and B is selected from B1 to B27 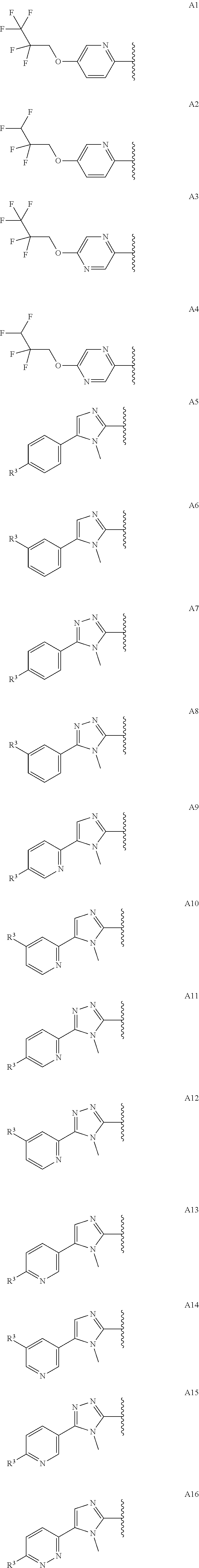 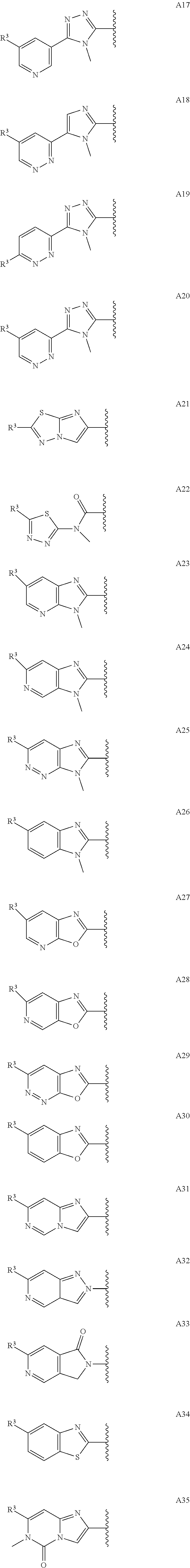 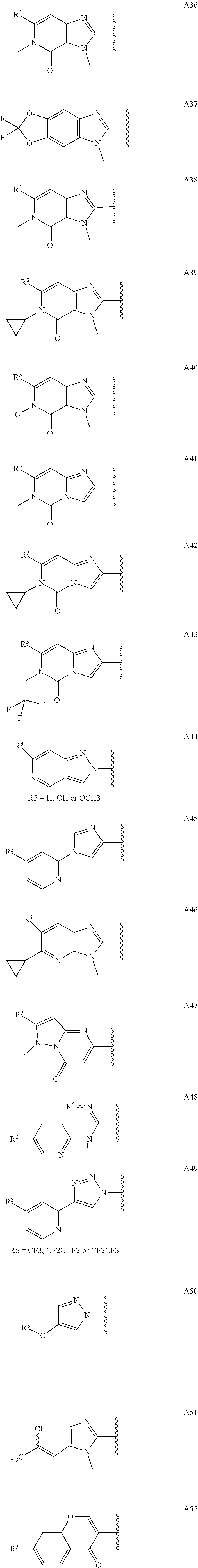 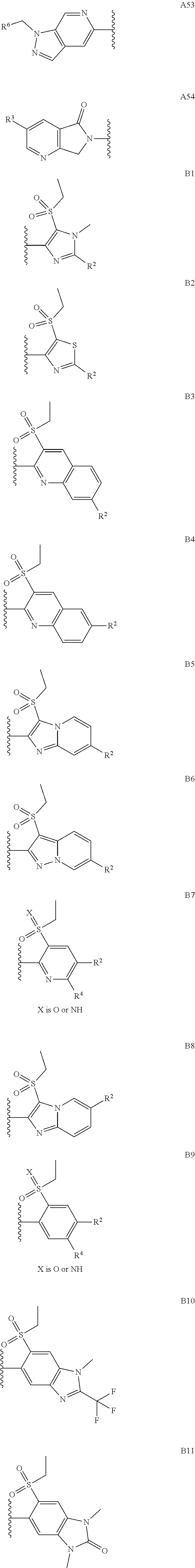 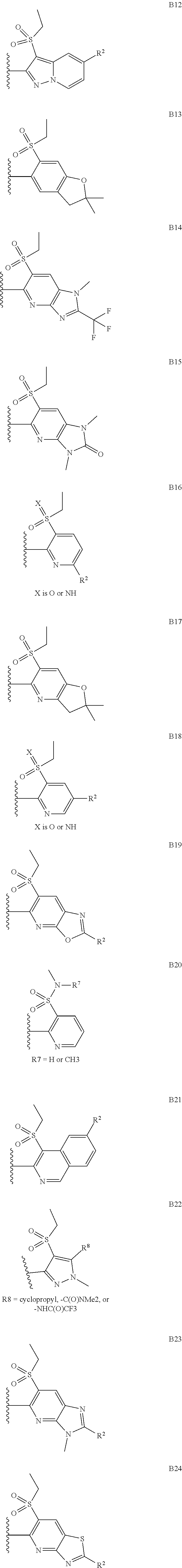 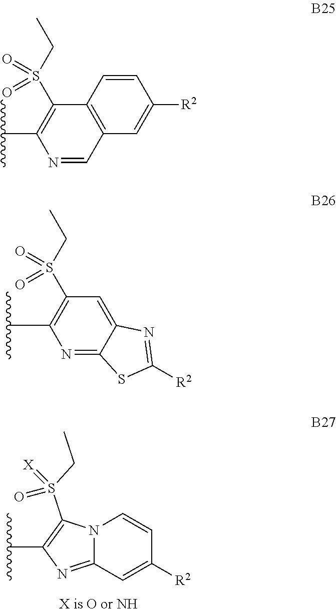
wherein
R² is hydrogen, bromine, CHF₂, CF₃, CF₂CF₃, or one of R2-1 to R2-25;
R³ is CHF₂, CF₃, CF₂CF₃, OCHF₂, OCF₃, OCF₂CF₃, SCF₃, SOCF₃, SO₂CF₃, SCHF₂, SOCHF₂, or SO₂CHF₂; and
R⁴ is hydrogen or methyl;
as well as agrochemically acceptable salts, enantiomers, diastereomers, tautomers, and N-oxides of formula I; where R2-1 to R2-25 is: 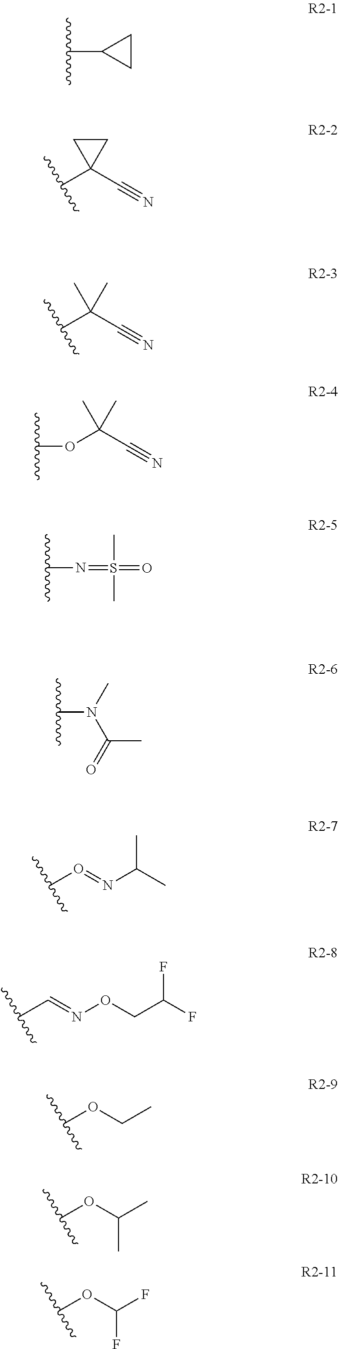 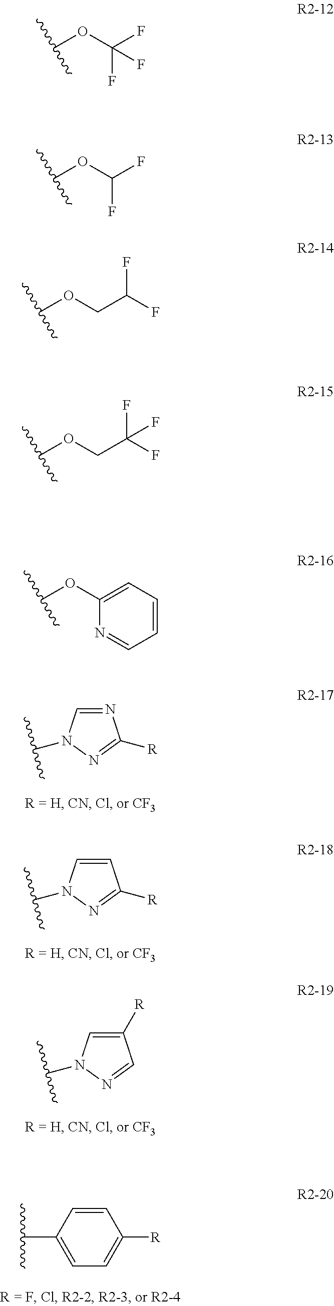 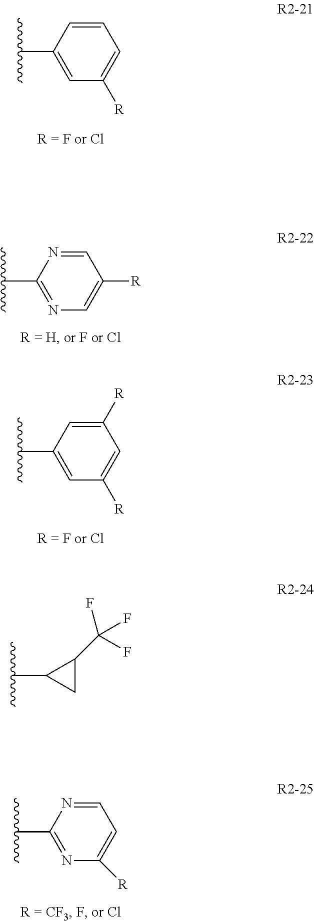
as well as agrochemically acceptable salts, enantiomers, diastereomers, tautomers, and N-oxides of formula I.

2. The method according to claim 1, wherein the pest is resistant to insecticides belonging to more than one mode of action groups 1 to 34 as defined by the the Insecticide Resistance Action Committee (IRAC; https://irac-online.org/mode-of-action/classification-online/).

3. The method according to claim 2, wherein the mode of action is selected from 1A, 1B, 2B, 3A, 4A, 6, and 28.

4. The method according to claim 1, wherein the insect is selected from Thrips tabaci, Bemisia tabaci, Aphis gossypii, Nilaparvata lugens, Sogatella furcifera, Myzus persicae, Frankliniella occidentalis, Trialeurodes vaporariorum, Tuta absoluta, and Plutella xylostella.

5. The method according to claim 1, wherein the pest is resistant to insecticides having a resistance factor of greater than 10.

6. The method according to claim 1, wherein the compound of formula I is represented by
a) formula Ia wherein A-B is A3 and B7; or
b) formula Ib wherein A-B is A12 and B7; or
c) formula Ic wherein A-B is A23 and B7; or
d) formula Id wherein A-B is A23 and B6; or
e) formula Ie wherein A-B is A23 and B5; or
f) formula If wherein A-B is A23 and B8; or
g) formula Ig wherein A-B is A23 and B12; or
h) formula Ih wherein A-B is A24 and B7; or
i) formula Ii wherein A-B is A25 and B7; or
j) formula Ij wherein A-B is A26 and B7; or
k) formula Ik wherein A-B is A27 and B7; or
l) formula Il wherein A-B is A30 and B7; or
m) formula Im wherein A-B is A37 and B7; or
n) formula In wherein A-B is A30 and B16
wherein in each of (a) to (m), independent of each other, R³ (if present) is CF₃, CF₂CF₃, OCHF₂, OCF₃, OCF₂CF₃, SCF₃, SOCF₃, SO₂CF₃, SCHF₂, SOCHF₂, or SO₂CHF₂; R² is hydrogen, CHF₂, CF₃, CF₂CF₃, or one of R2-1 to R2-25; R⁴ (if present) is hydrogen or methyl; and X (if present) is oxygen or NH.

7. A method of controlling or managing insecticide-resistance development of a pest comprising
a) applying to the pest, to a locus of the pest, to a plant susceptible to attack by the pest, or
b) treating a propagation material or its site;
an effective amount of a compound of formula I as defined in claim 1, which compound is insecticidally active by inhibition of, or affect the function of, the vesicular acetylcholine transporter (VAChT) of such pest, optionally in combination with an effective amount of another compound which is insecticidally active other than by inhibition of the vesicular acetylcholine transporter (VAChT).

8. A method of obtaining a regulatory approval as a pesticide in a country comprising the action of representing a compound of formula I as defined in claim 1 as a compound that is insecticidally active by inhibition of, or affect the function of, the vesicular acetylcholine transporter (VAChT) of a pest, and optionally, submitting data relating to a VAChT mode of action of a compound of formula I.

9. (canceled)
